(19) United States
(12) Patent Application Publication
(10) Pub. No.: US 2026/0295571 A1
(43) Pub. Date: Oct. 1, 2026

(54) DESIGN AND SYNTHESIS OF ELECTRON-RICH PHOSPHINE LIGANDS FOR SELECTIVE, SUSTAINABLE CROSS-COUPLING REACTIONS

(71) Applicant: The Curators of the University of Missouri, Columbia, MO (US)

(72) Inventors: Sachin Handa, COLUMBIA, MO (US); Ashish Dusunge, COLUMBIA, MO (US)

(21) Appl. No.: 19/570,853

(22) Filed: Mar. 18, 2026

Related U.S. Application Data
(60) Provisional application No. 63/773,669, filed on Mar. 18, 2025.

(51) Int. Cl. B01J 31/24; B01J 37/04; B01J 37/08; C07F 9/50

(52) U.S. Cl. CPC B01J 31/2447; B01J 37/04; B01J 37/08; C07F 9/505; B01J 2231/4283; B01J 2531/004; B01J 2531/824

(57) ABSTRACT

A family of highly electron rich monophosphine compounds is described. The monophosphines can be prepared from inexpensive materials in one or two steps. The monophosphines can be used as ligands in transition metal or organometallic catalysis for cross-couplings and other new bond-forming reactions. A pre-catalyst palladium complex containing an exemplary monophosphine compound, i.e., AshPhos, and its use in palladium-catalyzed Buchwald-Hartwig amination reactions are described. The coupling partners for the reactions include five- and six-membered (hetero)aryl halides and cyclic secondary or bulky amines. Use of the pre-catalyst palladium complex in catalyzing cyanide ion-free cyanation reactions is also described.

### CROSS-REFERENCE TO RELATED APPLICATION

This application claims the benefit of U.S. Provisional Patent Application Ser. No. 63/773,669, filed Mar. 18, 2025, the disclosure of which is incorporated herein by reference in its entirety.

### GOVERNMENT SUPPORT

This invention was made with government support under grant numbers 2044778 and 2345856 awarded by the National Science Foundation. The government has certain rights in the invention.

### TECHNICAL FIELD

The presently disclosed subject matter relates to monophosphine compounds, to transition metal complexes containing the monophosphine compounds, e.g., pre-catalyst palladium complexes containing the monophosphine compounds, and to the use of the transition metal complexes in methods of performing cross-coupling reactions, such as Buchwald-Hartwig amination reactions and cyanide-free cyanation reactions.

### BACKGROUND

Many pharmaceuticals are synthesized through cross-coupling reactions, with Buchwald-Hartwig amination being one of the most valuable, yet challenging examples, particularly when they involve heterocyclic substrates. The Buchwald-Hartwig amination reaction involves the palladium-catalyzed reaction of an amine with an aryl halide to form a new carbon-nitrogen bond between a carbon atom of the aryl halide aryl group and the nitrogen atom of the amine. Challenges associated with the reaction can include low or negligible conversion rates due to the strongly binding nature of amines, which can lead to catalyst deactivation. Thus, successful production of such pharmaceuticals can involve high catalyst loading and more resource-intensive protocols, leading to poor yield and/or high cost.

While significant research has focused on the development of catalyst ligands to improve conversion rates and substrate compatibility for the reaction, there remains an ongoing need for additional catalyst ligands, pre-catalyst compositions, and methods of performing cross-coupling reactions.

### SUMMARY

This Summary lists several embodiments of the presently disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

In some embodiments, the presently disclosed subject matter provides a compound having a structure of Formula (I):

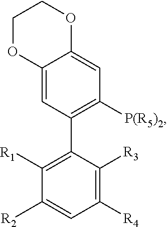

wherein: R₁ and R₃ are independently selected from C₁-C₆ alkyl, C₁-C₆ alkoxy, and N(R₆)₂; R₂ and R₄ are independently selected from H, C₁-C₆ alkyl, C₁-C₆ alkoxy, benzyl, substituted benzyl, and N(R₆)₂; or wherein R₁ and R₂ together and/or R₃ and R₄ together are —CH═CH—CH═CH— or —O—(C(R₇)₂)ₙ—O—, wherein n is 1 or 2 and each R₇ is H or halo, optionally H or F; R₅ is selected from the group comprising alkyl, cycloalkyl, aryl, 2-pyridyl, and N(R₆)₂; and each R₆ is independently C₁-C₆ alkyl.

In some embodiments, R₁ and/or R₃ is C₁-C₆ alkoxy, optionally methoxy. In some embodiments, R₂ and/or R₄ is H, optionally wherein R₂ and R₄ are each H.

In some embodiments, R₁ and R₂ together are —O—(C(R₇)₂)ₙ—O—, optionally wherein each R₇ is H and n is 1; and/or wherein R₃ and R₄ together are —O—(C(R₇)₂)ₙ—O—, optionally wherein each R₇ is H and n is 1.

In some embodiments, each R₅ is C₁-C₆ alkyl, optionally tert-butyl (t-Bu). In some embodiments, each R₅ is cycloalkyl, optionally cyclohexyl (Cy).

In some embodiments, the compound is selected from the group comprising:

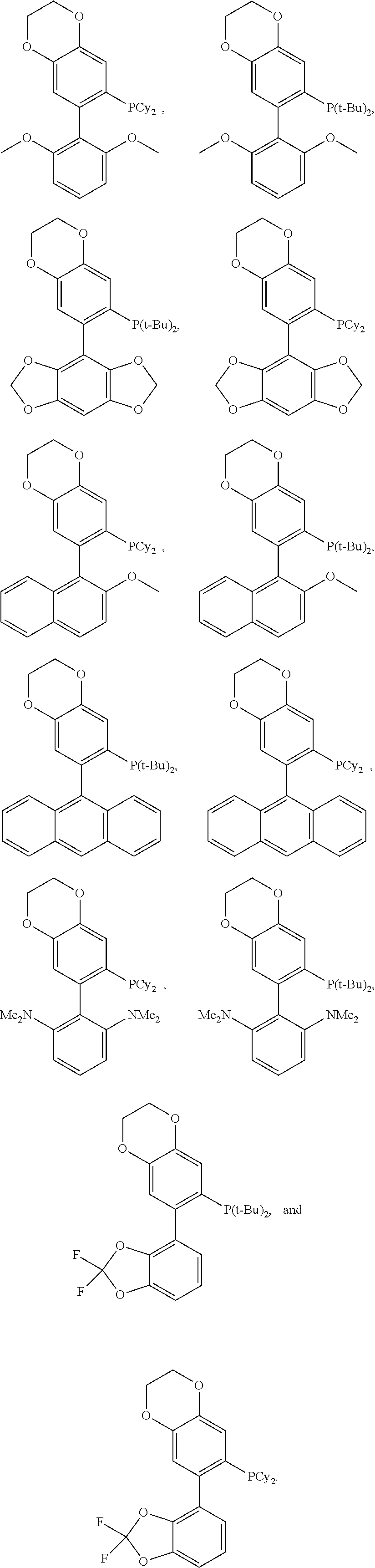

In some embodiments, the presently disclosed subject matter provides a pre-catalyst palladium complex, wherein the pre-catalyst palladium complex comprises a palladium (Pd) ion and a monophosphine ligand, wherein the monophosphine ligand is a compound having a structure of Formula (I). In some embodiments, the pre-catalyst palladium complex has a formula [Pd(L)(MP)X′], wherein L is an olefin, MP is the monophosphine ligand, and X′ is a halide, optionally wherein L is selected from the group comprising crotyl alcohol (crotyl), 1-propene (allyl), cinnamyl alcohol (cinnamyl), cyclooctadiene (cod), and dibenzylideneacetone (dba).

In some embodiments, the presently disclosed subject matter provides a method of performing a palladium (Pd)-catalyzed cross-coupling reaction between a first substrate and a second substrate, wherein the method comprises contacting the first substrate and the second substrate in the presence of a pre-catalyst palladium complex comprising a Pd ion and a monophosphine ligand, wherein the monophosphine ligand is a compound having a structure of Formula (I); wherein the first substrate and the second substrate undergo a Pd-catalyzed cross-coupling reaction to form a product comprising a carbon-carbon, carbon-nitrogen, carbon-oxygen, or carbon-sulfur bond that was not present in the first or second substrate. In some embodiments, the first substrate is a compound having a structure of the formula Ar₁—X, wherein Ar₁ is aryl, substituted aryl, heteroaryl, or substituted heteroaryl, and X is halo, alkyl sulfonate, substituted alkyl sulfonate, aryl sulfonate, or substituted aryl sulfonate; optionally wherein X is Br, Cl, I, methanesulfonate (OMs), or trifluorosulfonate (OTf). In some embodiments, the second substrate is selected from the group comprising an alcohol, a phenol, a thiol, a primary amine, a secondary amine, and an α,β-unsaturated carbonyl compound.

In some embodiments, the Pd-catalyzed cross-coupling reaction is a Buchwald-Hartwig amination reaction, wherein the first substrate is a compound having a structure of the formula Ar₁—X, wherein Ar₁ is aryl, substituted aryl, heteroaryl, or substituted heteroaryl, and X is halo, alkyl sulfonate, substituted alkyl sulfonate, aryl sulfonate, or substituted aryl sulfonate; wherein the second substrate is a primary or secondary amine having the structure HN(R′)₂, wherein each R′ group is selected from H, alkyl, substituted alkyl, aralkyl, substituted aralkyl, aryl, and substituted aryl, subject to the proviso that at least one R′ group is alkyl, substituted alkyl, aralkyl, substituted aralkyl, aryl, and substituted aryl, or wherein two R′ groups together with the nitrogen atom to which they are attached form a cyclic amino group; and wherein the product is a compound of the formula Ar₁—N(R′)₂. In some embodiments, the second substrate is a primary or secondary amine having a structure of the formula HN(R′)₂, wherein each R′ group is H, alkyl or substituted alkyl, subject to the proviso that at least one R′ group is alkyl or substituted alkyl; or wherein the two R′ groups together with the nitrogen atom to which they are attached form a cyclic amino group, optionally wherein the cyclic amino group comprises a substituted and/or fused nitrogen-containing ring structure; and wherein the product is a compound of the formula Ar₁—N—(R′)₂. In some embodiments, the second substrate is a primary amine having a structure of the formula H₂NR′, wherein R′ is alkyl having the structure —C(R″)₃, wherein each R″ is H, alkyl, or substituted alkyl, and wherein at least two R″ groups are alkyl or substituted alkyl; optionally wherein each R″ is methyl and the second substrate is t-butylamine. In some embodiments, the second substrate is an α-branched secondary amine, optionally wherein the α-branched secondary amine comprises a substituted or fused nitrogen-containing ring structure. In some embodiments, the second substrate is a non-α-branched secondary amine, optionally wherein the non-α-branched secondary amine comprises a substituted or unsubstituted nitrogen-containing ring structure.

In some embodiments, the method comprises: (a) contacting the monophosphine ligand with about 0.5 molar equivalents of a palladium compound or salt in a first aprotic solvent, wherein the palladium compound or salt is selected from the group comprising [Pd(crotyl)Cl]₂, [Pd(allyl)Cl]₂, Pd₂dba₃, Pd(OAc)₂, PdBr₂, [Pd(cinnamyl)Cl]₂, (COD)PdCH₂C(Me)₂Ph, and Pd(cod)Cl₂; thereby preparing a solution comprising the pre-catalyst palladium complex; (b) preparing a mixture comprising the first substrate and the second substrate in a second aprotic solvent, wherein the second aprotic solvent is the same or different than the first aprotic solvent; and (c) contacting the mixture from step (b) with the solution comprising the pre-catalyst palladium complex and stirring the resulting mixture for a period of time at a temperature of about 20° C. to about 90° C. In some embodiments, the contacting of step (c) is performed in the presence of a non-nucleophilic base, optionally an alkali metal alkoxide, further optionally wherein the non-nucleophilic base is sodium tert-butoxide. In some embodiments, the first and/or second aprotic solvent is tetrahydrofuran or toluene. In some embodiments, the contacting of step (c) is performed for a period of time of about 3 hours to about 16 hours and/or at a temperature of about 50° C. to about 90° C.

In some embodiments, the presently disclosed subject matter provides a nanoparticle comprising a pre-catalyst palladium complex, wherein the pre-catalyst palladium complex comprises a monophosphine ligand, wherein the monophosphine ligand is a compound having a structure of Formula (I). In some embodiments, the monophosphine ligand is

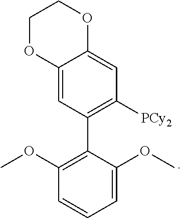

In some embodiments, the nanoparticle further comprises ferrocyanide.

In some embodiments, the presently disclosed subject matter provides a method of preparing a nitrile, wherein the method comprises contacting a substrate, wherein the substrate comprises a (hetero)aryl halide or (hetero)aryl sulfonate ester, with (i) potassium ferrocyanide or a hydrate thereof and a nanoparticle comprising a pre-catalyst palladium complex comprising a monophosphine ligand, wherein the monophosphine ligand is a compound having a structure of Formula (I), or (ii) a nanoparticle comprising the pre-catalyst palladium complex and ferrocyanide, wherein the contacting is performed in an aqueous solution comprising hydroxypropyl methylcellulose (HPMC), thereby converting the substrate into a (hetero)aryl nitrile. In some embodiments, the method comprises: (a) contacting the pre-catalyst palladium complex with an aqueous solution comprising HPMC and stirring the resulting mixture for a first period of time at a first temperature to provide an aqueous solution comprising HPMC and a nanoparticle comprising the pre-catalyst palladium complex; (b) adding the substrate and potassium ferrocyanide or a hydrate thereof to the aqueous solution comprising the HPMC and the nanoparticle to provide a reaction mixture; and (c) stirring the reaction mixture at a second temperature for a second period of time. In some embodiments, step (b) further comprises adding a base to the reaction mixture, wherein the base is selected from an alkali metal hydroxide, an alkali metal carbonate, an alkali metal alkoxide, and a trialkylamine, optionally wherein the base is potassium carbonate. In some embodiments, the method is performed without the generation of free cyanide ions.

Accordingly, it is an object of the presently disclosed subject matter to provide compounds of Formula (I), related pre-catalyst palladium complexes and nanoparticles, and methods of performing cross-coupling reactions and/or preparing nitriles. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description, Figures, and Examples.

### BRIEF DESCRIPTIONS OF THE FIGURES

The patent or application file contains at least one drawing executed in color. Copies of this patent or patent application publication with color drawing(s) will be provided by the Office upon request and payment of the necessary fee.

The presently disclosed subject matter can be better understood by referring to the following figures. The drawings are not intended to limit the scope of this presently disclosed subject matter, which is set forth with particularity in the claims as appended or as subsequently amended, but merely to clarify and exemplify the presently disclosed subject matter.

FIGS. 1A and 1B. Design of AshPhos Ligand and Use of AshPhos as a Catalyst Ligand in Cross-Coupling Reaction. FIG. 1A is a schematic diagram showing the chemical structure and design features of AshPhos, an exemplary monophosphine compound of the presently disclosed subject matter. FIG. 1B is a schematic diagram showing the use of an AshPhos-containing palladium complex in catalyzing a cross-coupling reaction between a heteroaryl halide and a (cyclo)alkylamine.

FIGS. 2A and 2B: Synthesis of the AshPhos Ligand. FIG. 2A is a schematic diagram showing the synthesis of AshPhos using a two-step synthesis route involving cross-coupling and lithiation chemistry. FIG. 2B is a schematic diagram showing a one-step synthesis route for AshPhos involving a benzyne intermediate.

FIG. 3 is a graph showing the ³¹P NMR spectra of (bottom) AshPhos, (middle) the [Pd(crotyl)(AshPhos)Cl]pre-catalyst palladium complex, and (top) an oxidative addition complex (OAC) formed from the pre-catalyst palladium complex and an exemplary (heteroaryl) halide cross-coupling substrate, i.e., 3-bromo-4-methylthiophene.

FIG. 4 is a schematic diagram showing (top) the conditions for (hetero)aryl bromide cross-coupling reactions with α-branched and hindered amines catalyzed using a palladium catalyst prepared with the AshPhos ligand; and (bottom) exemplary cross-coupling reaction products and their corresponding yields. Unless otherwise indicated, reaction conditions were as follows: (hetero)aryl bromide (0.25 mmol, 1.0 equiv.), α-branched amine (3.0 mmol, 1.2 equiv.), sodium tert-butoxide (t-BuONa, 0.5 mmol, 2.0 equiv.), [Pd(crotyl)Cl]₂ (1 mol %), AshPhos (2 mol %), toluene or tetrahydrofuran (THF) (0.5 M), 70° C., 16 hours. THF was the reaction solvent for preparing products 11, 12, 15, 16, and 18-24. Toluene was the reaction solvent for preparing products 7-10, 13, 14, and 17. Percent yields marked with a single asterisk (*) indicate the reaction time was 12 hours. Yields marked with a superscript letter b indicate the product was prepared from a reaction performed with 2 mol % [Pd(crotyl)Cl]₂ and 4 mol % AshPhos. Yields marked with a superscript letter c indicate that the product was prepared from a reaction performed with 2.5 mol % [Pd(crotyl)Cl]₂ and 5 mol % AshPhos. Yields marked with a superscript letter d indicate that the product was prepared from a reaction performed with 3 mol % [Pd(crotyl)Cl]₂ and 6 mol % AshPhos.

FIG. 5 is a schematic diagram showing (top) the conditions for (hetero)aryl bromide cross-coupling reactions with unbranched cyclic secondary amines catalyzed using a palladium catalyst prepared with the AshPhos ligand; and (bottom) exemplary cross-coupling reaction products and their corresponding yields. Unless otherwise indicated, reaction conditions were as follows: (hetero)aryl bromide (0.25 mmol, 1.0 equiv.), cyclic secondary amine (3.0 mmol, 1.2 equiv.), sodium tert-butoxide (t-BuONa, 0.5 mmol, 2.0 equiv.), [Pd(crotyl)Cl]₂ (1 mol %), AshPhos (2 mol %), toluene (0.5 M), 60° C., 16 hours. Percent yields indicated with an asterisk (*) indicate that the products were prepared with THF as the reaction solvent instead of toluene. Yields marked with a superscript letter b indicate the product was prepared from a reaction performed at 90° C. instead of 60° C. Yields marked with a superscript letter c indicate that the product was prepared from a reaction performed with 3 mol % [Pd(crotyl)Cl]₂ and 6 mol % AshPhos, with t-BuONa at 1.0 equiv. instead of 2.0 equiv.

FIGS. 6A and 6B. Couplings of (Hetero)aryl Chlorides with Cyclic Secondary and Hindered Amines. FIG. 6A is a schematic diagram showing (top) the conditions for (hetero)aryl chloride coupling reactions with cyclic secondary and hindered amines catalyzed using a palladium catalyst prepared with the AshPhos ligand; and (bottom) exemplary cross-coupling reaction products and their corresponding percent yields. Unless otherwise indicated, reaction conditions were as follows: (hetero)aryl chloride (0.5 mmol, 1.0 equiv.), amine (0.6 mmol, 1.2 equiv.), sodium tert-butoxide (t-BuONa, 1.0 mmol, 2.0 equiv.), [Pd(crotyl)Cl]₂ (1 mol %), AshPhos (2 mol %), THF (0.5 M), 70° C., 12 hours. Yields marked with a superscript letter b indicate that the product was prepared with a reaction performed at 90° C. instead of 60° C. and with a reaction time of 6 hours instead of 12 hours. FIG. 6B shows a schematic diagram of a palladium-catalyzed coupling reaction between loratadine (63) and 4-methoxypiperidine (62).

FIGS. 7A-7C: Temperature Effects on Catalysis. FIG. 7A is a schematic diagram showing proposed temperature dependent routes to catalyst deactivation and reactivation. FIG. 7B is a graph showing ³¹P NMR spectra from a study verifying the off-cycle route shown in FIG. 7A. The bottom spectrum in FIG. 7B corresponds to a palladium (Pd)-catalyzed halide/amine cross-coupling reaction mixture quenched after the reaction was stirred for 1 hour at room temperature. The peak at −10.2 parts-per-million (ppm) corresponds to free AshPhos ligand, while the peak at 46 ppm corresponds to Pd-bound AshPhos. The middle spectrum corresponds to a Pd-catalyzed halide/amine cross-coupling reaction mixture quenched after 16 hours at room temperature. The top spectrum corresponds to a Pd-catalyzed halide/amine cross-coupling reaction mixture quenched after heating at 90° C. for 16 hours. FIG. 7C is (top) a schematic diagram showing the Pd-catalyzed cross-coupling reaction of heteroaryl bromide 65 or 66 with 2-methylpiperidine (67) to produce products 68 or 18; and (bottom) a graph showing the reaction yields (%) products 68 and 18 as a function of the identity of the monophosphine Pd ligand used in the reaction, i.e., GPhos or AshPhos.

FIGS. 8A and 8B: Cyanide-free Cyanation Reactions of Aromatic Halides using Transmetallation by Halogen-Nitrile Metathesis with Iron (Fe)/Pd-Containing Nanoparticles Stabilized by Hydroxypropyl Methylcellulose (HPMC). FIG. 8A is (top) a schematic diagram of a cyanide ion-free approach to nitrile formation via cyanation of an aryl halide substrate featuring transmetallation involving halogen-nitrile metathesis with mixed metal nanoparticles containing an AshPhos-Pd complex and potassium ferrocyanide as a bound cyanide reservoir; and (bottom) nitrile transfer to an aromatic group in the mixed metal nanoparticles. Pd is indicated by the oval shapes that coordinate to the aromatic (Ar) and bromide (Br) groups of the aryl halide substrate in the initial stage of the reaction. FIG. 8B is a graph showing ³¹P NMR spectra from a study of fresh and aged AshPhos-Pd-containing nanoparticles. The nanoparticles were prepared by stirring [Pd(crotyl)(AshPhos)Cl] in 0.1 wt % HPMC in D₂O at 60° C. for 30 minutes. The resulting nanoparticles were then aged at room temperature. The spectra in the graph correspond, from bottom to top, to nanoparticles aged for 0 hours, 8 hours, 24 hours, 48 hours, or 1 week prior to characterization.

FIG. 9 is a graph showing infrared (IR) spectra from a study performed to detect the presence or absence of free nitrile species in different solutions. From bottom to top, the spectra are of: an aqueous solution of 0.1 wt. % hydroxypropyl methylcellulose (0.1 wt. % aq. HPMC), the 0.1 wt. % HPMC solution further containing KCN (potassium cyanide), the 0.1 wt. % aq. HPMC solution further containing K₄[Fe(CH)₆]·3H₂O (potassium ferrocyanide), a standard reaction mixture for the Pd-catalyzed cyanation of an aryl halide using transmetallation with a Fe—Pd HPMC nanoparticle at time zero (reaction mixture at 0 h), and the standard reaction mixture after 24 hours (reaction mixture after 24 h).

FIGS. 10A-10H: Characterization of Pd-Containing Nanoparticles. FIG. 10A is a high-angle annular dark-field (HAADF)-scanning transmission electron microscopy (HAADF-STEM) image of ligated Pd nanoparticles (NP 1) prepared from an aqueous solution of HPMC, [Pd(crotyl)Cl]₂, and AshPhos in the absence of potassium ferrocyanide. The scale bar at the bottom represents 50 nanometers (nm). FIG. 10B is an energy-dispersive X-ray spectroscopy (EDS) mapping image of NP 1. The scale bar at the bottom left represents 0.5 micrometers (μm). FIG. 10C is a high-resolution transmission electron microscopy (HTREM) image of NP 1 clusters. The scale bar at the bottom left of the image represents 20 nm. FIG. 10D is a graph showing the x-ray photoelectron spectroscopy (XPS) analysis for Pd of NP 1. FIG. 10E is a HAADF-STEM image of ligated Pd nanoparticles (NP 2) prepared from a solution HPMC, [Pd(crotyl)Cl]₂, K₄[Fe(CN)₆]·3H₂O, and AshPhos. The scale bar at the bottom represents 100 nm. FIG. 10F is an EDS mapping image of NP 2. The scale bar at the bottom left represents 1 μm. FIG. 10G is a HTREM image of NP 2 clusters. The scale bar at the bottom left represents 10 nm. FIG. 10H is a graph showing the XPS analysis for Pd of NP 2.

FIG. 11 is a schematic diagram showing the conditions and exemplary scope of (hetero)aryl halide cyanation reactions involving transmetallation by halogen-nitrile metathesis catalyzed by a Pd-containing nanocatalyst and using potassium ferrocyanide (70) as a source of CN. The yields (%) of exemplary products 71, 73, 76-100 are provided. Standard conditions for the reaction are 0.5 mmol of aryl bromide, 0.25 equiv. of K₄[Fe(CN)₆]·3H₂O, 2.0 mol % [Pd(crotyl)Cl]₂, 4.0 mmo % AshPhos, 2.0 equiv. K₂CO₃, 1.0 mL 0.1 wt % HPMC, 60° C. Unless otherwise indicated, X is Br. Yields indicated by an asterisk (*) are for products prepared from reactions where conditions were altered to use 3.0 mol % [Pd(crotyl)Cl]₂ and 6.0 mol % AshPhos. Yields indicated by a double asterisk (**) indicate products where an aryl iodide was used as a substrate in place of an aryl bromide, where reaction conditions were altered to use 5.0 mol % [Pd(crotyl)Cl]₂, 10.0 mol % AshPhos, and where the reactions were run for 36 hours, leaving unreacted substrate but no by-product formation.

### DETAILED DESCRIPTION

The presently disclosed subject matter provides the design of new phosphine compounds for use as ligands in organometallic catalysts that are sustainable, scalable, and highly effective. These phosphines include electron-rich, monophosphine structures that are particularly effective for use in catalysts for cross-coupling reactions that involve challenging heteroaryl and bulky alkyl amine coupling substrates, as well as secondary amines, heteroaryl amines, boronic acids, Bpin esters, and various organometallic reagents, such as organozinc, organolithium, and organomagnesium compounds. The phosphines can also be used as ligands in catalysts for a cross-coupling cyanation reactions in aqueous solutions.

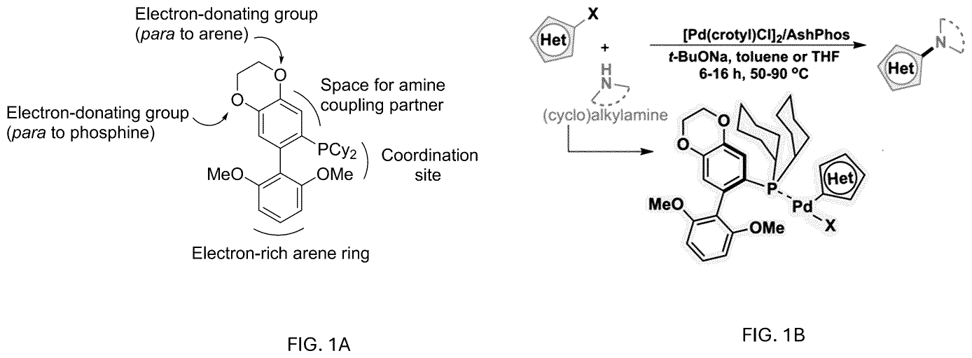

More particularly, a family of new monophosphine metal ligands (e.g., transition metal ligands), exemplified by AshPhos (see FIG. 1A), is described. These ligands represent an important advancement in palladium-catalyzed cross-coupling reactions, such as Buchwald-Hartwig aminations, overcoming many issues of existing ligands. Created using affordable and accessible materials, the exemplary monophosphine AshPhos enhances catalytic performance, particularly for difficult substrates. The successful synthesis and use of AshPhos as a ligand in catalytic aminations underscores its potential for employment in the sustainable synthesis of compounds of interest in the fields of medicinal chemistry, materials, and energy. More particularly, the effectiveness of AshPhos was observed in coupling reactions of challenging heteroaryl bromides and chlorides with various amines, including hindered and/or cyclic amines (see FIG. 1B) and amines with multiple heteroatoms. Use of slightly elevated temperatures reduced the formation of inactive species, providing for consistent catalytic turnover. Without being bound to any one theory, a study using nuclear magnetic resonance (NMR) spectroscopy suggested the formation of a catalytically dormant species of AshPhos from palladium at room temperature due to the coordination of multiple substrates with the palladium species. Analyses showed the cost-effectiveness of AshPhos, making it a note-worthy advancement in catalytic amination for more efficient and sustainable chemical processes. The diverse substrate scope, covering challenging coupling partners and forming over 55 products in good-to-excellent yields, further demonstrated the efficiency of AshPhos.

In addition, AshPhos was used as a Pd ligand in Pd-catalyzed, cyanide ion-free cyanation reactions of aryl halides using an approach featuring transmetalation via halogen-nitrile metathesis and using potassium ferrocyanide as a bound cyanide reservoir in a mixed metal nanoparticle. As described below, various studies confirmed that no free cyanide ion is released at any stage, eliminating toxicity and downstream cyanide liabilities. Stable AshPhos-Pd-containing nanoparticles formed in HPMC-containing solutions provided efficient cyanation across diverse aryl and heteroaryl bromides and chlorides under mild conditions, showing that this approach combines safety and environmental compliance, offering a scalable solution for late-stage nitrile installation.

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limited to the presently disclosed subject matter.

While the following terms are believed to be well understood by one of ordinary skill in the art, the following definitions are set forth to facilitate an explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate an explanation of the presently disclosed subject matter.

Following long-standing patent law convention, the terms “a” “an”, and “the” refer to “one or more” when used in this application, including in the claims. For example, the phrase “a solvent” refers to one or more solvents. Similarly, the phrase “at least one”, when employed herein to refer to an entity, refers to, for example, 1, 2, 3, 4, 5, 6, 7, 8, 9, 10, 15, 20, 25, 30, 35, 40, 45, 50, 75, 100, or more of that entity, including but not limited to whole number values between 1 and 100 and greater than 100.

Unless otherwise indicated, all numbers expressing quantities of ingredients, reaction conditions, and so forth used in the specification and claims are to be understood as being modified in all instances by the term “about”. The term “about”, as used herein when referring to a measurable value such as an amount of mass, weight, time, temperature, volume, concentration, or percentage, is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods and/or employ the disclosed compositions. Accordingly, unless indicated to the contrary, the numerical parameters set forth in this specification and attached claims are approximations that can vary depending upon the desired properties sought to be obtained by the presently disclosed subject matter.

As used herein, the term “and/or” when used in the context of a list of entities, refers to the entities being present singly or in combination. Thus, for example, the phrase “A, B, C, and/or D” includes A, B, C, and D individually, but also includes any and all combinations and subcombinations of A, B, C, and D.

The term “comprising”, which is synonymous with “including” “containing”, or “characterized by”, is inclusive or open-ended and does not exclude additional, unrecited elements and/or method steps. “Comprising” is a term of art that means that the named elements and/or steps are present, but that other elements and/or steps can be added and still fall within the scope of the relevant subject matter.

As used herein, the phrase “consisting essentially of” limits the scope of the related disclosure or claim to the specified materials and/or steps, plus those that do not materially affect the basic and novel characteristic(s) of the disclosed and/or claimed subject matter.

As used herein, the phrase “consisting of” excludes any element, step, or ingredient not specifically recited. It is noted that, when the phrase “consists of” appears in a clause of the body of a claim, rather than immediately following the preamble, it limits only the element set forth in that clause; other elements are not excluded from the claim as a whole.

With respect to the terms “comprising”, “consisting of”, and “consisting essentially of”, where one of these three terms is used herein, the presently disclosed and claimed subject matter can include the use of either of the other two terms.

As used herein the term “alkyl” refers to C₁-C₂₀ inclusive, linear (i.e., “straight-chain”), branched, or cyclic, saturated or at least partially and in some cases fully unsaturated (i.e., alkenyl, and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. In some embodiments, the alkyl group is “lower alkyl.” “Lower alkyl” refers to an alkyl group having 1 to about 8 carbon atoms (i.e., a C₁-C₈ alkyl), e.g., 1, 2, 3, 4, 5, 6, 7, or 8 carbon atoms. In some embodiments, the alkyl is “higher alkyl.” “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁-C₈ straight-chain alkyls. In other embodiments, “alkyl” refers, in particular, to C₁-C₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. There can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

The term “aryl” is used herein to refer to an aromatic moiety that can be a single aromatic ring, or multiple aromatic rings that are fused together, linked covalently, or linked to a common group, such as, but not limited to, a methylene or ethylene moiety. The common linking group also can be a carbonyl, as in benzophenone, or oxygen, as in diphenylether, or nitrogen, as in diphenylamine. The term “aryl” specifically encompasses heterocyclic aromatic compounds. The aromatic ring(s) can comprise phenyl, naphthyl, biphenyl, diphenylether, diphenylamine, and benzophenone, among others. In some embodiments, the term “aryl” means a cyclic aromatic comprising about 5 to about 10 carbon atoms, e.g., 5, 6, 7, 8, 9, or 10 carbon atoms, and including 5- and 6-membered hydrocarbon and heterocyclic aromatic rings.

The aryl group can be optionally substituted (a “substituted aryl”) with one or more aryl group substituents, which can be the same or different, wherein “aryl group substituent” includes alkyl, substituted alkyl, aryl, substituted aryl, aralkyl, hydroxyl, alkoxyl, aryloxyl, aralkyloxyl, carboxyl, carbonyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, wherein R′ and R″ can each be independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

Specific examples of aryl groups include, but are not limited to, cyclopentadienyl, phenyl, naphthyl, furan, thiophene, pyrrole, pyran, pyridine, imidazole, benzimidazole, isothiazole, isoxazole, pyrazole, triazole, pyrazine, triazine, tetrazole, pyrimidine, quinoline, isoquinoline, indole, carbazole, and the like.

The term “heteroaryl” refers to aryl groups wherein at least one atom of the backbone of the aromatic ring or rings is an atom other than carbon. Thus, heteroaryl groups have one or more non-carbon atoms selected from the group, including but not limited to, nitrogen, oxygen, and sulfur. The term “N-heteroaryl” refers to heteroaryl groups comprising one or more nitrogen atoms, such as, but not limited to, pyrazole, imidazole, tetrazole, and triazole.

The term “(hetero)aryl” as used herein refers to compounds comprising hydrocarbon or heterocyclic aromatic rings or to the hydrocarbon or heterocyclic aromatic ring moieties themselves. The aryl or heteroaryl moieties can optionally be substituted by one or more functional groups.

As used herein, the term “acyl” refers to a represented by RC(═O)—, wherein R is an alkyl or an aryl group as defined herein. As such, the term “acyl” specifically includes arylacyl groups, such as an acetylfuran and a phenacyl group. Specific examples of acyl groups include acetyl and benzoyl.

“Cyclic” and “cycloalkyl” refer to a non-aromatic mono- or multicyclic ring system of about 3 to about 10 carbon atoms, e.g., 3, 4, 5, 6, 7, 8, 9, or 10 carbon atoms. The cycloalkyl group can be optionally partially unsaturated. The cycloalkyl group also can be optionally substituted with an alkyl group substituent as defined herein, oxo, and/or alkylene. There can be optionally inserted along the cyclic alkyl chain one or more oxygen, sulfur or substituted or unsubstituted nitrogen atoms, wherein the nitrogen substituent is hydrogen, alkyl, substituted alkyl, aryl, or substituted aryl, thus providing a heterocyclic group. Representative monocyclic cycloalkyl rings include cyclopentyl, cyclohexyl, and cycloheptyl. Multicyclic cycloalkyl rings include adamantyl, octahydronaphthyl, decalin, camphor, camphane, and noradamantyl.

The terms “heterocycle” or “heterocyclic” refer to cycloalkyl groups (i.e., non-aromatic, cyclic groups as described hereinabove) wherein one or more of the backbone carbon atoms of a cyclic ring is replaced by a heteroatom (e.g., nitrogen, sulfur, or oxygen). Examples of heterocycles include, but are not limited to, tetrahydrofuran, tetrahydropyran, morpholine, dioxane, piperidine, piperazine, and pyrrolidine.

“Alkylene” refers to a straight or branched bivalent aliphatic hydrocarbon group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be optionally unsaturated and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Exemplary alkylene groups include methylene (—CH₂—); ethylene (—CH₂—CH₂—); propylene (—(CH₂)₃—); cyclohexylene (—C₆H₁₀—); —CH═CH—CH═CH—; —CH═CH—CH₂—; —(CH₂)_{q}—N(R)—(CH₂)ᵣ—, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 2 to about 3 carbon atoms and can further have 6-20 carbons.

“Alkoxyl” or “alkoxy” refer to an alkyl-O— group wherein alkyl is as previously described. The term “alkoxyl” as used herein can refer to, for example, methoxyl, ethoxyl, propoxyl, isopropoxyl, butoxyl, t-butoxyl, and pentoxyl. The term “oxyalkyl” can be used interchangably with “alkoxyl”.

“Aryloxy” or “aryloxyl” refer to an aryl-O— group, where aryl is as previously described. Exemplary aryloxy groups include phenoxy.

“Aralkyl” refers to an aryl-alkyl-group wherein aryl and alkyl are as previously described and include substituted aryl and substituted alkyl. Exemplary aralkyl groups include benzyl (C₆H₅—CH₂—), phenylethyl, and naphthylmethyl.

The term “amino” refers to the —NR′R″ group, wherein R′ and R″ are each independently selected from the group including H and substituted and unsubstituted alkyl, cycloalkyl, aralkyl, and aryl. In some embodiments, the amino group is —NH₂. In some embodiments, R′ and R″, taken together with the nitrogen atom to which they are attached, form a heterocyclic ring having from 4 to 8 atoms (i.e., R′ and R″ together form an alkylene group, wherein optionally one or more carbon atoms of the alkylene group are replaced by an oxygen, sulfur or NH group). Amino groups can be primary (where R′ and R″ are each H), secondary (where one of R′ and R″ is H and the other is substituted or unsubstituted alkyl, cycloalkyl, aralkyl, or aryl), or tertiary (where both R′ and R″ are independently substituted or unsubstituted alkyl, cycloalkyl, aralkyl, or aryl), and in cationic form, may be quaternary (—⁺NH₁(R′)(R″)). Examples of amino groups include, but are not limited to, —NH₂, —NHCH₃, —NHC(CH₃)₂, —N(CH₃)₂, —N(CH₂CH₃)₂, and —NHPh. Examples of cyclic amino groups include, but are not limited to, aziridino, azetidino, pyrrolidino, piperidino, piperazino, morpholino, and thiomorpholino. Cyclic amino groups include single nitrogen-containing cyclic structures, as well as nitrogen-containing cyclic structures that are substituted by one or more substituents and/or fused to other cyclic groups to provide multi-ring structures.

The term “amine” refers to a compound having the structure N(R)₃ where each R is independently selected from H, alkyl, substituted alkyl, cycloalkyl, substituted cycloalkyl, aralkyl, substituted aralkyl, aryl, and substituted aryl. The term “primary amine” refers to an amine where two R groups are H and one R group is alkyl, substituted alkyl, cycloalkyl, substituted cycloalkyl, aralkyl, substituted aralkyl, aryl, or substituted aryl. The term “secondary amine” refers to an amine where one R group is H and two R groups are independently alkyl, substituted alkyl, cycloalkyl, substituted cycloalkyl, aralkyl, substituted aralkyl, aryl, or substituted aryl. The term “tertiary amine” refers to an amine where none of the three R groups is H. The term “(cyclo)alkylamine” as used herein refers to mono-, di-, and trialkylamines, as well as cyclic amines (e.g., nitrogen-containing heterocycles, such as pyrrolidine and piperidine, where the pyrrolidine or piperidine ring can be optionally substituted with one or more atoms or functional groups).

The term “carbonyl” refers to the —(C═O)— or a double bonded oxygen substituent attached to a carbon atom of a previously named parent group.

The terms “halo”, “halide”, or “halogen” as used herein refer to fluoro, chloro, bromo, and iodo groups.

The term “haloalkyl” can be used to refer to an alkyl group wherein one or more hydrogen atoms have been replaced by halo groups.

The term “perhaloalkyl” refers to an alkyl group wherein all of the hydrogen atoms are replaced by halo. Thus, for example, perhaloalkyl can refer to a “perfluroalkyl” group wherein all of the hydrogen atoms of the alkyl group are replaced by fluoro. Perhaloalkyl groups include, but are not limited to, trifluoromethyl (—CF₃).

The terms “hydroxyl” and “hydroxy” refer to the —OH group. Alcohols and phenols include at least one hydroxy group.

The terms “mercapto” and “thiol” refer to the —SH group.

The terms “carboxylate” and “carboxylic acid” refer to the groups —C(═O)—O⁻ and —C(═O)—OH, respectively.

The term “phosphine” refers to the compounds having the structure P(R)₃ or substituents having the structure —P(R)₂, where each R is independently H, alkyl, substituted alkyl, aralkyl, substituted aralkyl, aryl, or substituted aryl. The term “monophosphine” refers to an organic compound containing one —P(R)₂ group.

The term “sulfonate” refers to a group having the structure —OS(═O)₂R, where R is alkyl, substituted alkyl, aryl, or substituted aryl.

The term “sulfonate ester” refers to a compound having the formula R′—OS(═O)₂R, wherein R′ and R are each alkyl, substituted alkyl, aryl, or substituted aryl. For example, a (hetero)aryl sulfonate ester is a compound of the formula R′—OS(═O)₂R, where R′ is an aryl, substituted aryl, heteroaryl, or substituted heteroaryl group.

The terms “coordination complex” and “complex” as used herein, e.g., with respect to a “palladium complex”, refer to a compound in which there is a coordinate bond between a metal ion and an electron pair donor, ligand or chelating group. Thus, ligands or chelating groups are generally electron pair donors, molecules or molecular ions having one or more electron pairs available for donation to a metal ion. For example, an alkene can donate electrons from its π-orbital to empty orbitals on the metal ion.

The term “coordinate bond” refers to an interaction between an electron pair donor and a coordination site on a metal ion resulting in an attractive force between the electron pair donor and the metal ion. The use of this term is not intended to be limiting, in so much as certain coordinate bonds can be classified as having more or less covalent character (if not entirely covalent character) depending on the characteristics of the metal ion and the electron pair donor.

As used herein, the term “ligand” refers generally to a species, such as a molecule or ion, that interacts, e.g., binds in some way, with another species. More particularly, as used herein, the term ligand refers to a molecule or ion that binds a metal ion in solution to form a “coordination complex”. See Martell A. E. and Hancock, R. D., Metal Complexes in Aqueous Solutions, Plenum: New York (1996).

The terms “nanoparticle” and “nano” refer to structures having at least one region with a dimension (e.g., a length, width, diameter, etc.) of less than about 1,000 nanometers (nm). In some embodiments, the dimension is smaller (e.g., less than about 500 nm, less than about 250 nm, less than about 200 nm, less than about 150 nm, less than about 100 nm, less than about 75 nm, less than about 50 nm, less than about 25 nm, or less than about 10 nm). Nanoparticles can have any shape. When the nanoparticle is approximately spherical, the characteristic dimension of the nanoparticle can be the diameter of the sphere. Nanoparticles can also be disc-shaped, plate-shaped, oblong, polyhedral, rod-shaped, cubic, or irregularly shaped.

The terms “aprotic solvent” and “aprotic organic solvent” as used herein refer to a solvent typically used in the field of organic synthesis and that does not include an O—H or N—H bond and, thus, do not act as proton donors in hydrogen bonding. Aprotic solvents can be polar or non-polar. Examples of polar aprotic solvents include, but are not limited to, acetone, acetonitrile (ACN), dichloromethane (DCM), dimethylacetamide, dimethylformamide (DMF), N-methylpyrrolidone (NMP), dimethyl sulfoxide (DMSO), ethyl acetate, and tetrahydrofuran (THF). Examples of non-polar aprotic solvents include, but are not limited to, pentane, hexane, benzene, chloroform, diethyl ether, 1,4-dioxane, and toluene. In contrast, “protic solvents”, include solvents such as water and alcohols (e.g., methanol, ethanol, propanol) that can act as proton donors in hydrogen bonding.

### II. Cross-Coupling Reactions

### II.A. Amination Reactions

The significance of C—N bond formation in medicinal chemistry is underscored by the fact that over 62% of bioactive molecules discussed in the literature feature C—N bonds (Vitaku et al. 2014; Roughley and Jordon, 2011). While nucleophilic aromatic substitution (SNAr) reactions can form C—N bonds when aryl halides are activated (Borlinghaus et al., 2021; Kumar et al., 2016), the Buchwald-Hartwig amination stands out as a highly useful method for constructing such bonds in unactivated substrates (Ruiz-Castillo and Buchwald, 2016; Old et al., 1998). Its prominence is evident by being one of the top 20 most utilized reactions in the field (Campeau and Hazari, 2018; Cooper et al., 2010). Despite its broad applicability, the Buchwald-Hartwig amination is often challenging for certain substrates (Dorel et al, 2019; Sather and Martinot, 2019; Matthews et al., 2023). Hindered or sterically demanding amines, as well as five- and six-membered heteroaryl halides, often show reduced or no reactivity (Hooper et al., 2003; Khadra et al., 2017). This is typically due to the decomposition of ligated palladium species or the active catalyst or substrate, necessitating the use of specialized ligands (Reichert et al., 2023). For example, a moderate base can prevent the base-mediated decomposition of sensitive five-membered heteroarenes, which can otherwise lead to no catalysis. Additionally, Pd catalysts with suitable donicity and sterics can be used to resist heteroarene-induced catalyst deactivation while promoting efficient coupling.

Several classes of transition metal ligands, e.g., phosphines, H-heterocyclic carbene (NHC), sulfonated amines, functional polymers, functional micelles, and bipyridines, have been developed to improve C—N cross-coupling reactions, e.g., by providing effective catalysis under milder conditions and/or expanding the substrate scope for the reaction. Phosphine ligands include, for example, dialkyl biaryl monophosphines, sometimes referred to as “Buchwald phosphines” or “Buchwald ligands”, which can be used in Buchwald-Hartwig amination and etherification reactions, as well as in Negishi cross-coupling, Suzuki-Miyaura cross-coupling, and other reactions. In addition to Pd, they can also be used as ligands for other transition metal-based catalysts (e.g., in nickel (Ni) or copper (Cu)-based catalysts). Exemplary dialkyl biaryl monophosphine ligands known in the art, i.e., BrettPhos, EPhos, GPhos, XPhos, and t-BuXPhos, are shown in Scheme 1, below. BrettPhos, for instance, is a ligand that can be used for primary amine arylation, EPhos can be used in reactions with five-membered heterocycles, and GPhos can be used for secondary amine arylation.

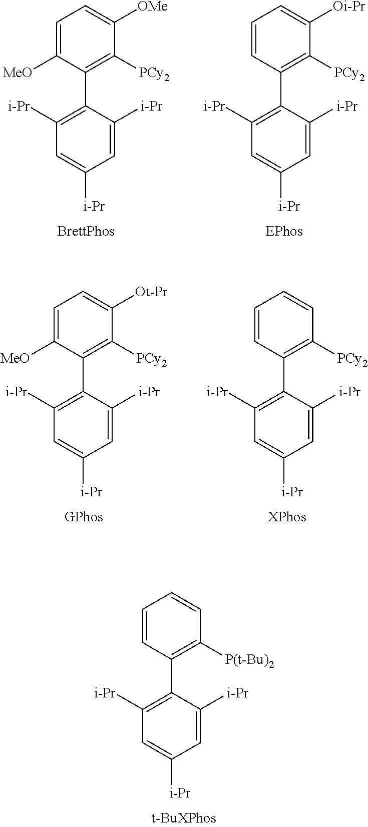

### Scheme 1. Exemplary Phosphine Ligands.

In particular, GPhos is a Pd catalyst ligand known for providing good reactivity (Reichert et al., 2023; McCann et al., 2020). GPhos can be synthesized in five steps from 2-fluoro-1,4-dimethoxybenzene in an overall yield of about 18%. However, the cost involved with this synthesis can be prohibitive, especially when the ligand is required in a large amount (Iyer et al., 2024). Thus, while GPhos presents considerable benefits for Buchwald-Hartwig amination reactions, there remains a need for developing additional reactive ligands that are more sustainable. These alternative ligands can be used to both mitigate the limitations of GPhos and expand the efficiency and scope of this important synthetic transformation.

### II.B. Cyanation Reactions

In addition to complex amines that can be prepared via metal-catalyzed cross-coupling reactions, aryl nitriles also represent a versatile and widely used fragment across numerous sectors of the chemical industry. Their inherent stability, polarity, and capacity for downstream functionalization make them integral to materials science, polymer chemistry, dyes and pigments, coordination chemistry, electronic and optical materials, and industrial fine chemicals (Sruthi and Anas, 2020; Miller and Manson, 2001). Beyond materials and industrial applications, aryl nitriles are particularly prominent in agrochemistry, where nitrile-containing scaffolds are widely incorporated into herbicides, insecticides, fungicides, and acaricides (Sousa et al., 2020). The nitrile group often enhances bioavailability, metabolic stability, and environmental persistence in a controllable way, contributing to the success of key agrochemical classes. Numerous widely used pesticides, including phenyl and heteroaryl nitrile derivatives, rely on the cyano group for potency and selectivity, highlighting its strategic importance in global crop protection and food security-driven innovation. Within the pharmaceutical industry, aryl nitriles are equally indispensable. They appear in approved drugs, clinical candidates, and medicinal chemistry leads due to the —CN group's ability to enhance protein binding, modulate lipophilicity, serve as a weak hydrogen-bond acceptor, and improve metabolic stability, acting as a bioisostere for carbonyl or halogen substituents (Jones et al., 2010). Over thirty FDA-approved small-molecule drugs feature nitrile groups, with many more in development (Fleming et al., 2010; Anbarasan et al., 2011). The cyano group's properties, i.e., vectorial geometry, a weakly basic nitrogen lone pair, and a tunable dipole, allow for precise structure-activity relationships and water-displacing interactions in protein active sites (see Jones et al., 2010; Fleming et al., 2010; Anbarasan et al., 2011; Wang et al., 2021). Analyses from DrugBank, ChEMBL, and the PDB emphasize the nitrile's role in boosting binding affinity and mimicking bound waters, highlighting its importance in drug design (Wang et al., 2018).

Classical routes to aryl nitriles date to the late 19th and early 20th centuries. Sandmeyer cyanation converts aryl diazonium salts to benzonitriles under copper catalysis via radical-nucleophilic aromatic substitution (Sandmeyer, 1884); despite refinements, the transformation still hinges on handling thermally sensitive diazonium salts and CuCN (Hodgson, 1947). Complementarily, the Rosenmund-von Braun reaction replaces aryl halides with cyanide using stoichiometric CuCN at elevated temperatures (Rosenmund and Stuck, 1919), with well-documented challenges in functional-group tolerance and purification (wen et al., 2014). As a strategic lever, amide dehydration (e.g., with POCl₃, SOCl₂, P₂O₅, or diverse phosphorus/silane systems) is effective for converting carboxylic acids into nitriles (Ganesan and Nagaraaj, 2020); however, it does not provide a general solution for the direct cyanation of aryl halides within convergent cross-coupling (Anbarasan et al., 2011).

Over the past five decades, transition-metal catalyzed-cross-coupling, e.g., palladium catalysis, has modernized aryl cyanation (Anbarasan et al., 2011), yet a persistent mechanistic challenge remains: soluble cyanide binds Pd(II) strongly, forming catalytically inactive off-cycle species that suppress turnover (Erhardt et al., 2008). Beyond this, traditional cyanations impose three major liabilities: (i) process safety, as free cyanide (CN⁻/HCN) is acutely toxic and subject to strict regulatory controls for air emissions, wastewater, storage, and worker protection (Jaszczak et al., 2017); (ii) catalyst deactivation, where highly mobile cyanide competes for Pd ligation, blocking oxidative addition and transmetallation, necessitating high temperatures, specialized ligands, slow-dose protocols, or biphasic media (Erhardt et al., 2008; Sudermeier et al., 2003; Senecal et al., 2013); and (iii) end-of-pipe burden, since “total cyanide” assays capture both free CN⁻ and cyanide released from complexes upon acid distillation, shifting liability downstream and increasing monitoring and treatment costs (U.S. Environmental Protection Agency (EPA), 1993). In manufacturing, cyanide is regulated under air toxics and wastewater programs, with municipal discharge limits for total cyanide often in the single-digit g/L range to protect aquatic life (U.S. Environmental Protection Agency (EPA), 1985). Consequently, processes that mobilize free cyanide, even transiently, incur significant compliance overhead and remediation steps.

In cross-couplings, efforts to avoid alkali cyanides include insoluble or “less toxic” surrogates (Zn(CN)₂, acetone cyanohydrin), slow dosing, biphasic systems, and, more recently, ferrocyanide (K₄[Fe(CN)₆]), leveraging its low bioavailability and strong iron-cyanide bonding to mitigate acute hazards (Cohen and Buchwald, 2015; Thakore et al., 2021; and Jinho et al., 2012). Yet, even these strategies typically depend on releasing CN⁻ in situ to intercept the metal center, leaving process windows where free cyanide can still exist and risk poisoning the catalyst, health, and environment (Jaszczak et al., 2017; Sundermeier et al., 2003; Senecal et al., 2013; EPA, 1993; EPA, 1985). Parallel advances deploy masked electrophilic “cyanide equivalents” (e.g., oxazole-based or latent CN transfer reagents) that sidestep free CN⁻ entirely (Schuppe et al., 2019); but these generally target C(sp2/sp) coupling sequences or heteroatom cyanations via multi-step surrogacy rather than a single-step, direct cyanide-free cross-coupling from aryl halides (Sharma et al., 2022). In short, the field lacks a general, cyanide-free direct installation platform that couples aryl halides to nitriles without transient free-cyanide and without sacrificing the breadth and practicality expected of modern cross-couplings.

### III. Electron-Rich Monophosphine Ligands, Pre-Catalyst Metal Complexes Thereof, and Methods of Performing Catalyzed Reactions Using the Metal Complexes

According to one aspect, the presently disclosed subject provides family of electron-rich biaryl monophosphine ligands that promote chelation. The ligands can be prepared from inexpensive materials using relative few synthetic steps, e.g., one to two steps. Their design is rooted in the concepts of chelation and cooperativity, with the aim of facilitating chelation without synthetic complications (Hamann and Hartwig, 1998; Handa et al., 2016; Imamoto, 2016). The design process also prioritized using inexpensive materials, cost-effectiveness, and synthesis that conserves resources, thereby promoting advancements in sustainable catalysis. One example of this family of ligands is referred to herein as AshPhos. See FIG. 1A.

The design hypothesis for AshPhos posits that 6,7-dibromo-2,3-dihydrobenzo-[b][1,4]dioxine (1), an affordable starting material featuring two ether units, is ideal for the installation of phosphine at the para position relative to one ether. At the same time, an electron-rich aryl ring can be introduced para to the second ether unit and ortho to the electron-rich phosphine. This configuration yields a highly electron-rich and stable phosphine, conducive to facile oxidative addition and effective chelation. The use of the 2,6-dimethoxyphenyl ring as the secondary aryl ring can be judicious due to its cost-effectiveness, natural derivation from resorcinol, electron-rich nature, and chelating properties. The preference for a dioxane ring over two methoxy substituents stems from the conformational rigidity and stability of the dioxane ring (Imamoto, 2016). The absence of substituents at the sp2 carbon atoms of the benzodioxane ring provides space for the amine coupling partner to interact with palladium. Additionally, the absence of a substituent at the 4-position of the lower aryl ring can create a more open environment in the catalyst, allowing bulky nucleophiles to bind effectively for trans-metalation. Consequently, this ligand is designed to enhance chelation, facilitate oxidative addition, and promote efficient transmetallation, thereby providing for effective amination of challenging substrates.

Accordingly, in some embodiments, the presently disclosed subject matter provides a monophosphine compound for use as a transition metal ligand (e.g., in a transition metal catalyst for use in catalyzing organic transformations, such as cross-coupling reactions). In some embodiments, the compound has a structure of Formula (I):

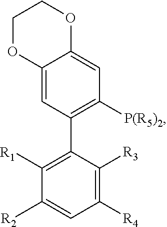

wherein: R₁ and R₃ are independently selected from C₁-C₆ alkyl, C₁-C₆ alkoxy, and —N(R₆)₂; R₂ and R₄ are independently selected from H, C₁-C₆ alkyl, C₁-C₆ alkoxy, benzyl, substituted benzyl, and —N(R₆)₂; or wherein R₁ and R₂ together and/or R₃ and R₄ together are —CH═CH—CH═CH— or —O—(C(R₇)₂)ₙ—O—, wherein n is 1 or 2 and each R₇ is H or halo (e.g., —F); R₅ is selected from the group consisting of alkyl (e.g., C₁-C₆ alkyl), cycloalkyl, aryl, 2-pyridyl, and N(R₆)₂; and each R₆ is independently a C₁-C₆ alkyl group (i.e., each R₆ group is a C₁-C₆ alkyl group, e.g., methyl or ethyl, where each R₆ group can be the same as or different to any other R₆ group present in the compound).

In some embodiments, one or both of R₁ and R₃ is a C₁-C₆ alkoxy group, such as methoxy, ethoxy, isopropoxy, sec-butoxy, etc. In some embodiments, at least one of R₁ and R₃ is methoxy. In some embodiments, R₁ and R₃ are both methoxy. In some embodiments, one or both of R₂ and R₄ is H. In some embodiments, R₂ and R₄ are both H.

In some embodiments, R₁ and R₂ together are —O—(C(R₇)₂)ₙ—O— group (i.e., where n is 1 or 2 and each R₇ is independently H or halo). Thus, the bottom aryl ring of the compound of Formula (I) can be fused to another ring structure. In some embodiments, n is 1 and each R₇ is H or F. In some embodiments, n is 1 and each R₇ is H, such that R₁ and R₂ together form the group —O—CH₂—O—. In some embodiments, R₃ and R₄ together are —O—(C(R₇)₂)ₙ—O—. In some embodiments, each R₇ is H or F and n is 1. In some embodiments, n is 1 and each R₇ is H i.e., such that R₃ and R₄ together are —O—CH₂—O—. In some embodiments, R₁ and R₂ together and R₃ and R₄ together are both —O(C(R₇)₂)ₙ—O— groups (e.g., both R₁ and R₂ together and R₃ and R₄ together are —O—CH₂—O— or —O—CF₂—O—).

In some embodiments, each R₅ is C₁-C₆ alkyl, for example, methyl (Me), ethyl (Et), n-propyl, isopropyl, n-butyl, sec-butyl, tert-butyl, n-pentyl, 2,2-dimethylpropyl, 1,1-dimethylpropyl, 3-methylbutyl, 1-methylbutyl, 2-methylbutyl, n-hexyl, 1-methylpentyl, 2-methylpentyl, 3-methylpentyl, 4-methylpentyl, 1-ethylbutyl, 2-ethylbutyl, etc. In some embodiments, each R₅ is tert-butyl (t-Bu). In some embodiments, each R₅ is cycloalkyl, such as cyclopropyl, cyclopentyl or cyclohexyl. In some embodiments, each R₅ is cyclohexyl (Cy).

In some embodiments, the compound is selected from the group comprising:

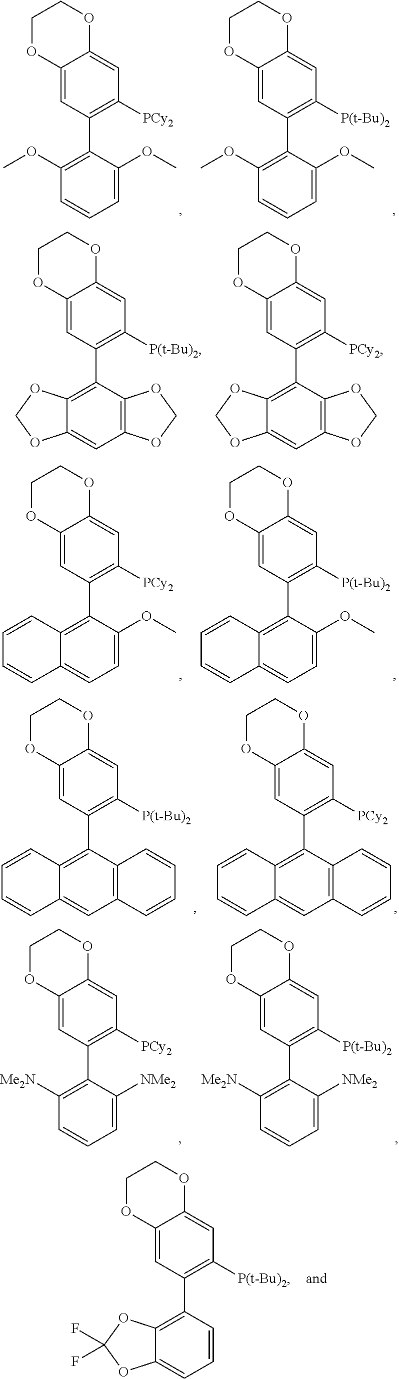

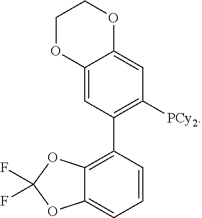

In some embodiments, the compound of Formula (I) is AshPhos, i.e.,:

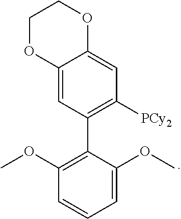

As noted above, the compounds of Formula (I) can serve as metal ligands in catalytic and pre-catalytic metal complexes. Thus, in some embodiments, the presently disclosed subject matter provides a metal complex comprising a metal ion and a monophosphine ligand where the monophosphine ligand is a compound of Formula (I). The metal ion can be any suitable metal ion. For example, the metal ion can be an ion of a transition metal, such as, but not limited to, Pd, nickel (Ni), copper (Cu), gold (Au), silver (Ag), rhodium (Rh), ruthenium (Ru), platinum (Pt), and iridium (Ir). Typically, the metal complex can also include one or more additional metal ion ligands, each of which can be selected from the group comprising, for example, a carbon ligand, such as, but not limited to a carbene or an olefin; a nitrogen ligand, such as an amine or an imine; a halide (i.e., F, Cl, Br, or I); a sulfonate, such as, but not limited to trifluoromethanesulfonate (i.e., triflate (OTf)) or another perfluoroalkanesulfonate (e.g., pentafluoroethanesulfonate heptafluoropropanesulfonate, or nonafluorobutanesulfanate), an aryl or substituted arylsulfonate, such as toluenesulfonate (i.e., tosylate (OTs)), or an alkylsulfonate, such as methanesulfonate (i.e., mesylate (OMs)); tetrafluoroborate; hexafluoroborate; hexafluorophosphate; hexafluoroantimonate; tetraphenylborate; a carboxylate (e.g., acetate (OAc) or trifluoroacetate); acetylacetonate (acac); or triflimide.

In some embodiments, the presently disclosed subject matter provides a pre-catalyst palladium complex comprising a palladium ion and a monophosphine ligand where the monophosphine ligand is a compound of Formula (I). Typically, the pre-catalyst palladium complex includes one monophosphine ligand and one or more additional ligands (i.e., ligands other than the monophosphine ligand of Formula (I)). In some embodiments, the pre-catalyst palladium complex comprises two additional ligands. In some embodiments, the pre-catalyst palladium complex is a stable (e.g., air-stable and/or moisture stable) palladium complex that can form an oxidative addition complex (OAC) when contacted with a (hetero)aryl halide or (heter)aryl sulfonate ester (e.g., to exchange two non-phosphine ligands from the pre-catalyst palladium complex with the halide and (hetero)aryl groups from the (hetero)aryl halide).

In some embodiments, the pre-catalyst palladium complex has a structure of Formula (II):

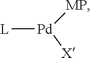

(which can also be written as [Pd(L)(MP)X′]), where MP is a monophosphine ligand having a structure of Formula (I), L is a carbon ligand (e.g., an olefin), and X′ is a weakly coordinating or non-coordinating ligand, such as, but not limited to, a halide (e.g., Br or Cl), a perfluoroalkanesulfonate (e.g., OTf), an arylsulfonate (e.g., OTs), an alkylsulfonate (e.g., OMs), tetrafluoroborate, hexafluoroborate, hexafluorophosphate, hexafluoroantimonate, tetraphenylborate, OAc, acac, trifluoroacetate, or triflimide. In some embodiments, L is an olefin, such as, but not limited to, crotyl alcohol (crotyl, i.e., 2-buten-1-ol), 1-propene (allyl), cinnamyl alcohol (cinnamyl, i.e., 3-phenylprop-2-en-1-ol); cyclooctadiene (cod), and dibenzylideneacetone (dba). n some embodiments, the pre-catalyst palladium complex has the formula [Pd(crotyl)(MP)X′]. In some embodiments, X′ is a halide, e.g., Cl. In some embodiments, MP is AshPhos and the pre-catalyst palladium complex has the formula [Pd(crotyl)(AshPhos)X′], e.g., [Pd(crotyl)(AshPhos)Cl]. In some embodiments the pre-catalyst palladium complex has the formula [Pd(L)(AshPhos)X′]. In some embodiments, the pre-catalyst palladium complex has the formula [Pd(olefin)(AshPhos)X′], where X′ is a halide, e.g., Cl.

The pre-catalyst palladium complex can be formed, for example, by contacting a compound of Formula (I) (i.e., a monophosphine ligand) with a palladium precursor compound (also referred to herein as a “palladium source”). The palladium source can be a palladium compound or salt, such as, but not limited to, [Pd(crotyl)Cl]₂, [Pd(allyl)Cl]₂, Pd₂dba₃, Pd(OAc)₂, PdBr₂, [Pd(cinnamyl)Cl]₂, (COD)PdCH₂C(Me)₂Ph, and Pd(cod)Cl₂. In some embodiments, the contacting can be performed in an aprotic organic solvent. In some embodiments, the aprotic organic solvent is non-polar solvent, such as, but not limited to, an alkane (e.g., n-hexane), an aromatic solvent (e.g., benzene or toluene), or a non-polar ether. In some embodiments, the aprotic solvent is a more polar aprotic solvent, such as THF. In some embodiments, the contacting is performed under an inert atmosphere (e.g., a nitrogen or argon atmosphere). In some embodiments, the contacting comprises contacting the monophosphine ligand with about 0.5 molar equivalents of the palladium source.

In some embodiments, the presently disclosed subject matter provides a method of performing a palladium-catalyzed coupling reaction (e.g., palladium-catalyzed cross-coupling reaction, such as, but not limited to, a Buchwald-Hartwig amination, a Suzuki reaction, a Kumada reaction, a Stille reaction, a Heck reaction, a Negishi reaction, or a Hiyama coupling). The method comprises contacting a suitable substrate or substrates for the coupling reaction (i.e., “coupling partners) in the presence of a pre-catalyst palladium complex to form a new compound (i.e., a “product” of the cross-coupling reaction) that contains a carbon-carbon, carbon-nitrogen, carbon-sulfur, or carbon-oxygen bond that was not present in the substrate or substrates. In some embodiments, there are two different substrates, i.e., a “first substrate” and a “second substrate”. In some embodiment, the first substrate is an alkyl or (hetero)aryl halide or an alkyl or (hetero)aryl sulfonate ester. When the new bond being formed is a carbon-nitrogen bond (i.e., when the cross-coupling reaction is an amination), the second substrate can be an amine. When the new bond being formed is a carbon-oxygen or carbon-sulfur bond, the second substrate can be an alcohol or a thiol. When the new bond being formed is a carbon-carbon bond, the second substrate can be selected from the group including, for example, an organoboronic acid or ester, an organomagnesium halide, an organostannane, an organozinc compound, an activated alkene, and an organosilane.

The pre-catalyst palladium complex can be prepared prior to contacting the pre-catalyst palladium complex with the substrate or substrates (e.g., the first substrate and the second substrate) or can be prepared in situ in the reaction mixture with the substrate or substrates. Accordingly, in some embodiments, the method comprises contacting (al) a monophosphine compound having a structure of Formula (I) and a palladium compound or salt, or (a2) a pre-catalyst palladium complex comprising a palladium ion and a monophosphine ligand having a structure of Formula (I), e.g., a complex having a structure of Formula (II), with a first substrate and/or a second substrate.

In some embodiments, the pre-catalyst palladium complex is prepared prior to contact with the cross-coupling partners. The pre-catalyst palladium complex can be a pre-catalyst palladium complex prepared previously and stored as a dried solid. In such cases, the pre-catalyst palladium complex can be dissolved in an aprotic solvent to prepare a pre-catalyst complex solution just prior to contacting the cross-coupling partners with the solution containing the complex. Alternatively, the pre-catalyst complex can be prepared in a solution that is then directly added to a cross-coupling reaction mixture (i.e., without isolating the pre-catalyst palladium complex). Thus, in some embodiments, the method comprises: (a) contacting a monophosphine ligand (i.e., a compound of Formula (I)) with about 0.5 molar equivalents of a palladium compound or salt in a first aprotic solvent; thereby preparing a solution comprising the pre-catalyst palladium complex; (b) preparing a mixture comprising the first substrate and the second substrate in a second aprotic solvent, wherein the second aprotic solvent is the same or different than the first aprotic solvent; and (c) contacting the mixture from step (b) with the solution comprising the pre-catalyst palladium complex and stirring the resulting mixture for a period of time to provide the product. In some embodiments, the palladium compound or salt is selected from the group comprising [Pd(crotyl)Cl]₂, [Pd(allyl)Cl]₂, Pd₂dba₃, Pd(OAc)₂, PdBr₂, [Pd(cinnamyl)Cl]₂, (COD)PdCH₂C(Me)₂Ph, and Pd(cod)Cl₂.

In some embodiments, the cross-coupling reaction is performed in the presence of a base (e.g., a non-nucleophilic base). Thus, in some embodiments, the contacting of step (c) is performed in the presence of a base. In some embodiments, preparing the mixture in step (b) comprises adding a base to the mixture of the first and second substrates. Any suitable non-nucleophilic base can be used. In some embodiments, the base is a metal hydroxide, a metal carbonate, a metal bicarbonate, an amine (e.g., a trialkylamine, such as triethylamine), a metal alkoxide, a metal carboxylate, or a metal phosphate. In some embodiments, the base is an alkali metal hydroxide (e.g., KOH, LiOH, or NaOH), an alkaline earth metal hydroxide (e.g., calcium hydroxide (Ca(OH)₂) or magnesium hydroxide) and an alkali metal alkoxide (e.g., sodium methoxide (NaOMe), potassium methoxide, sodium isopropoxide (i-PrONa), sodium tert-butoxide (t-BuONa), or potassium tert-butoxide (t-BuOK). In some embodiments, the base is an alkali metal alkoxide. In some embodiments, the base is t-BuONa.

In some embodiments, the contacting is performed in the presence of about 1 mole to about 3 moles of base per mole of the first substrate (i.e., about 1, about 1.5, about 2, about 2.5 or about 3 equivalents of the base). In some embodiments, the contacting is performed in the presence of about 2 moles of base per mole of the first substrate (i.e., about 2 equivalents of the base).

In some embodiments, the first substrate is a (hetero)aryl halide or sulfonate ester, i.e., a compound having a structure of the formula Ar₁—X, wherein Ar₁ is an optionally substituted aryl or heteroaryl group and X is a halide, an optionally substituted alkyl sulfonate, or an optionally substituted aryl sulfonate. In some embodiments, X is selected from the group comprising Br, Cl, I, OMs, and OTf. In some embodiments, Ar₁ is a heteroaryl or substituted heteroaryl group, e.g., pyridinyl or substituted pyridinyl, thiophenyl or substituted thiophenyl, benzothiophenyl or substituted benzothiophenyl, pyrimidinyl or substituted pyrimidinyl, quinolinyl or substituted quinolinyl, indazolyl or substituted indazolyl, thiazolyl or substituted thiazolyl, pyrazolyl or substituted pyrazolyl, pyrrolopyridinyl or substituted pyrrolopyridinyl, pyrazinyl or substituted pyrazinyl. When substituted, the Ar₁ aryl or heteroaryl group can be substituted with a substituent selected, for example, from alkyl (e.g., C₁-C₆ alkyl), alkoxy (e.g., C₁-C₆ alkoxy), haloalkyl (e.g., perfluoroalkyl), cycloalkyl, aryl, ester (e.g., —C(═O)—O— alkyl) and cyano.

In some embodiments, the second substrate is selected from an alcohol, a phenol, a thiol, a primary amine, a secondary amine, or an α,β-unsaturated carbonyl compound. In some embodiments, the second substrate is a primary or secondary amine. In some embodiments, the second substrate has a structure of the formula HN(R′)₂, wherein each R′ group is H or alkyl (e.g., substituted alkyl), subject to the proviso that at least one R′ group is alkyl (e.g., substituted alkyl). In some embodiments, the second substrate is a cyclic secondary amine, i.e., an amine having the structure of the formula HN(R′)₂, wherein the two R′ groups together with the nitrogen atom to which they are attached form a nitrogen-containing ring structure. The nitrogen containing ring structure can be substituted with one or more substituents (e.g., halo, alkyl, alkoxy, aralkyl, or aryl) or be part of a fused ring structure. In some embodiments, the nitrogen-containing ring structure can comprise a further heteroatom, e.g., a second nitrogen atom or an oxygen atom.

When the second substrate is an amine, the method comprises preparing a compound (i.e., a product) comprising a carbon-nitrogen bond, e.g., via a Buchwald-Hartwig amination reaction. In some embodiments, the compound comprising the carbon-nitrogen bond (i.e., the product) has a structure of the formula: Ar₁—N—(R′)₂, wherein Ar₁ is aryl, substituted aryl, heteroaryl, or substituted heteroaryl (i.e., the same Ar₁ group from the first substrate) and each R′ group is H, alkyl, or substituted alkyl, subject to the proviso that at least one R′ group is alkyl or substituted alkyl or wherein the two R′ groups together with the nitrogen atom to which they are attached form a nitrogen-containing ring structure. The nitrogen-containing ring structure can be substituted, fused, and/or contain one or more additional heteroatoms, e.g., a second nitrogen atom or an oxygen atom.

In some embodiments, the second substrate is a primary amine having a structure of the formula H₂NR′, wherein R′ has the structure —C(R″)₃, wherein each R″ group is H, alkyl, or substituted alkyl, and wherein at least two R″ groups are alkyl or substituted alkyl. In some embodiments, each R″ is alkyl (e.g., C₁-C₆ alkyl). In some embodiments, each R″ is methyl and the second substrate is t-butylamine.

In some embodiments, the second substrate is an α-branched secondary amine, i.e., an amine having the structure HN(R′)₂ wherein each R′ group is alkyl or substituted alkyl or wherein the two R′ groups together with the nitrogen atom to which they are attached form a nitrogen-containing ring structure, and wherein at least one carbon atom of a R′ group that is directly attached to the nitrogen atom is substituted with no more than one hydrogen atoms.

In some embodiments, the α-branched secondary amine comprises a substituted or fused nitrogen-containing ring structure. Exemplary α-branched secondary amines include, but are not limited to, piperidines and pyrrolidines that are substituted at the 2-position (e.g., 2-methylpiperidine) and indoline.

In some embodiments, the second substrate is a non-α-branched secondary amine, i.e., an amine having the structure HN(R′)₂ wherein each R′ group is —CH₂R″ where each R″ is H, alkyl or substituted alkyl or wherein the two R′ groups together with the nitrogen atom to which they are attached form a nitrogen-containing ring structure. The nitrogen-containing ring structure can be substituted with one or more substituents (e.g., alkyl, halo, alkoxy) as long as the carbon atoms of the ring structure that are directly attached to the nitrogen atom are unsubstituted. Exemplary non-α-branched secondary amines include, but are not limited to, morpholine, 3,3-difluoroazetidine, 3,3-difluoropyrrolidine, 1,2,3,4-tetrahydroisoquinoline, 4-methoxypiperidine, 1-methylpiperazine, 2-(piperizin-1-yl)pyrimidine, and 1-(pyridine-2-yl)piperazine.

In some embodiments, the contacting is performed under conditions where there is an equimolar amount or an excess of the second substrate compared to the first substrate. In some embodiments, the contacting is performed with about 1.05 moles to about 1.5 moles of the second substrate per mole of the first substrate. In some embodiments, with about 1.2 moles of the second substrate per mole of the first substrate (i.e., about 1.2 equivalents of the second substrate).

In some embodiments, the first and/or second aprotic solvent is selected from the group including but not limited to, an alkane (e.g., pentane, hexane, cyclohexane), an arene (e.g., benzene, toluene, p-xylene) or an ether (e.g., diethylether, tetrahydrofuran (THF), anisole, a dioxane, or methyl tert-butyl ether (MTBE). Mixtures of aprotic solvents can also be used. In some embodiments, the first and/or second solvent is THF, MTBE, or toluene. In some embodiments, the first and/or second solvent is THF or toluene. In some embodiments, the concentration of the first substrate in the mixture prepared in step (b) or (c) is about 0.3 M to about 0.7 M, e.g. In some embodiments, the concentration of the first substrate in the mixture stirred in step (c) is about 0.5 M.

The contacting of the first and second substrates with the pre-catalyst palladium complex can be performed at any suitable temperature. In some embodiments, the temperature is about 20° C. to about 90° C. (e.g., about 20° C., about 30° C., about 40° C., about 50° C., about 60° C., about 70° C., about 80° C., or about 90° C.). In some embodiments, the temperature (e.g., the temperature in step (c)) is at least about 40° C. or at least about 50° C. In some embodiments, the temperature is about 50° C. to about 90° C. In some embodiments, the temperature is about 70° C.

The contacting (e.g., the stirring in step (c)) can be carried out for any suitable amount of time. To determine how long to allow the contacting (e.g., stirring) to continue, reaction progress (e.g., the amount of the first substrate remaining or the rate of product formation) can be followed via a suitable analytical method, such as, but not limited to, GC-MS, HPLC, TLC, IR, NMR, or the like. In some embodiments, the period of time of about 30 minutes to about 48 hours. In some embodiments, the period of time is about 3 hours to about 26 hours (e.g., about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 25 hours, about or about 26 hours). In some embodiments, the period of time is about 3 hours to about 16 hours. In some embodiments, the period of time is about 16 hours.

In some embodiments, the solution comprising the pre-catalyst palladium complex contacted with the mixture from step (b) contains about 0.5 mol % to about 2 mol % of the pre-catalyst palladium complex (i.e., about 0.5 moles to about 2 moles of the pre-catalyst palladium complex per 100 moles of the first substrate). In some embodiments, the solution contains about 1 mol % of the pre-catalyst palladium complex, about 1.5 moles of the pre-catalyst palladium complex or about 2.0 mol % of the pre-catalyst palladium complex. In some embodiments, the pre-catalyst palladium complex is [Pd(crotyl)(AshPhos)Cl].

Following the contacting (e.g., following step (c)), e.g., when no first substrate remains, the reaction mixture can be filtered, concentrated (e.g., to remove solvent) and purified to obtain the product of the palladium-catalyzed coupling reaction. In some embodiments, the method provides a yield of the product of the palladium-catalyzed coupling reaction of about 50% or more or about 60% or more. In some embodiments, the yield is about 70% or more (e.g. about 70% to about 99%). In some embodiments, the yield is about 80%, about 85%, about 90%, about 92%, about 93%, about 94%, or about 95% or more.

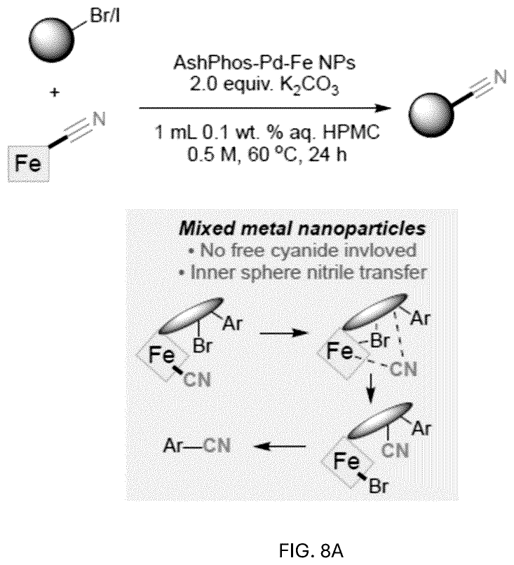

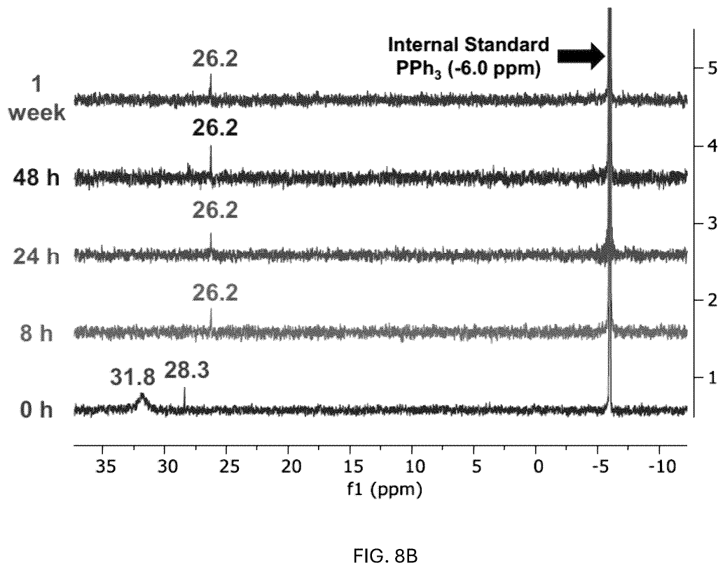

According to one aspect of the presently disclosed subject matter, a method of converting (hetero)aryl halides or (heteroaryl) sulfonate esters to (hetero)aryl nitriles in water is provided. In some embodiments, the method comprises the use of hydroxypropyl methylcellulose (HPMC), a widely used, food-grade, cellulose-derived additive (Sharma et al., 2021), as part of the reaction medium, e.g., to provide a catalytic microenvironment, while potassium ferrocyanide (K₄[Fe(CN)₆]) serves as a cyanide reservoir for inner-sphere transmetallation via halogen-nitrile metathesis on Pd(II)-containing particles residing on the hydrophobic pocket of HPMC. See FIG. 8A. Crucially, mechanistic studies using this approach show no involvement of free cyanide ions during turnover: the ferrocyanide complex donates CN only via bound-transfer pathways at the catalytic site on the nanoparticle (NP) catalyst surface dispersed in HPMC. This halogen-nitrile cross-metathesis has the benefit of both avoiding Pd poisoning by cyanide ligation and preventing the possibility of transiently liberated CN⁻ into the reaction media.

Thus, in some embodiments, the presently disclosed subject matter provides a nanoparticle comprising the pre-catalyst palladium complex of the presently disclosed subject matter (i.e., the complex comprising a palladium ion and a monophosphine ligand where the monophosphine ligand is a compound of Formula (I), e.g., AshPhos). In some embodiments, the nanoparticle is provided in an aqueous solution comprising a micelle (e.g., formed from a non-ionic or anionic surfactant, such as a polyethylene glycol fatty acid derivative, a polyethylene glycol sorbitan ester, or a salt of dodecyl sulfate) or an amphiphilic or hydrophilic organic polymer. In some embodiments, the nanoparticle is stabilized by the micelle or organic polymer. In some embodiments, the nanoparticle is embedded on the surface of the organic polymer. In some embodiments, the organic polymer is a cellulose derivative, such as, but not limited to, HPMC.

In some embodiments, the nanoparticle is a mixed-metal nanoparticle further comprising iron (Fe). For example, the nanoparticle can comprise ferrocyanide. In some embodiments, nanoparticle is formed in situ in an aqueous solution, such as in a reaction mixture for converting an aryl or heteroaryl halide or sulfonate ester into an aryl or heteroaryl nitrile or in a solution to be added to such a reaction mixture. Thus, in some embodiments, the nanoparticle is for use in a method of preparing a nitrile.

For example, in some embodiments, the presently disclosed subject matter provides a method of preparing a nitrile, wherein the method comprises contacting a substrate comprising a (hetero)aryl halide or a (hetero)aryl sulfonate ester with potassium ferrocyanide or a hydrate thereof and a nanoparticle comprising a pre-catalyst palladium complex, wherein the pre-catalyst palladium complex comprises a palladium ion and a monophosphine ligand (i.e., a dialkyl biaryl monophosphine ligand); thereby converting the substrate into an aryl nitrile or heteroaryl nitrile. In some embodiments, nanoparticle comprising the pre-catalyst palladium complex is a mixed metal nanoparticle further comprising potassium ferrocyanide. In some embodiments, the contacting is performed in an aqueous solution comprising a micelle or a hydrophilic or amphiphilic organic polymer. In some embodiments, the organic polymer is a cellulose derivative, e.g., HPMC. For example, in some embodiments, the aqueous solution has a concentration of about 0.01 wt. % to about 1 wt. % HPMC or another cellulose derivative (e.g., about 0.01 wt. %, about 0.05 wt. %, about 0.075 wt. %, about 0.1 wt. %, about 0.15 wt. %, about 0.2 wt. %, about 0.25 wt. %, about 0.30 wt. %, about 0.4 wt. %, about 0.5 wt. %, about 0.75 wt. %, or about 1.0 wt. % HPMC).

In some embodiments, the method of preparing a nitrile comprises: (a) contacting the pre-catalyst palladium complex with the aqueous solution comprising the cellulose derivative and stirring the resulting mixture for a first period of time at a first temperature to provide an aqueous solution comprising a nanoparticle comprising the pre-catalyst palladium complex; (b) adding the substrate and potassium ferrocyanide or a hydrate thereof to the aqueous solution comprising the nanoparticle to provide a reaction mixture; and (c) stirring the reaction mixture at a second temperature for a second period of time.

In some embodiments, the substrate is a compound having the formula Ar₂—X, wherein Ar₂ is an aryl, substituted aryl, heteroaryl or substituted heteroaryl group and X is a halide, an alkyl sulfonate, a substituted alkyl sulfonate, an aryl sulfonate or a substituted aryl sulfonate. In some embodiments, X is I, Br or Cl. In some embodiments, Ar₂ is phenyl, naphthyl, pyridinyl, benzo[b]thiophenyl, or indolyl group, which can optionally be substituted by one or more groups, such as, but not limited to, alkyl, alkoxy, aryl, a nitrogen-containing heterocycle, —S(═O)-alkyl, —C(═O)O-alkyl, and —C(═O)NH-alkyl.

In some embodiments, the dialkyl biaryl monophosphine ligand is a compound of Formula (I). In some embodiments, the compound of Formula (I) is AshPhos. In some embodiments, the pre-catalyst palladium complex is formed from a palladium precursor selected from [Pd(crotyl)Cl]₂ or [Pd(allyl)Cl]₂. In some embodiments, the dialkyl biaryl monophosphine ligand and the palladium precursor are mixed in an aprotic organic solvent (e.g., THF) under heating (e.g., to about 60° C.) to provide the pre-catalyst palladium complex. In some embodiments, the mixing is performed under a nitrogen or inert atmosphere (e.g., under argon gas). In some embodiments, the molar ratio of palladium precursor and dialkyl biaryl monophosphine ligand used to prepare the pre-catalyst palladium complex is about 1:2.

In some embodiments, the first period of time is about 1 minute to 15 minutes (e.g., about 1, 2, 3, 4, 5, 6, 7, 8, 9, 10, 11, 12, 13, 14, or about 15 minutes). In some embodiments, the first period of time is about 5 minutes.

In some embodiments, step (b) further comprises adding a base, such as, but not limited to an alkali metal hydroxide (e.g., KOH, NaOH, LiOH), an alkali metal carbonate (Li₂CO₃, Cs₂CO₃, K₂CO₃), an alkali metal alkoxide (sodium or potassium tert-butoxide), a trialkylamine (e.g., triethylamine), or an alkali metal trialkylsilanolate (e.g., potassium trimethylsilanolate (KOTMS)). In some embodiments, the base is an alkali metal carbonate.

In some embodiments, the base is potassium carbonate. In some embodiments, adding a base comprises adding about 0.1 to about 2.5 moles of base per mole of substrate (i.e., about 0.5 to about 2.5 equivalents of base). In some embodiments, adding a base comprises adding about 1.0 to about 2.0 equivalents of base. In some embodiments, adding a base comprises adding about 2.0 equivalents of the base.

In some embodiments, the second temperature is about 40° C. to about 80° C. (e.g., about 40° C., about 50° C., about 60° C., about 70° C., or about 80° C.). In some embodiments, the second temperature is about 60° C. In some embodiments, the second period of time is about 12 hours to about 60 hours (e.g., about 12, about 18, about 24, about 30, about 36, about 42, about 48, about 54, or about 60 hours).

In some embodiments, the method is performed using about 0.01 moles of the Pd source per mole of the substrate (i.e., about 1.0 mol % of the Pd source) to about 0.04 moles of the Pd source per mole of the substrate (i.e., about 4.0 mol % of the Pd source). In some embodiments, the method is performed using about 2.0 mol % to about 3.0 mol % of the Pd source. In some embodiments, the method is performed using about 3 mol % of the Pd source. In some embodiments, the method is performed using about 0.02 moles of the monophosphine ligand per mole of the substrate (i.e., about 2.0 mol % of the monophosphine ligand) to about 0.08 moles of the monophosphine ligand (i.e., about 8.0 mol % of the monophosphine ligand). In some embodiments, the solution comprises about 6.0 mol % of the monophosphine ligand.

In some embodiments, the reaction is performed using about 0.25 equivalents of potassium ferrocyanide.

In some embodiments, the method is performed without the generation of free cyanide ions. In some embodiments, the reaction provides a yield of the nitrile product of about 50% or more. In some embodiments, the yield is at least 60%, at least 70%, at least 80%, at least 85%, about least 90%, or at least 95%.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### General Materials and Methods

### General Reagent and Material Information:

Chromatography TLC plates (UV 254 indicator, thickness 200 mm) and silica gel (standard grade, 230-400 mesh) were purchased from Merck. Ethyl acetate, hexanes, dichloromethane, and acetone were purchased from Fisher Scientific. Methanol and pentane were supplied by Sigma-Aldrich. Heteroaryl halides and amines coupling partners were purchased from Ambeed. NMR solvents were obtained from Sigma-Aldrich. [Pd(crotyl)Cl]₂ was supplied by Sigma-Aldrich; tert-BuLi (1.7 M in pentane) was purchased from Sigma-Aldrich. CuCl and PCy₂Cl were purchased from Ambeed.

### General Analytical Information:

All products were purified by column chromatography using silica gel (60 Å pore size, 230-400 mesh). GC-MS data was obtained using a Thermo Scientific Trace 1300 Gas Chromatograph coupled with a Thermo Scientific ISQ-QD Single Quadrupole Mass Spectrometer. Reported chemical shifts are referenced to residual solvent peaks. All ¹H and ¹³C NMR spectra were recorded on 600 MHz (14.09 T Oxford magnet interfaced with a Bruker Avance III HD spectrometer, equipped with a commercial ¹H/¹³C 5 mm cryo-probe) and 500 MHz NMRs (11.74 T magnet operated by a Bruker Avance III HD spectrometer with a commercial broadband 5 mm probe). CDCl₃ and DMSO-d6 NMR solvents were used. The residual CHCl₃ for peaks for ¹H NMR (δ=7.26 ppm) and ¹³C NMR (δ=77.16 ppm) was used as reference. The residual DMSO-d6 for ¹H NMR (6=2.50 ppm) and ¹³C NMR (6=39.52) was used as reference. The following abbreviations described peak splitting patterns when appropriate: s=singlet, d=doublet, t=triplet, q=quartet, dd=doublet of doublet, m=multiplet. Coupling constants (J) were reported in Hertz (Hz).

Direct Infusion TOF-MS: MS data were collected in positive-ion time-TOF-MS mode from 100-2500 m/z and ion mobility from 0.45 to 1.6 1/K0. ESI-positive data (4000 kV cap voltage) was collected by infusing the compound at 3 μL/min from a 500 μL Hamilton syringe. Data were acquired over 1 min of infusion. The MS was calibrated with ESI-low (Agilent) just prior to acquisition; no internal recalibration was conducted.

LC-TOF-MS: MS data were collected in positive-ion time-TOF-MS mode from 100-1300 m/z and ion-mobility from 0.45 to 1.6 1/K0. ESI-positive data (1500 kV cap voltage) was collected by loading 0.1 uL (~100 ng) onto a column sold under the tradename PEPSEP®25 Ultra (25 cm×75 μm×1.5 μm Sapphir-C18, Bruker). MS data were acquired during a short gradient LCMS run—initial conditions were 3% B (A: 0.1% FA in water, B99.9% ACN+0.1% FA); rapid ramp to 80% B over 2 min, hold at 80% B for 10 minutes, ramp back to (2 minutes) and hold at initial conditions (3 minutes). Data were summed over ~1 min of peak elution. The MS was calibrated with ESI-low (Agilent) just prior to the acquisition; no internal recalibration was conducted.

### Example 1

### Ligand Synthesis

### Synthesis of 6,7-dibromo-2,3-dihydrobenzo[b][1,4]dioxine (1)

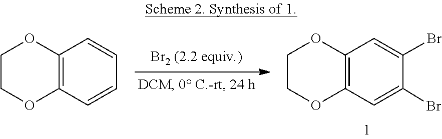 [SMILES: c1ccc2c(c1)OCCO2 ; Brc1cc2c(cc1Br)OCCO2]

Based on a previously described procedure (Hellberg et al., 2004) and as shown in Scheme 2, above, in an oven-dried 100 mL round bottom flask containing a magnetic stir bar and the flask covered with a rubber septum, 1,4-benzodioxane (5.0 g, 36.72 mmol) was added under nitrogen atmosphere. 30 mL dry CH₂Cl₂ was added to it via a syringe. The resulting mixture was cooled to 0° C. Br₂ (4.04 mL, 80.79 mmol) in 20 mL CH₂Cl₂ was added dropwise to the solution at 0° C. The reaction mixture was stirred at rt for 16 hours. The formed precipitates were dissolved in an additional amount of CH₂Cl₂ (20 mL). In the resulting organic solution, excess Br₂ was quenched with aq. Na₂S₂O₃. The resulting mixture was sequentially washed with water and brine. The organic phase was separated and dried over Na₂SO₄, and volatiles were removed under reduced pressure to obtain pure product as white crystals in 92% yield (9.94 g). ¹H NMR (600 MHz, CDCl₃): δ (in ppm) 7.13 (s, 2H), 4.23 (d, J=1.1 Hz, 4H). Melting Point: 135-137° C.

### Synthesis of 6-bromo-7-(2,6-dimethoxyphenyl)-2,3-dihydrobenzo[b][1,4]dioxine (2c)

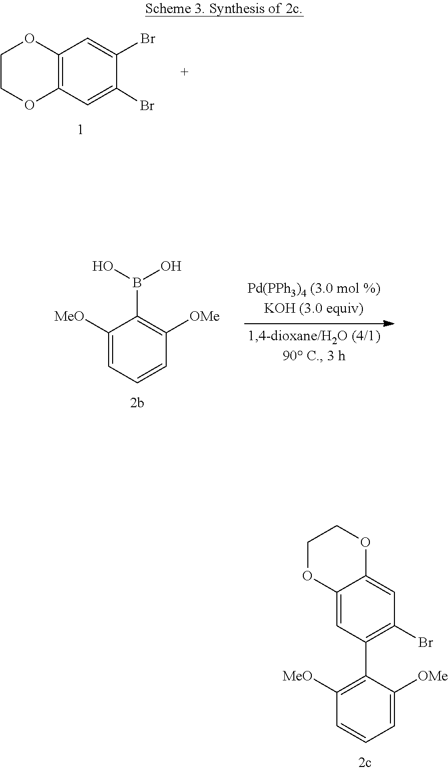 [SMILES: Brc1cc2c(cc1Br)OCCO2 ; COc1cccc(OC)c1B(O)O ; COc1cccc(OC)c1-c1cc2c(cc1Br)OCCO2]

As shown in Scheme 3, above, in an oven-dried 100 mL Schlenk tube equipped with a magnetic stir bar, dibromo-2,3-dihydrobenzo [1,4]dioxine (1) (1 g, 3.4 mmol), 2,6-dimethoxyphenylboronic acid (2) (2.11 g, 10.20 mmol), and KOH (0.572 g, 10.20 mmol) were added under nitrogen atmosphere. 1,4-Dioxane (8 mL) and H₂O (4 mL) were added to the reaction mixture, followed by an addition of Pd(PPh₃)₄(118 mg, 3 mol %). The reaction vessel was closed with a PTFE stopper, and the mixture stirred at 90° C. for 8 hours. After reaction completion, as monitored by TLC and GC-MS, the reaction mixture was cooled to rt. 1,4-Dioxane and H₂O were evaporated under reduced pressure. The mixture was diluted with CH₂Cl₂, and the resulting solution was passed through a celite pad. The filtrates were evaporated under reduced pressure to obtain crude product, which was purified by column chromatography over silica gel (60-120 mesh) using EtOAc/hexanes as eluent (7:93). Pure product was obtained as a white solid, yield: 92% (1.1 g). ¹H NMR (600 MHz, CDCl₃): δ (in ppm) 7.32 (t, J=8.3 Hz, 1H), 7.17 (d, J=1.6 Hz, 1H), 6.76 (d, J=1.6 Hz, 1H), 6.64 (d, J=8.4 Hz, 2H), 4.27 (s, 4H), 3.76 (d, J=1.6 Hz, 6H). ¹³C NMR (151 MHz, DMSO): δ (in ppm) 157.3, 143.1, 142.4, 129.5, 128.3, 120.1, 119.8, 117.4, 114.8, 104.1, 63.9, 55.6. Melting Point: 130-132° C. HRMS: Calculated [C₁₆H₁₅BrO₄+H]⁺=351.0226; found m/z (ESI)=351.0205.

### Synthesis of AshPhos (dicyclohexyl(7-(2,6-dimethoxyphenyl)-2,3-dihydrobenzo[b][1,4]dioxin-6-yl)phosphane) (3)

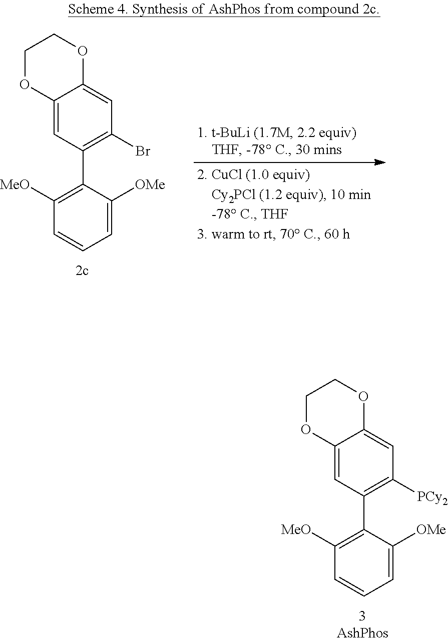

As shown in Scheme 4, above, in an oven-dried 250 mL Schlenk flask equipped with a magnetic stir bar and fitted with a rubber septum, 6-bromo-7-(2,6-dimethoxy phenyl)-2,3-dihydrobenzo[b][1,4]dioxine (2c) (1.0 g, 2.85 mmol) was added under nitrogen atmosphere. The reaction flask was evacuated and backfilled with nitrogen (this process was repeated three times). Anhydrous THF (20 mL) was added to the reaction mixture using a needle syringe. The reaction mixture was cooled to −78° C., and tert-BuLi (3.7 mL, 1.7 M in hexane, 2.2 equiv., 6.27 mmol) was added dropwise over a 20-minute period. The resulting mixture was stirred for 30 min at −78° C. under a positive nitrogen pressure. A septum was removed from the reaction flask, and anhydrous CuCl (0.283 g, 1.0 equiv., 2.85 mmol) was added rapidly to the reaction mixture. The flask was refitted with a rubber septum and stirred for another 10 mins, followed by the addition of dicyclohexyl chlorophosphine (0.7 mL, 1.1 equiv., 3.14 mmol) dropwise over 15 min. After the complete addition of dicyclohexyl chlorophosphine, the resulting mixture was stirred at −78° C. for 10 mins. The reaction mixture was allowed to warm to rt and heated to 70° C. for the next 60 hours. After reaction completion as monitored by TLC, the reaction mixture was allowed to cool at 0° C. and slowly and cautiously quenched with saturated aqueous NH₄Cl solution (10 mL). Later, the volatiles were evaporated under reduced pressure at 30° C. The aqueous layer was extracted with ethyl acetate (30 mL), and the resulting organic layer was washed with aqueous NH₄OH (this process has been repeated three times) and washed with brine. The organic layer was dried over anhydrous Na₂SO₄, and volatiles were removed under reduced pressure. The crude material was recrystallized in hot methanol or purified by column chromatography over neutral alumina (60-325 Mesh) using EtOAc/hexane as an eluent (5:95). Desired product was obtained as a white solid, yield: 77% (1.045 g). ¹H NMR (500 MHz, DMSO): δ (in ppm) 7.21 (d, J=8.3 Hz, 1H), 6.92 (d, J=1.7 Hz, 1H), 6.59 (d, J=8.4 Hz, 2H), 6.45 (d, J=3.4 Hz, 1H), 4.27 (s, 4H), 3.58 (s, 6H), 1.76-1.53 (m, 11H), 1.30-0.96 (m, 11H). ¹³C NMR (126 MHz, DMSO): δ (in ppm) 157.6, 143.6, 141.8, 135.9 (d, J=33.2 Hz), 128.6, 127.9 (d, J=17.6 Hz), 120.6 (d, J=3.6 Hz), 119.4 (d, J=6.7 Hz), 119.2 (d, J=7.1 Hz), 102.9, 64.2 (d, J=2.7 Hz), 55.2, 29.8 (d, J=16.8 Hz), 28.9 (d, J=9.0 Hz), 27.4, 27.3 (d, J=7.7 Hz), 26.5. ³¹P NMR (202 MHz, CDCl₃): δ −10.2 ppm (PPh₃ was used as an internal standard in a sealed capillary −6.00 ppm). HRMS: Calculated [C₂₈H₃₇O₄P+H]⁺=469.2502; found m/z (ESI)=469.2497. Melting Point: 237-239° C.

### Gram-Scale Two-Step Synthesis and Recrystallization

AshPhos was prepared using the two-step route described above starting with 5 g (17.01 mmol) of 1 and 9.5 g (51.03 mmol) of 2b, which provided 4.2 g 2c (70% yield). The AshPhos crude product prepared from 2c was recrystallized by adding approximately 20 mL of methanol and stirring the mixture at room temperature for 15 minutes. After 15 minutes, stirring was discontinued, and the white precipitate was allowed to settle. The supernatant brown solution was carefully decanted, and fresh hot methanol (10 mL) was added to the solid, which was then stirred for an additional 15 minutes. The methanol was then decanted, and pentane (10 mL) was added to the resulting solid. The suspension was stirred for 10 minutes, after which the supernatant was decanted. This washing procedure was repeated twice more to afford the desired product as a white solid. After drying under high vacuum overnight, the desired product was obtained as a white solid, 2.30 g, 63% yield. The combined washing solvents were evaporated under reduced pressure, and a second recrystallization further purified the resulting material, affording 490 mg (14%) of white solid. The total of the pure compound obtained was 2.79 g (77%).

For improved isolated yield at higher reaction scales, the recrystallization procedure can be repeated, e.g., at least three times. During aqueous workup, vigorous shaking can be avoided to reduce the occurrence of persistent emulsions that are difficult to resolve. Degassed water (argon-sparged for 5 minutes immediately before use) can be employed during the workup. Argon can also be used to backfill the system during vacuum release during rotary evaporation. While silica-gel chromatography can be used for purification, prolonged exposure of the product to silica gel can result in diminished yields and partial oxidation of the phosphine.

### One-Pot Synthesis of AshPhos

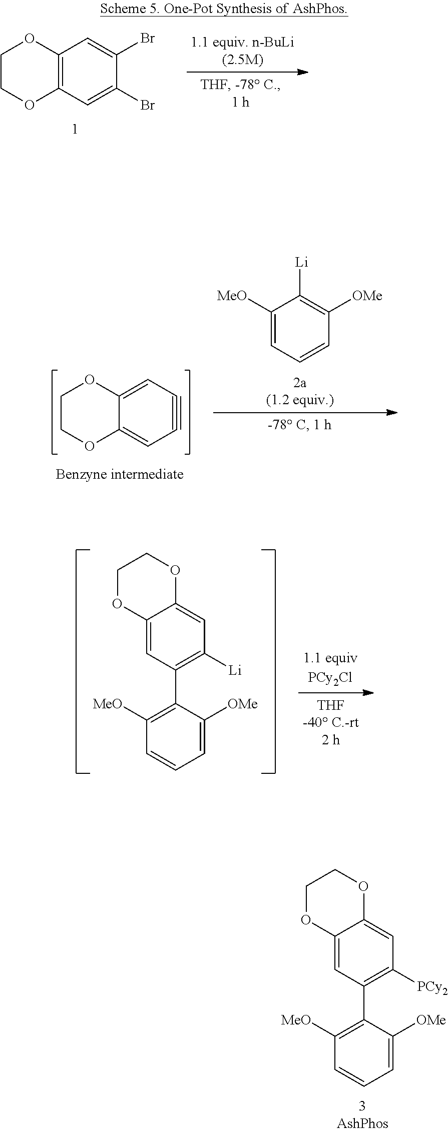

As shown in Scheme 5, above, in an oven-dried 50 mL Schlenk flask (flask A) equipped with a magnetic stir bar, dibromo-2,3-dihydrogen [1,4]dioxin (0.5 g, 1.70 mmol) was added in 10 mL anhydrous THF at rt under a nitrogen atmosphere. The reaction flask was cooled to −78° C., followed by evacuation and backfilling with nitrogen (this process was repeated three times). Later, n-BuLi (2.5 M in hexane, 1.1 equiv.) was dropwise added to the reaction mixture over 10 minutes. The resulting white foamy solution was stirred for 60 minutes under positive nitrogen pressure. Meantime, another flask (flask B), 1-bromo 2,6-methoxybenzene (0.370 g, 1.70 mmol) in 5 mL anhydrous THF was taken. The reaction mixture of flask B was cooled to −78° C., and tert-BuLi (1.7 M in hexane, 1.1 equiv.) was added. The resulting mixture was stirred for 30 mins. After 30 mins, the resulting solution of (2,6-methoxyphenyl) lithium from flask B was slowly added to flask A at −78° C. over a period of 30 mins. The reaction mixture was allowed to stir at −78° C. for another hour under positive nitrogen pressure. Further, the reaction mixture was warmed to rt, dicyclohexyl chlorophosphine (1.2 equiv., 2.04 mmol) was added dropwise over 10 min, and the reaction mixture was stirred at rt. After consumption of starting material as monitored by TLC (neutral alumina), the reaction mixture was quenched with 5-10 mL saturated aqueous NH₄Cl solution. Volatiles except the aqueous layer were removed under reduced pressure. The resulting reaction mixture was extracted with ethyl acetate. The organic layer was washed with brine, dried over anhydrous Na₂SO₄, and evaporated under reduced pressure. The crude material was recrystallized using hot methanol to yield the desired product as a white solid, yield 33% (0.27 g).

### Synthesis of Pre-catalyst: [Pd(crotyl)(AshPhos)Cl]

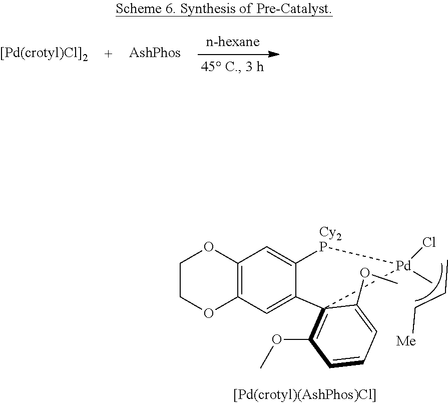

As shown in Scheme 6, above, 30 mL dry reaction vial was equipped with a Teflon-coated magnetic stir bar and was charged with [Pd(crotyl)Cl]₂ (300 mg, 0.76 mmol), followed by the addition of AshPhos (0.72 g, 2.0 equiv.). The flask was fitted with the rubber septum and was evacuated and backfilled with nitrogen over a cycle of three times. To the reaction flask, n-hexane (4 mL per mmol) was added via syringe, and the reaction mixture was stirred at 45° C. for 3 h. Over this time, pale-yellow precipitates were formed. The precipitates were collected using vacuum filtration, and the resulting filter cake was washed with additional hexane (5 mL) to afford a bright yellow solid, yield 79% (0.82 g). ¹H NMR (500 MHz, CDCl₃): δ (in ppm) 7.23 (t, J=8.3 Hz, 1H), 7.12 (d, J=8.9 Hz, 1H), 6.54 (d, J=3.4 Hz, 3H), 4.75 (s, 1H), 4.31 (s, 4H), 3.77-3.63 (m, 6H), 3.13 (s, 1H), 2.16 (s, 2H), 1.90 (s, 3H), 1.76-1.52 (m, 11H), 1.38-1.03 (m, 11H). ¹³C NMR (151 MHz, CDCl₃): δ (in ppm) 158.0, 144.5, 141.5 (d, J=10.0 Hz), 134.1 (d, J=12.0 Hz), 128.6, 123.2 (d, J=32.5 Hz), 122.9 (d, J=8.9 Hz), 121.0 (d, J=8.4 Hz), 118.8 (d, J=4.0 Hz), 114.7 (d, J=4.4 Hz), 103.7, 103.1, 100.5 (d, J=26.0 Hz), 64.4 (d, J=11.3 Hz), 55.3 (d, J=6.2 Hz), 49.3, 36.6, 29.8 (d, J=3.9 Hz), 28.8, 27.4 (d, J=11.0 Hz), 27.1 (d, J=13.0 Hz), 26.2, 17.3 (d, J=4.0 Hz). ³¹P NMR (202 MHz, CDCl₃): δ (in ppm) 31.8 (PPh₃ as an internal standard in a sealed capillary, −6.00 ppm).

A crystal for [Pd(crotyl)(AshPhos)Cl]was developed using vapor diffusion by dissolving 10 mg of precatalyst in 0.5 mL of dichloroethane in a dram vial and placing it in a chamber containing 10 mL of pentane for 3 days.

### Discussion

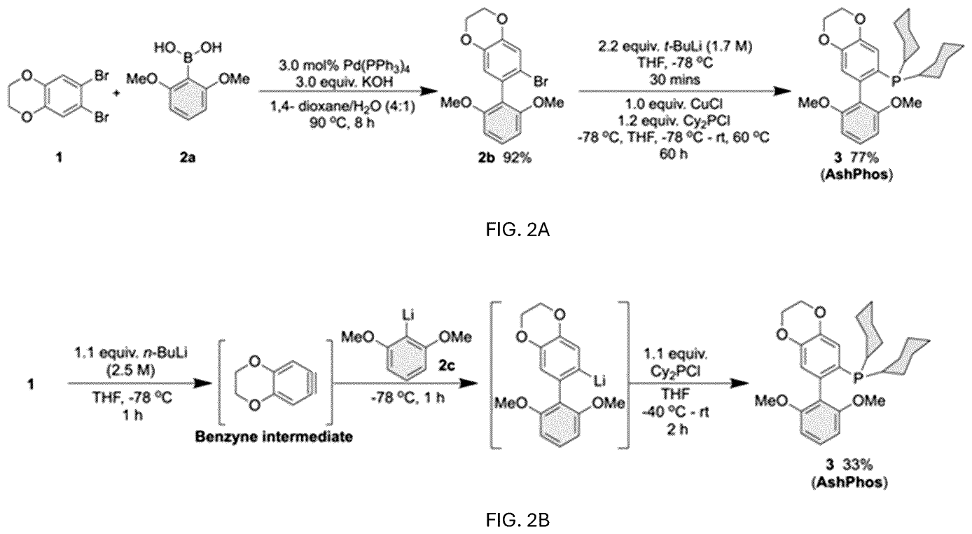

The ligand AshPhos was successfully synthesized utilizing two distinct synthetic pathways starting from 6,7-dibromo-2,3-dihydrobenzo-[b][1,4]dioxine (1). The first approach, a high-yielding two-step synthesis, commenced with the installation of the aryl ring using arylboronic acid 2a to provide 6,7-dibromo-2,3-dihydrobenzo[b][1,4]-dioxine 2b through Suzuki-Miyaura cross-coupling, followed by the introduction of the phosphine moiety, leading to the formation of AshPhos ligand (3). See FIG. 2A. Alternatively, a moderately yielding one-pot synthesis was used. See FIG. 2B. This route entailed a benzyne formation, followed by the subsequent entrapment of the benzyne intermediate with 2,6-dimethoxyphenyllithium, 2c. In the same pot, the resulting intermediate 2c was further reacted with dicyclohexylphosphine chloride to yield the desired AshPhos ligand 3.

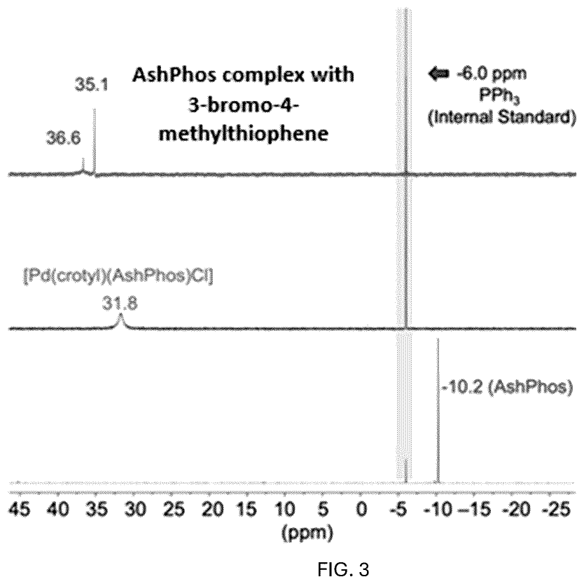

After obtaining the AshPhos ligand, its binding affinity with [Pd(crotyl)Cl]2 was investigated. The resulting complex of AshPhos exhibited a propensity for oxidative addition of (hetero)aryl bromides, followed by transmetallation using t-BuNH2 and reductive elimination. [Pd(crotyl)Cl]2 was selected over Pd(OAc)₂, Pd(dppb)₂, and PdCl₂ due to its ease of characterization and the facile generation of Pd(0) species for oxidative addition, as demonstrated in Colacot and coworkers' pre-catalyst development study (DeAngelis et al., 2015; Johansson Seechurn et al., 2011). The ³¹P NMR signal of AshPhos appeared at −10.2 ppm, while the signal for [Pd(crotyl)(AshPhos)Cl]was observed at 31.8 ppm, confirming the chelation of AshPhos with palladium. See FIG. 3. This chelation was further verified through X-ray single-crystal analysis. Upon treatment with 3-bromo-4-methylthiophene, the resulting complex rapidly formed an oxidative addition complex, which remained stable even after passing through silica gel during column chromatography. The oxidative addition complex existed in two rotamers: a major rotamer with a chemical shift of 35.1 ppm and a minor rotamer observed at 36.6 ppm. See FIG. 3. Thus, this study indicated that the palladium complex of AshPhos can be a suitable candidate for catalysis due to ease of handling and facile oxidative addition, as observed in the initial study.

### Example 2

### Optimization of Buchwald-Hartwig Amination Conditions and Substrate Scope

### AshPhos-Pd(crotyl)Cl Stock Solution Preparation

Reactions were conducted at 0.5 and 0.25 mmol scales. For 0.5 mmol scale reaction: In THF or toluene, 0.05 M stock solution of AshPhos-Pd(crotyl)Cl was prepared using [Pd(crotyl)Cl]₂ (19.7 mg, 0.05 mmol) and AshPhos (46.9 mg, 0.10 mmol) in 2 mL solvent and stored under nitrogen atmosphere. Freshly prepared stock solutions were used for a set of multiple reactions. Note: 1.0 mol % [Pd(crotyl)Cl]₂ and 2.0 mol % AshPhos=2[Pd(AshPhos)(crotyl)Cl], 200 μL of the stock solution, which contains 2 mol % 2[Pd(AshPhos)(crotyl)Cl], was used under a nitrogen atmosphere.

### General Procedure for Catalytic Buchwald-Hartwig Amination Reactions:

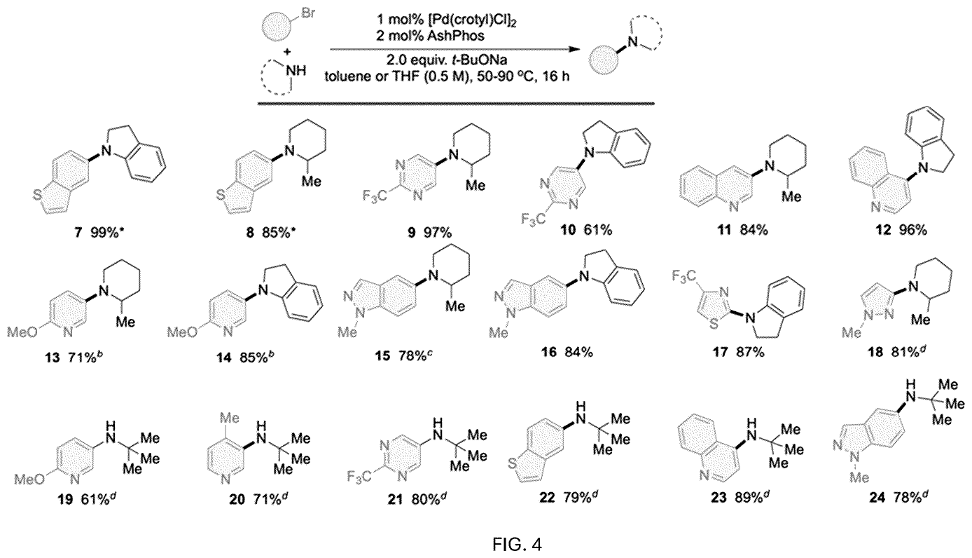

In an 8 mL reaction vial equipped with a stir bar, the t-BuONa base (96.5 mg, 1.0 mmol, 2.0 equivalents) was introduced under a nitrogen atmosphere. Subsequently, a heteroaryl halide (0.5 mmol, 1.0 equivalent), an aliphatic primary or secondary amine (0.6 mmol, 1.2 equivalents), and anhydrous THF or toluene (0.8 mL per reaction) were added to the reaction vial. From the above stock solution prepared in THF or toluene, 200 μL of the solution stock solution (corresponding to 2 mol % of AshPhos-Pd(crotyl)Cl, with the amount adjusted as described for different substrate scopes as described in Table 1G, below and in FIGS. 4, 5, 6A, and 6B) was added to the reaction mixture using a microliter syringe. The global concentration in the reaction was maintained at 0.5 M, along with the catalyst stock solution, base, and coupling partners. The reaction vial was then capped and placed in a preheated oil bath for stirring at 50° C. to 90° C. (depending upon the nature of the coupling partners and as indicated for the particular product syntheses described below) under a nitrogen atmosphere. After the complete consumption of the starting materials, as monitored by TLC and GC-MS, the reaction vial was removed from the oil bath and cooled to room temperature. The reaction vial was opened, and the contents were filtered through a celite plug, which was subsequently rinsed with EtOAc (3×5 mL). Volatiles were removed under reduced pressure to obtain a crude product, which was purified by column chromatography on silica gel using EtOAc/hexanes as eluent.

### Reaction Optimizations Studies:

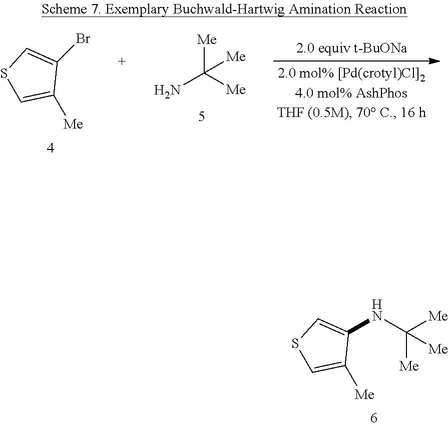

### Scheme 7. Exemplary Buchwald-Hartwig Amination Reaction

Using 3-bromo-4-methylthiophene (4) as an exemplary (hetero)aryl halide substrate and tert-butylamine (5) as an exemplary amine substrate, optimal palladium-catalyzed Buchwald-Hartwig amination reaction conditions were determined by running several series of reactions, varying one reaction parameter at a time. In particular, other palladium sources were used in place of the [Pd(crotyl)Cl]₂ shown in Scheme 7, the palladium loading amount was varied from 0.5 mol % to 2.0 mol % (using a constant ratio of 2 for the ratio of AshPhos mol % to Pd mol %), other bases were used in place of the t-BuONa shown in Scheme 7, and other solvents were used in place of THF. In addition, the effects of reaction temperature and reaction time were studied. Results of these studies are described in Tables 1A-1F, below. Percent yields described in Tables 1A-1F were determined by GC-MS using mesitylene (0.5 mmol) as an internal standard except for Table 1F (wherein % yields are based on GC-MS with respect to 3-bromo-4-methylthiophene), or, when indicated with an asterisk, based on isolated yield. N.d. stands for not determined.

TABLE 1A
Optimization of Palladium (Pd) Source.

| | | Yield |
|---|---|---|
| Entry | Pd Source | (%) |
| 1 | [Pd(crotyl)Cl]₂ | 87* |
| 2 | [Pd(allyl)Cl]₂ | 82 |
| 3 | [Pd(cinnamyl)Cl]₂ | 66* |
| 4 | Pd₂dba₃ | 70 |
| 5 | Pd(OAc)₂ | 38 |
| 6 | Pd (cod)Cl₂ | 46 |

TABLE 1B
Optimization of Palladium (Pd) Loading (mol %).

| | Pd | |
|---|---|---|
| | Loading | Yield |
| Entry | (mol %) | (%) |
| 1 | 0.5 | 18 |
| 2 | 1.0 | 25 |
| 3 | 1.5 | 57 |
| 4 | 2.0 | 87* |

TABLE 1C
Effect of Base.

| | | Yield |
|---|---|---|
| Entry | Base | (%) |
| 1 | NaOt-Bu | 87* |
| 2 | KOt-Bu | 35 |
| 3 | KOH | n.d. |
| 4 | Cs₂CO₃ | n.d. |
| 5 | NEt₃ | n.d. |
| 6 | i-PrNEt₂ | n.d. |
| 7 | DBU | n.d. |

TABLE 1D
Effect of Solvent

| | | Yield |
|---|---|---|
| Entry | Solvent | (%) |
| 1 | THF | 87* |
| 2 | Toluene | 81 |
| 3 | t-BuOH | n.d. |
| 4 | EtOH | n.d. |
| 5 | MTBE | 56 |

TABLE 1E
Effect of Temperature (° C.)

| | Temperature | Yield |
|---|---|---|
| Entry | (° C.) | (%) |
| 1 | Room | 8 |
| | temperature | |
| 2 | 60 | 84 |
| 3 | 70 | 87* |

TABLE 1F
Optimization of Reaction Time (h).

| | Reaction | Yield |
|---|---|---|
| Entry | Time (h) | (%) |
| 1 | 1.0 | 73 |
| 2 | 1.5 | 73 |
| 3 | 2.0 | 77 |
| 4 | 3.0 | 79 |
| 5 | 6.0 | 80 |
| 6 | 9.0 | 82 |
| 7 | 16.0 | 87* |
| 8 | 26.0 | 90* |

Reaction conditions were also optimized for reactions using other (hetero)aryl halides and amines as substrates. Optimized conditions using other (hetero)aryl halide substrates are summarized in Table 1G, below, where A is the base (hetero)aryl group of the (hetero)aryl halide substrate and B is the amine.

TABLE 1G
Optimum Conditions By Substrate Combination.

| | [Pd | | | | | |
|---|---|---|---|---|---|---|
| | (crotyl) | | | | | |
| | C1]₂ | | | | | |
| | (mol | | | Temp. | Time | Yield |
| Substrates | %) | base | solvent | (° C.) | (h) | (%) |
| A: | 1.0 | NaOt- | toluene | 60 | 16 | 85 |
| benzothio- | | Bu | | | | |
| phene | | | | | | |
| B: | | | | | | |
| 2-methyl- | | | | | | |
| piperidine | | | | | | |
| A: | 5.0 | NaOt- | THF | 70 | 16 | 84 |
| pyrazole | | Bu | | | | |
| B: | | | | | | |
| 2-methyl- | | | | | | |
| piperidine | | | | | | |
| A: | 5.0 | NaOt- | THF | 50 | 12 | 60 |
| thiazole | | Bu | | | | |
| B: | | | | | | |
| 2-methyl- | | | | | | |
| piperidine | | | | | | |
| A: | 2.5 | NaOt- | THF | 90 | 16 | 78 |
| indazole | | Bu | | | | |
| B: | | | | | | |
| 2-methyl- | | | | | | |
| piperidine | | | | | | |
| A: | 2.0 | NaOt- | toluene | 60 | 16 | 71 |
| pyridine | | Bu | | | | |
| B: | | | | | | |
| 2-methyl- | | | | | | |
| piperidine | | | | | | |
| A: | 1.0 | NaOt- | toluene | 60 | 16 | 97 |
| pyrimidine | | Bu | | | | |
| B: | | | | | | |
| 2-methyl- | | | | | | |
| piperidine | | | | | | |
| A: | 1.0 | NaOt- | THF | 90 | 16 | 93 |
| azaindole | | Bu | | | | |
| B: | | | | | | |
| 1-methyl- | | | | | | |
| piperazine | | | | | | |
| A: | 1.0 | NaOt- | THF | 70 | 16 | 84 |
| quinoline | | Bu | | | | |
| B: | | | | | | |
| 2-methyl- | | | | | | |
| piperidine | | | | | | |
| A: | 1.0 | NaOt- | THF | 90 | 6 | 93 |
| pyrazine | | Bu | | | | |
| B: | | | | | | |
| morpholine | | | | | | |

### Exemplary Buchwald-Hartwig Amination Reactions and Products

### Synthesis of1-(benzo[b]thiophen-5-yl)indoline (7)

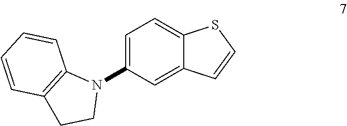

Product 7 was prepared in toluene according to the General Procedure described above at 60° C. using 5-bromobenzo[b]thiophene (53.3 mg, 0.25 mmol), indoline (33.72 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (10:90) to obtain a pure product as a pale-yellow liquid, yield 99% (62.5 mg). ¹H NMR (600 MHz, CDCl₃): δ (in ppm) 7.85 (d, J=8.7 Hz, 1H), 7.66 (d, J=2.3 Hz, 1H), 7.48 (d, J=5.4 Hz, 1H), 7.39 (dd, J=8.7, 2.3 Hz, 1H), 7.32-7.27 (m, 1H), 7.25-7.20 (m, 1H), 7.19-7.09 (m, 2H), 6.81 (t, J=7.3, 1H), 4.03 (t, J=8.4 Hz, 2H), 3.19 (t, J=8.4 Hz, 2H). ¹³C {¹H}NMR (151 MHz, CDCl₃): δ (in ppm) 147.8, 141.6, 140.7, 132.9, 131.2, 127.4, 127.2, 125.1, 123.7, 122.9, 118.8, 117.2, 112.4, 107.9, 52.9, 28.3. HRMS: Calculated [C₁₆H₁₃NS+H]⁺=252.0841; found m/z (ESI)=252.0822.

### Synthesis of 1-(benzo[b]thiophen-5-yl)-2-methylpiperidine (8)

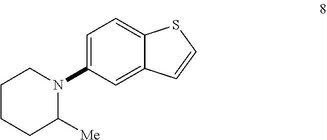

Product 8 was prepared in toluene according to the General Procedure described above at 60° C. using 5-bromobenzo[b]thiophene (106.54 mg, 0.5 mmol), 2-methylpiperidine (62.62 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (5:95) to obtain a pure product as pale-yellow viscous liquid, yield 85% (99 mg). ¹H NMR (600 MHz, CDCl₃): δ (in ppm) 7.76 (d, J=8.8 Hz, 1H), 7.40 (d, J=12.0 Hz, 2H), 7.26 (d, J=5.4 Hz, 1H), 7.15 (d, J=8.8 Hz, 1H), 3.84-3.77 (m, 1H), 3.19-3.04 (m, 2H), 2.00-1.90 (m, 1H), 1.86-1.77 (m, 1H), 1.76-1.67 (m, 2H), 1.65-1.55 (m, 2H), 1.01 (d, J=6.7 Hz, 3H). ¹³C{¹H}NMR (151 MHz, CDCl₃): δ (in ppm) 149.3, 140.6, 132.9, 126.5, 123.6, 122.4, 118.6, 112.9, 53.0, 47.5, 32.3, 26.2, 20.5, 14.7. HRMS: Calculated [C₁₄H₁₇NS+H]⁺=232.1154; found m/z (ESI)=232.1136.

### Synthesis of 5-(2-methylpiperidin-1-yl)-2-(trifluoromethyl)pyrimidine (9)

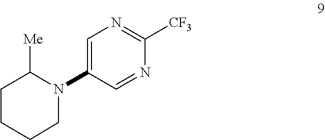

Product 9 was prepared in toluene according to the General Procedure described above at 60° C. using 5-bromo-2-(trifluoromethyl)pyrimidine (56.75 mg, 0.25 mmol), 2-methylpiperidine (31.31 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a pale yellow solid, yield 97% (60 mg). ¹H NMR (600 MHz, CDCl₃): δ (in ppm) 8.34 (s, 2H), 4.20 (dd, J=9.1, 4.3 Hz, 1H), 3.57 (m, 1H), 3.03 (m, 1H), 1.83 (m, 2H), 1.64 (m, 4H), 1.17 (d, J=6.8 Hz, 3H). ¹³C{¹H}NMR (151 MHz, CDCl₃): δ (in ppm) 144.7 (q, J=36.8 Hz), 144.1, 141.6, 120.2 (q, J=273.4 Hz), 40.8, 30.2, 25.0, 18.0, 13.3.

### Synthesis of 1-(2-(trifluoromethyl)pyrimidin-5-yl)indoline (10)

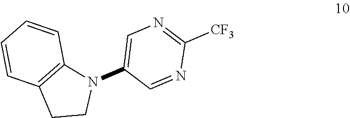

Product 10 was prepared in toluene according to the General Procedure described above at 60° C. using 5-bromo-2-(trifluoromethyl)pyrimidine (56.75 mg, 0.25 mmol), indoline (33.72 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a brown solid, yield 61% (40 mg). ¹H NMR (600 MHz, CDCl₃): δ (in ppm) 8.74 (d, J=1.3 Hz, 2H), 7.31-7.23 (m, 2H), 7.21-7.16 (m, 1H), 6.96 (t, J=7.3, 1H), 4.06 (t, J=8.3, 2H), 3.27 (t, J=8.3 Hz, 2H). ¹³C{¹H}NMR (151 MHz, CDCl₃): δ (in ppm) 147.1 (q, J=37.0 Hz), 143.8, 143.4, 139.8, 131.8, 127.6, 125.9, 122.2, 121.6-116.6 (m), 109.7, 51.0, 28.2. HRMS: Calculated [C₁₃H₁₀F₃N₃+H]⁺=266.0899; found m/z (ESI)=266.0880. Melting Point: 137-139° C.

### Synthesis of 3-(2-methylpiperidin-1-yl)quinoline (11) (CAS #2326261-60-1)

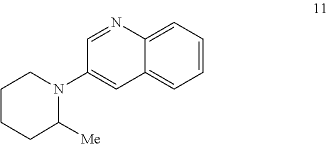 [SMILES: CC1CCCCN1c1cnc2ccccc2c1]

Product 11 was prepared in THF according to the General Procedure described above at 60° C. using 3-bromoquinoline (104.02 mg, 67.85 μL, 0.5 mmol), 2-methylpiperidine (62.62 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a colorless viscous liquid, yield 84% (96 mg). ¹H NMR (600 MHz, CDCl₃): δ (in ppm) 8.79 (d, J=3.0 Hz, 1H), 7.97 (d, J=8.1 Hz, 1H), 7.62 (dd, J=8.0, 1.7 Hz, 1H), 7.46-7.39 (m, 2H), 7.31 (d, J=3.0 Hz, 1H), 4.09 (dq, J=6.9, 3.7 Hz, 1H), 3.31 (dt, J=11.8, 4.0 Hz, 1H), 3.08 (td, J=11.3, 3.7 Hz, 1H), 1.95-1.90 (m, 1H), 1.80-1.78 (m, 1H), 1.72-1.60 (m, 4H), 1.05 (dd, J=6.8, 4.7 Hz, 3H). ¹³C{¹H}NMR (151 MHz, CDCl₃): δ (in ppm) 145.6, 144.7, 142.6, 129.0, 128.8, 126.5, 126.2, 125.8, 117.9, 51.4, 44.5, 31.4, 25.8, 19.3, 13.9.

### Synthesis of 4-(indolin-1-yl)quinoline (12)

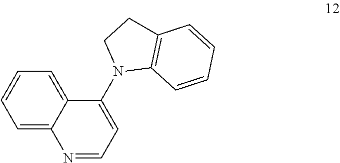 [SMILES: c1ccc2c(c1)CCN2c1ccnc2ccccc12]

Product 12 was prepared in THF according to the General Procedure described above at 60° C. using 4-bromoquinoline (104.02 mg, 0.5 mmol), indoline (67.44 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (30:70) to obtain a pure product as an off-white solid, yield 96% (119.2 mg). ¹H NMR (600 MHz, CDCl₃): δ (in ppm) 8.78 (d, J=5.0 Hz, 1H), 8.13 (dd, J=8.5, 1.4 Hz, 1H), 7.98 (dd, J=8.5, 1.5 Hz, 1H), 7.69-7.67 (m, 1H), 7.42-7.40 (m, 1H), 7.24 (dd, J=7.6, 1.6 Hz, 1H), 7.13 (d, J=4.9 Hz, 1H), 6.97 (dd, J=7.6, 1.5 Hz, 1H), 6.84 (t, J=7.4, 1H), 6.51 (d, J=8.0 Hz, 1H), 4.02 (t, J=8.1 Hz, 2H), 3.19 (t, J=8.1 Hz, 2H). ¹³C{¹H}NMR (151 MHz, CDCl₃): δ (in ppm) 150.7, 149.8, 149.8, 147.9, 131.6, 129.8, 129.5, 126.7, 125.0, 124.8, 124.0, 123.6, 120.4, 110.8, 110.3, 54.6, 28.9. HRMS: Calculated [C₁₇H₁₄N₂+H]⁺=247.1229; found m/z (ESI)=247.1214. Melting Point: 112-115° C.

### Synthesis of 2-methoxy-5-(2-methylpiperidin-1-yl)pyridine (13)

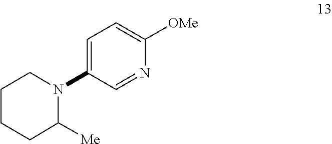

Product 13 was prepared in toluene according to the General Procedure described above at 60° C. using 5-bromo-2-methoxypyridine (47.00 mg, 32.35 μL, 0.25 mmol), 2-methylpiperidine (31.3 μL, 0.3 mmol), 2.0 mol % [Pd(crotyl)Cl]₂ and 4.0 mol % AshPhos as catalyst. The crude reaction mixture was purified by column chromatography over silica gel using EtOAc/Hexane as eluent (10:90) to obtain a pure product as a yellow viscous liquid, yield 71% (38 mg). ¹H NMR (600 MHz, CDCl₃): δ (in ppm) 7.84 (d, J=2.9 Hz, 1H), 7.33 (dd, J=9.2, 2.8 Hz, 1H), 6.67 (d, J=8.9 Hz, 1H), 3.89 (s, 3H), 3.30-3.35 (m, 1H), 2.95-2.98 (m, 1H), 2.87-2.90 (m, 1H), 1.83-1.84 (m, 1H), 1.77-1.68 (m, 2H), 1.68-1.59 (m, 1H), 1.47-1.49 (m, 2H), 0.90 (d, J=6.4 Hz, 3H). ¹³C{¹H}NMR (151 MHz, CDCl₃): δ (in ppm) 139.5, 132.8, 110.7, 54.0, 53.5, 50.3, 33.3, 26.5, 21.7, 16.6. HRMS: Calculated [C₁₂H₁₈N₂O+H]⁺=207.1481; found m/z (ESI)=207.1478.

### Synthesis of 1-(6-methoxypyridin-3-yl)indoline (14)

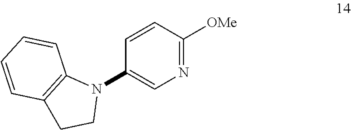

Product 14 was prepared in toluene according to the General Procedure described above at 60° C. using 5-bromo-2-methoxypyridine (47.00 mg, 32.35 μL, 0.25 mmol), indoline (33.7 μL, 0.6 mmol), 2.0 mol % [Pd(crotyl)Cl]₂ and 4.0 mol % AshPhos as catalyst. The crude reaction mixture was purified by column chromatography over silica gel using EtOAc/Hexane as eluent (20:80) to obtain a pure product as a colourless viscous liquid, yield 85% (48.6 mg). ¹H NMR (600 MHz, CDCl₃): δ (in ppm) 8.11 (dd, J=2.9, 0.7 Hz, 1H), 7.57 (dd, J=8.8, 2.9 Hz, 1H), 7.17 (d, 1H), 7.05 (t, 1H), 6.82-6.84 (m, 2H), 6.80-6.70 (m, 1H), 3.94 (s, 3H), 3.88 (t, J=8.4 Hz, 2H), 3.05 (t, 2H). ¹³C{¹H}NMR (151 MHz, CDCl₃): δ (in ppm) 159.9, 148.5, 138.4, 135.6, 131.3, 130.9, 127.6, 125.4, 119.1, 111.2, 107.6, 53.4, 28.7. HRMS: Calculated [C₁₄H₁₄N₂O+H]⁺=227.1178; found m/z (ESI)=227.1168.

### Synthesis of 1-methyl-5-(2-methylpiperidin-1-yl)-1H-indazole (15)

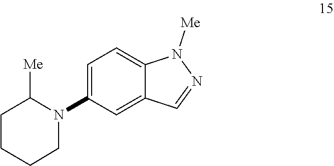

Product 15 was prepared in toluene according to the General Procedure described above at 90° C. using 5-bromo-1-methyl-1H-indazole (52.76 mg, 0.25 mmol), 2-methylpiperidine (31.31 μL, 0.3 mmol), 5.0 mol % [Pd(crotyl)Cl]₂ and 10.0 mol % AshPhos as catalyst. The crude reaction mixture was purified by column chromatography over silica gel using EtOAc/Hexane as eluent (20:80) to obtain a pure product as a light pink solid, yield 78% (45 mg). [Note: Using 1.0 mol % [Pd(crotyl)Cl]₂ and 2.0 mol % AshPhos as catalyst gave 48% yield]¹H NMR (600 MHz, CDCl₃): δ (in ppm) 7.86 (d, J=1.0 Hz, 1H), 7.29 (d, J=9.7 Hz, 1H), 7.23 (d, J=7.4 Hz, 2H), 4.03 (s, 3H), 3.48 (td, J=6.4, 3.9 Hz, 1H), 3.06 (dd, J=7.6, 4.1 Hz, 1H), 2.93 (m, 1H), 1.91-1.86 (m, 1H), 1.77-1.65 (m, 3H), 1.56-1.48 (m, 2H), 0.90 (d, J=6.5 Hz, 3H). ¹³C{¹H}NMR (151 MHz, CDCl₃): δ (in ppm) 146.3, 136.6, 131.9, 124.4, 123.4, 110.9, 109.0, 54.6, 50.6, 35.4, 33.2, 26.4, 21.6, 16.1. HRMS: Calculated [C₁₄H₁₉N₃+H]⁺=230.1651; found m/z (ESI)=230.1629. Melting Point: 62-64° C.

### Synthesis of 5-(indolin-1-yl)-1-methyl-1H-indazole (16)

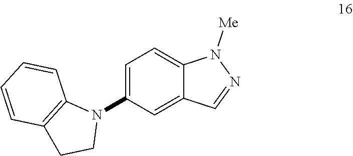

Product 16 was prepared in THF according to the General Procedure described above at 90° C. using 5-bromo-1-methyl-1H-indazole (52.76 mg, 0.25 mmol), indoline (33.72 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a yellow solid, yield 84%. ¹H NMR (600 MHz, CDCl₃): δ (in ppm) 7.93 (d, J=1.0 Hz, 1H), 7.48 (dd, J=2.1, 0.8 Hz, 1H), 7.46 (dd, J=8.9, 2.1 Hz, 1H), 7.39 (dt, J=8.9, 0.9 Hz, 1H), 7.19 (dd, J=7.3, 1.3 Hz, 1H), 7.09-7.04 (m, 1H), 6.97-6.93 (m, 1H), 6.75 (td, J=7.3, 1.0 Hz, 1H), 4.08 (s, 3H), 3.96 (t, J=8.4 Hz, 2H), 3.14 (t, 2H). ¹³C{¹H}NMR (151 MHz, CDCl₃): δ (in ppm) 149.0, 138.5, 137.0, 132.3, 131.0, 127.4, 125.2, 124.9, 121.6, 118.7, 110.0, 109.8, 107.6, 53.9, 35.9, 28.7. HRMS: Calculated [C₁₆H₁₅N₃+H]⁺=250.1336; found m/z (ESI)=250.1313. Melting Point: 116-118° C.

### Synthesis of 2-(indolin-1-yl)-4-(trifluoromethyl)thiazole (17)

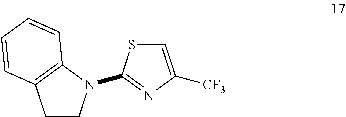

Product 17 was prepared in toluene according to the General Procedure described above at 50° C. using 2-bromo-4-(trifluoromethyl)thiazole (58.00 mg, 0.25 mmol), indoline (33.72 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a white solid, yield 93% (63 mg). [Note: Using 1.0 mol % [Pd(crotyl)Cl]₂ and 2.0 mol % AshPhos as catalyst gave 87% yield]¹H NMR (600 MHz, CDCl₃): δ (in ppm) 7.99 (dd, J=8.1, 1H), 7.29 (t, J=7.8 Hz, 1H), 7.24 (dt, J=7.7, 2.2 Hz, 1H), 7.14 (dd, J=2.4, 1.2 Hz, 1H), 7.04-6.98 (m, 1H), 4.11 (dt, J=11.6, 8.5 Hz, 2H), 3.32 (q, J=7.9 Hz, 2H). ¹³C{¹H}NMR (151 MHz, CDCl₃): δ (in ppm) 164.2, 143.2, 141.8 (q, J=36.7 Hz), 131.2, 127.9, 125.0, 123.7-117.2 (m), 113.2, 108.9 (q, J=4.3 Hz), 51.7, 28.1. ¹⁹F{¹H}NMR (564 MHz, CDCl₃): δ −65.02. HRMS: Calculated [C₁₂H₉F₃N₂S+H]⁺=271.0511; found m/z (ESI)=271.0500. Melting Point: 75-78° C.

### Synthesis of 2-methyl-1-(1-methyl-1H-pyrazol-3-yl)piperidine (18)

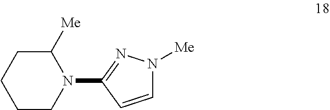

Product 18 was prepared in THF according to the General Procedure described above at 60° C. using 3-bromo-1-methyl-1H-pyrazole (40.25 mg, 25.80 μL, 0.25 mmol), 2-methylpiperidine (104.3 μL, 1.0 mmol), 5.0 mol % [Pd(crotyl)Cl]₂ and 10.0 mol % AshPhos as catalyst. The crude reaction mixture was purified by column chromatography over silica gel using EtOAc/Hexane as eluent (30:70) to obtain a pure product as a yellow viscous liquid, yield 84% (37 mg). ¹H NMR (600 MHz, CDCl₃): δ (in ppm) 7.12 (d, J=2.4 Hz, 1H), 5.59 (s, 1H), 3.87-3.85 (m, 1H), 3.73 (s, 3H), 3.42-3.39 (m, 1H), 2.95-2.88 (m, 1H), 1.88-1.79 (m, 1H), 1.70-1.64 (m, 1H), 1.63-1.52 (m, 4H), 1.07 (d, J=6.7 Hz, 3H). ¹³C{¹H}NMR (151 MHz, CDCl₃): δ (in ppm) 159.4, 130.7, 91.6, 50.0, 42.9, 38.5, 30.7, 25.5, 19.2, 12.9. HRMS: Calculated [C₁₀H₁₇N₃+H]⁺=180.1495; found m/z (ESI)=180.1476.

### Synthesis of N-(tert-butyl)-4-methylpyridin-3-amine (19)

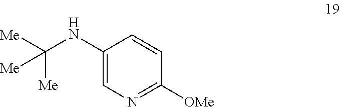 [SMILES: COc1ccc(NC(C)(C)C)cn1]

Product 19 was prepared in THF according to the General Procedure described above at 90° C. using 3-bromo-4-methylpyridine (94.01 mg, 64.7 μL, 0.5 mmol), 2-methylpropan-2-amine (64 μL, 0.6 mmol), 3.0 mol % [Pd(crotyl)Cl]₂ and 6.0 mol % AshPhos as a catalyst. The crude reaction mixture was purified by column chromatography over silica gel using EtOAc/Hexane as eluent (20:80) to obtain a pure product as a pale-yellow viscous liquid, yield 61% (56 mg). ¹H NMR (600 MHz, CDCl₃): δ (in ppm) 7.73 (d, J=3.0 Hz, 1H), 7.32-7.08 (m, 1H), 6.60 (d, J=8.7 Hz, 1H), 3.87 (d, J=1.4 Hz, 3H), 1.20 (d, J=1.8 Hz, 9H). ¹³C{¹H}NMR (151 MHz, CDCl₃): δ (in ppm) 160.0, 139.7, 136.7, 134.3, 110.5, 53.6, 52.7, 30.3. HRMS: Calculated [C₁₀H₁₆N₂O+H]⁺=181.1335; found m/z (ESI)=181.1321.

### Synthesis of N-(tert-butyl)-4-methylpyridin-3-amine (20) (CAS #2322055-17-2)

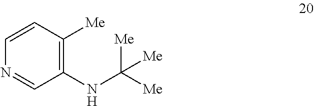 [SMILES: Cc1ccncc1NC(C)(C)C]

Product 20 was prepared in THF according to the General Procedure described above at 60° C. using 3-bromo-4-methylpyridine (86.01 mg, 55.53 μL, 0.5 mmol), 2-methylpropan-2-amine (64 μL, 0.6 mmol), 3.0 mol % [Pd(crotyl)Cl]₂ and 6.0 mol % AshPhos as catalyst. The crude reaction mixture was purified by column chromatography over silica gel using EtOAc/Hexane as eluent (20:80) to obtain a pure product as a pale-yellow viscous liquid, yield: 71% (59.6 mg). ¹H NMR (500 MHz, CDCl₃): δ (in ppm) 8.24 (s, 1H), 7.88 (d, J=4.7 Hz, 1H), 6.94 (d, J=4.7 Hz, 1H), 3.28 (s, 1H), 2.10 (s, 3H), 1.39 (s, 9H). ¹³C{¹H}NMR (126 MHz, CDCl₃): δ (in ppm) 141.6, 139.3, 136.3, 132.2, 125.3, 51.6, 30.2, 17.5.

### Synthesis of N-(tert-butyl)-2-(trifluoromethyl)pyrimidin-5-amine (21)

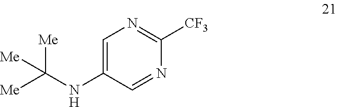 [SMILES: CC(C)(C)Nc1cnc(C(F)(F)F)nc1]

Product 21 was prepared in THF according to the General Procedure described above at 60° C. using 5-bromo-2-(trifluoromethyl)pyrimidine (136.2 mg, 0.5 mmol), 2-methylpropan-2-amine (64 μL, 0.6 mmol), 3.0 mol % [Pd(crotyl)Cl]₂ and 6.0 mol % AshPhos as catalyst. The crude reaction mixture was purified by column chromatography over silica gel using EtOAc/Hexane as eluent (10:90) to obtain a pure product as a dark orange solid, yield 80% (106 mg). ¹H NMR (600 MHz, CDCl₃): δ (in ppm) 8.21 (s, 2H), 4.19 (s, 1H), 1.41 (d, J=1.3 Hz, 9H). ¹³C{¹H}NMR (151 MHz, CDCl₃): δ (in ppm) 145.0 (q, J=36.7 Hz), 142.4, 142, 120.5 (q, J=273.2 Hz), 52.0, 29.4. ¹⁹F NMR (564 MHz, CDCl₃): δ (in ppm) −68.9. HRMS: Calculated [C₉H₁₂F₃N₃+H]⁺=220.1056; found m/z (ESI)=220.1037. Melting Point: 106-108° C.

### Synthesis of N-(tert-butyl)benzo[b]thiophen-5-amine (22)

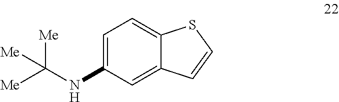

Product 22 was prepared in THF according to the General Procedure described above at 60° C. using 5-bromobenzo[b]thiophene (128 mg, 0.5 mmol), 2-methylpropan-2-amine (64 μL, 0.6 mmol), 3.0 mol % [Pd(crotyl)Cl]₂ and 6.0 mol % AshPhos as catalyst. The crude reaction mixture was purified by column chromatography over silica gel using EtOAc/Hexane as eluent (5:95) to obtain a pure product as a brown viscous liquid, yield 79% (97.6 mg). ¹H NMR (600 MHz, CDCl₃): δ (in ppm) 7.66 (dd, J=8.7, 2.1 Hz, 1H), 7.39 (dd, J=5.5, 2.2 Hz, 1H), 7.26 (t, J=2.3 Hz, 1H), 7.21 (dt, J=5.4, 1.3 Hz, 1H), 6.86 (dt, J=8.6, 2.3 Hz, 1H), 3.41 (s, 1H), 1.38 (d, J=3.0 Hz, 9H). ¹³C NMR (151 MHz, CDCl₃): δ (in ppm) 143.7, 140.5, 130.9, 126.6, 123.3, 122.3, 118.8, 111.8, 51.8, 30.0. HRMS: Calculated [C₁₂H₁₅NS+H]⁺=206.0997; found m/z (ESI)=206.0975.

### Synthesis of N-(tert-butyl)quinolin-4-amine (23) (CAS #386706-68-9)

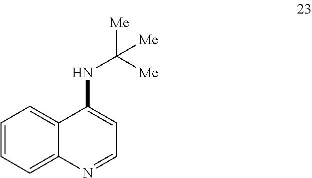

Product 23 was prepared in THF according to the General Procedure described above at 60° C. using 4-bromoquinoline (124.8 mg, 0.5 mmol), 2-methylpropan-2-amine (64 μL, 0.6 mmol), 3.0 mol % [Pd(crotyl)Cl]₂ and 6.0 mol % AshPhos as catalyst. The crude reaction mixture was purified by column chromatography over silica gel using EtOAc/Hexane as eluent (20:80) to obtain a pure product as a white solid, yield 89% (109 mg). ¹H NMR (600 MHz, CDCl₃): δ (in ppm) 8.51 (d, J=5.4 Hz, 1H), 7.95 (dd, J=8.4, 1.3 Hz, 1H), 7.66 (dd, J=8.5, 1.4 Hz, 1H), 7.59 (ddd, J=8.3, 6.8, 1.4 Hz, 1H), 7.39 (ddd, J=8.3, 6.8, 1.4 Hz, 1H), 6.65 (d, J=5.4 Hz, 1H), 5.00 (s, 1H), 1.54-1.48 (m, 9H). ¹³C NMR (151 MHz, CDCl₃): δ (in ppm) 150.4, 148.7, 147.6, 130.1, 128.6, 124.4, 119.3, 118.9, 101.0, 51.3, 29.1.

### Synthesis of N-(tert-butyl)-1-methyl-1H-indazol-5-amine (24)

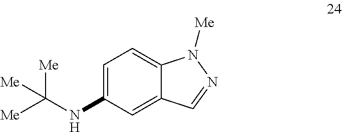

Product 24 was prepared in THF according to the General Procedure described above at 60° C. using 5-bromo-1-methyl-1H-indazole (126.7 mg, 0.5 mmol), 2-methylpropan-2-amine (64 μL, 0.6 mmol), 3.0 mol % [Pd(crotyl)Cl]₂ and 6.0 mol % AshPhos as catalyst. The crude reaction mixture was purified by column chromatography over silica gel using EtOAc/Hexane as eluent (20:80) to obtain a pure product as a yellow viscous liquid, yield 78% (95 mg). ¹H NMR (600 MHz, CDCl₃): δ (in ppm) 7.82 (d, J=1.0 Hz, 1H), 7.19 (dd, J=8.8, 1.1 Hz, 1H), 7.14-7.06 (m, 1H), 6.93-6.95 (m, 1H), 3.99 (d, J=1.2 Hz, 3H), 3.19 (s, 1H), 1.27 (s, 9H). ¹³C{¹H}NMR (151 MHz, CDCl₃): δ (in ppm) 139.7, 136.2, 131.5, 124.5, 123.8, 109.8, 108.8, 52.2, 35.4, 29.9. HRMS: Calculated [C₁₂H₁₇N₃+H]⁺=204.1495; found m/z (ESI)=204.1472.

### Synthesis of 5-(3,3-difluoroazetidin-1-yl)-2-methoxypyridine (25)

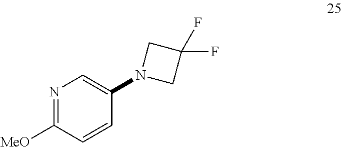

Product 25 was prepared in toluene according to the General Procedure described above at 60° C. using 5-bromo-2-methoxypyridine (47.00 mg, 30.71 μL, 0.25 mmol), 3,3-difluoroazetidine (38.8 mg, 0.3 mmol), 2.0 mol % [Pd(crotyl)Cl]₂ and 4.0 mol % AshPhos as catalyst. The crude reaction mixture was purified by column chromatography over silica gel using EtOAc/Hexane as eluent (5:95) to obtain a pure product as a colourless viscous liquid, yield 75% (37.4 mg). ¹H NMR (600 MHz, CDCl₃): δ (in ppm) 7.44 (d, J=3.1 Hz, 1H), 6.84 (m, 1H), 6.6 (m, 1H), 4.17 (t, J=11.7 Hz, 4H), 3.87 (s, 3H). ¹³C{¹H}NMR (151 MHz, CDCl₃): δ (in ppm) 158.2, 140.9, 130.3, 124.6, 115.8 (t, J=274.9 Hz), 110.8, 63.9 (t, J=25.2 Hz), 53.3. ¹⁹F{¹H}NMR (564 MHz, CDCl₃): δ −98.98. HRMS: Calculated [C₉HioF₂N₂O+H]⁺=201.0833; found m/z (ESI)=201.0816.

### Synthesis of 4-(6-methoxypyridin-3-yl) morpholine (26)

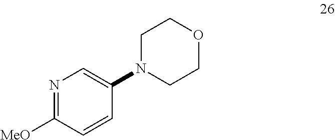

Product 26 was prepared in toluene according to the General Procedure described above at 60° C. using 5-bromo-2-methoxypyridine (94.01 mg, 61.5 μL, 0.5 mmol), morpholine (52.3 μL, 0.6 mmol), 2.0 mol % [Pd(crotyl)Cl]₂ and 4.0 mol % AshPhos as catalyst. The crude reaction mixture was purified by column chromatography over silica gel using EtOAc/Hexane as eluent (20:80) to obtain a pure product as a yellow viscous liquid, yield 86% (84 mg). ¹H NMR (500 MHz, DMSO): δ (in ppm) 6.93 (d, J=3.1 Hz, 1H), 6.58 (dd, J=9.0, 3.1 Hz, 1H), 5.95-5.85 (m, 1H), 2.94 (d, J=2.1 Hz, 4H), 2.93 (s, 3H), 2.23-2.14 (m, 4H). ¹³C{¹H}NMR (126 MHz, DMSO): δ (in ppm) 157.7, 142.3, 133.3, 128.6, 110.2, 66.0, 52.9, 49.4. HRMS: Calculated [C₁₀H₁₄N₂O₂+H]⁺=195.1128; found m/z (ESI)=195.1107.

### Synthesis of 5-(3,3-difluoropyrrolidin-1-yl)-2-methoxypyridine (27)

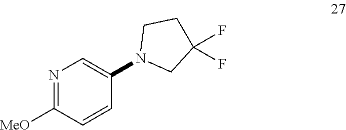

Product 27 was prepared in toluene according to the General Procedure described above at 60° C. using 5-bromo-2-methoxypyridine (94.01 mg, 61.5 μL, 0.5 mmol), 3,3-difluoropyrrolidine (77.8 mg, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a white waxy solid, yield 71% (77 mg). ¹H NMR (500 MHz, DMSO): δ (in ppm) 6.69 (d, J=3.1 Hz, 1H), 6.30 (dd, J=8.9, 3.1 Hz, 1H), 5.86 (d, J=8.9 Hz, 1H), 2.91 (s, 3H), 2.78 (t, J=13.5 Hz, 2H), 2.56 (t, J=7.2 Hz, 2H), 1.68-1.60 (m, 2H). ¹³C{¹H}NMR (126 MHz, DMSO): δ (in ppm) 156.5, 138.9, 129.8, 129.3, 124.9, 110.3, 55.6 (t, J=30.9 Hz), 52.8, 46.2 (t, J=3.6 Hz), 33.8 (t, J=23.6 Hz). HRMS: Calculated [C₁₀H₁₂F₂N₂O+H]⁺=215.0990; found m/z (ESI)=215.0975.

### Synthesis of 2-(6-methoxypyridin-3-yl)-1,2,3,4-tetrahydroisoquinoline (28) (CAS #1057279-02-3)

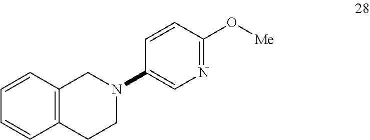

Product 28 was prepared in toluene according to the General Procedure described above at 60° C. using 5-bromo-2-methoxypyridine (94.01 mg, 61.5 μL, 0.5 mmol), 1,2,3,4-tetrahydroisoquinoline (52.3 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a pale-yellow viscous liquid, yield 78% (95 mg) (NMR purity 82%). ¹H NMR (500 MHz, DMSO): δ (in ppm) 7.86 (d, J=3.0 Hz, 1H), 7.51 (dd, J=9.0, 3.1 Hz, 1H), 7.24-7.01 (m, 4H), 6.73 (d, J=9.0 Hz, 1H), 4.28 (s, 2H), 3.78 (s, 3H), 3.42 (t, J=5.9 Hz, 2H), 2.89 (t, J=5.9 Hz, 2H). ¹³C{¹H}NMR (126 MHz, DMSO): δ (in ppm) 157.1, 141.5, 133.9, 133.1, 128.5, 128.3, 126.3, 125.9, 125.6, 110.0, 52.6, 50.8, 46.2, 27.7.

### Synthesis of 2-methoxy-5-(4-methoxypiperidin-1-yl)pyridine (29)

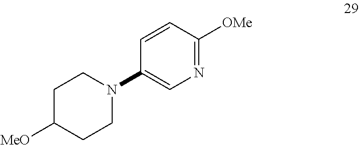

Product 29 was prepared in toluene according to the General Procedure described above at 60° C. using 5-bromo-2-methoxypyridine (94.01 mg, 61.5 μL, 0.5 mmol), 4-methoxypiperidine (74.3 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a pale-yellow viscous liquid, yield 81% (94 mg). ¹H NMR (600 MHz, DMSO): δ (in ppm) 7.77 (d, J=3.2 Hz, 1H), 7.40 (dd, J=9.0, 3.1 Hz, 1H), 6.68 (d, J=9.0 Hz, 1H), 3.77 (s, 3H), 3.32-3.26 (m, 3H), 3.25 (s, 3H), 2.79-2.75 (m, 2H), 1.93-1.90 (m, 2H), 1.56-1.51 (m, 2H). ¹³C{¹H}NMR (151 MHz, DMSO): δ (in ppm) 157.3, 142.3, 133.7, 129.3, 109.9, 74.9, 54.6, 52.6, 47.2, 39.4, 30.1. HRMS: Calculated [C₁₂H₁₈N₂O₂+H]⁺=223.1441; found m/z (ESI)=223.1422.

### Synthesis of 2-(6-(trifluoromethyl)pyridine-2-yl)-1,2,3,4-tetrahydroisoquinoline (30)

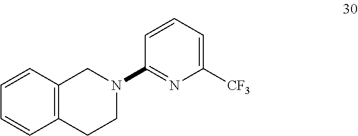

Product 30 was prepared in toluene according to the General Procedure described above at 60° C. using 2-bromo-6-(trifluoromethyl)pyridine (56.5 mg, 0.25 mmol), 1,2,3,4-tetrahydroisoquinoline (37.5 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as bright yellow semisolid/waxy, yield 99% (59.1 mg). ¹H NMR (600 MHz, CDCl₃): δ (in ppm) 7.64-7.61 (m, 1H), 7.27-7.22 (m, 4H), 6.95 (d, J=7.3 Hz, 1H), 6.81 (d, J=8.6 Hz, 1H), 4.75 (s, 2H), 3.90 (t, J=5.9 Hz, 2H), 2.99 (t, J=5.9 Hz, 2H). ¹³C{¹H}NMR (151 MHz, CDCl₃): δ (in ppm) 158.3, 146.5 (q, J=33.8 Hz), 138.3, 135.4, 134.1, 128.5, 126.7 (d, J=3.8 Hz), 126.4, 121.9 (q, J=273.9 Hz), 109.2, 108.3 (d, J=3.2 Hz), 47.0, 42.4, 28.9. HRMS: Calculated [C₁₅H₁₃F₃N₂+H]⁺=279.1103; found m/z (ESI)=277.0937.

### Synthesis of 2-(4-(6-methoxypyridin-2-yl)piperazin-1-yl)pyrimidine (31)

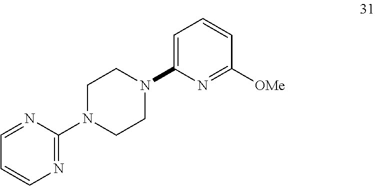

Product 31 was prepared in toluene according to the General Procedure described above at 60° C. using 2-bromo-6-methoxypyridine (94.01 mg, 61.5 μL, 0.5 mmol), 2-(piperazin-1-yl)pyrimidine (98.52 mg, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a yellow solid, yield 82% (111 mg). ¹H NMR (500 MHz, CDCl₃): δ (in ppm) 8.33 (d, J=4.7 Hz, 2H), 7.42 (t, J=7.9 Hz, 1H), 6.50 (t, J=4.7 Hz, 1H), 6.20 (d, J=8.0 Hz, 1H), 6.10 (d, J=7.9 Hz, 1H), 3.97-3.95 (m, 4H), 3.88 (s, 3H), 3.64-3.62 (m, 4H). ¹³C{¹H}NMR (126 MHz, CDCl₃): δ (in ppm) 163.2, 161.9, 158.3, 157.8, 140.3, 110.2, 98.5, 98.4, 53.1, 45.2, 43.5. HRMS: Calculated [C₁₄H₁₇N₅O+H]⁺=272.1505; found m/z (ESI)=272.1493. Melting Point: 81-84° C.

### Synthesis of 1-(6-methoxypyridin-3-yl)-4-(pyridin-2-yl)piperazine (32)

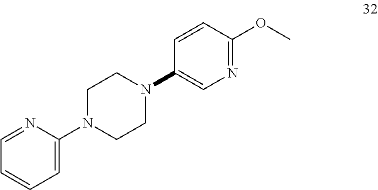

Product 32 was prepared in toluene according to the General Procedure described above at 60° C. using 5-bromo-2-methoxypyridine (94.01 mg, 61.5 μL, 0.5 mmol), 1-(pyridin-2-yl)piperazine (91.4 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a pale yellow solid yield 99% (142.8 mg). ¹H NMR (500 MHz, DMSO): δ (in ppm) 8.14 (dd, J=4.9, 2.0 Hz, 1H), 7.83 (d, J=3.0 Hz, 1H), 7.56-7.53 (m, 1H), 7.49 (dd, J=8.9, 3.1 Hz, 1H), 6.87 (d, J=8.6 Hz, 1H), 6.73 (d, J=8.9 Hz, 1H), 6.66 (dd, J=7.1, 4.9 Hz, 1H), 3.78 (s, 3H), 3.62 (t, J=5.1 Hz, 4H), 3.12 (t, J=5.0 Hz, 4H). ¹³C{¹H}NMR (126 MHz, DMSO): δ (in ppm) 159.0, 157.9, 147.6, 142.3, 137.5, 133.9, 129.4, 113.2, 110.2, 107.2, 52.9, 49.3, 44.6. HRMS: Calculated [C₁₅H₁₈N₄O+H]⁺=271.1543; found m/z (ESI)=271.1531. Melting Point: 91-94° C.

### Synthesis of 2-(4-(6-(trifluoromethyl)pyridin-2-yl)piperazin-1-yl)pyrimidine (33)

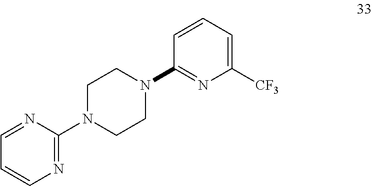

Product 33 was prepared in toluene according to the General Procedure described above at 60° C. using 2-bromo-6-(trifluoromethyl)pyridine (56.5 mg, 0.25 mmol), 2-(piperazin-1-yl)pyrimidine (49.3 mg, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as white semisolid/waxy, yield 98% (76 mg). ¹H NMR (600 MHz, CDCl₃): δ (in ppm) 8.32 (d, J=4.8 Hz, 1H), 7.58 (t, J=8.0 Hz, 1H), 6.95 (d, J=7.3 Hz, 1H), 6.80 (d, J=8.7 Hz, 1H), 6.51 (t, J=4.7 Hz, 1H), 3.97-3.95 (m, 4H), 3.72-3.70 (m, 4H). ¹³C{¹H}NMR (151 MHz, CDCl₃): δ (in ppm) 161.8, 158.9, 157.9, 146.5 (q, J=34.0 Hz), 138.4, 121.7 (q, J=273.9 Hz), 110.3, 109.7, 109.2, 44.6, 43.4. HRMS: Calculated [C₁₄H₁₄F₃N₅+H]⁺=318.1274; found m/z (ESI)=318.1267.

### Synthesis of 2-(4-methoxypiperidin-1-yl)-6-(trifluoromethyl)pyridine (34)

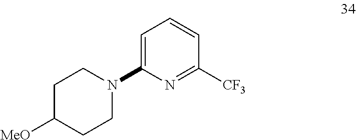

Product 34 was prepared in toluene according to the General Procedure described above at 60° C. using 2-bromo-6-(trifluoromethyl)pyridine (113 mg, 0.5 mmol), 4-methoxypiperidine (74.30 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a pale-yellow viscous liquid, yield 98% (127 mg). ¹H NMR (600 MHz, CDCl₃): δ (in ppm) 7.53 (dd, J=8.6, 7.2 Hz, 1H), 6.89 (d, J=7.4 Hz, 1H), 6.78 (d, J=8.7 Hz, 1H), 3.9 (m, 2H), 3.48-3.44 (m, 1H), 3.38 (s, 3H), 3.32-3.28 (m, 2H), 1.98-1.95 (m, 2H), 1.66-1.60 (m, 2H). ¹³C{¹H}NMR (151 MHz, CDCl₃): δ (in ppm) 158.8, 146.5 (q, J=33.8 Hz), 138.3, 121.8 (q, J=274.0 Hz), 109.6, 108.5 (d, J=3.1 Hz), 76.2, 55.7, 42.5, 30.3. ¹⁹F{¹H}NMR (564 MHz, CDCl₃): δ (in ppm) −68.81. HRMS: Calculated [C₁₂H₁₅F₃N₂O+H]⁺=261.1209; found m/z (ESI)=261.1189.

### Synthesis of 2-(2-(trifluoromethyl)pyrimidin-5-yl)-1,2,3,4-tetrahydroiso-quinoline (35)

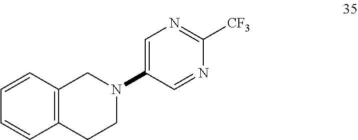

Product 35 was prepared in toluene according to the General Procedure described above at 60° C. using 5-bromo-2-(trifluoromethyl)pyrimidine (56.74 mg, 0.25 mmol), 1,2,3,4-tetrahydroisoquinoline (37.55 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a brown solid, yield 58% (42 mg). ¹H NMR (600 MHz, CDCl₃): δ (in ppm) 8.43 (s, 2H), 7.29-7.23 (m, 4H), 4.55 (s, 2H), 3.69 (t, J=5.9 Hz, 2H), 3.05 (t, J=5.9 Hz, 2H). ¹³C{¹H}NMR (151 MHz, CDCl₃): δ (in ppm) 145.2 (q, J=36.9 Hz), 143.7, 140.6, 134.4, 132.4, 128.5, 127.5, 126.9, 126.7, 120.4 (q, J=273.6 Hz), 48.1, 44.0, 28.7. HRMS: Calculated [C₁₄H₁₂F₃N₃+H]⁺=280.1056; found m/z (ESI)=280.1037. Melting Point: 160-163° C.

### Synthesis of 4-(2-(trifluoromethyl)pyrimidin-5-yl)morpholine (36)

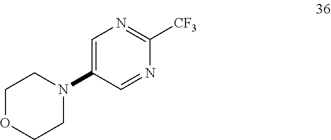

Product 36 was prepared in toluene according to the General Procedure described above at 60° C. using 5-bromo-2-(trifluoromethyl)pyrimidine (56.74 mg, 0.25 mmol), morpholine (26 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (10:90) to obtain a pure product as a pale yellow solid, yield 91% (53 mg). ¹H NMR (500 MHz, CDCl₃): δ (in ppm) 8.07 (s, 2H), 4.45 (t, J=11.5 Hz, 4H). ¹³C{¹H}NMR (126 MHz, CDCl₃): δ (in ppm) 147.0 (dt, J=36.9 Hz), 143.1, 140.3, 120.1 (q, J=273.7), 115.3, 63.6, 29.7. HRMS: Calculated [C₉H₁₀F₃N₃O+H]⁺=234.0848; found m/z (ESI)=234.0825. Melting Point: 148-151° C.

### Synthesis of 5-(3,3-difluoropyrrolidin-1-yl)-2-(trifluoromethyl)pyrimidine (37)

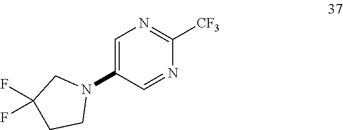

Product 37 was prepared in toluene according to the General Procedure described above at 60° C. using 5-bromo-2-(trifluoromethyl)pyrimidine (56.74 mg, 0.25 mmol), 3,3-difluoropyrrolidine (43.1 mg, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a yellow solid, yield 89% (56.5 mg). ¹H NMR (600 MHz, CDCl₃): δ (in ppm) 8.13 (s, 2H), 3.78 (t, J=12.5 Hz, 2H), 3.68 (t, J=7.2 Hz, 2H), 2.64-2.57 (m, 2H). ¹³C{¹H}NMR (151 MHz, CDCl₃): δ (in ppm) 145.9 (q, J=37.1 Hz), 141.2, 139.7, 127.2 (t, J=248.1 Hz), 120.3 (q, J=273.3 Hz), 54.2 (t, J=32.3 Hz), 45.3, 33.9 (t, J=24.3 Hz). ¹⁹F{¹H}NMR (564 MHz, CDCl₃): δ (in ppm) −68.9, −100.4 (m). HRMS: Calculated [C₉H₈F₅N₃+H]⁺=254.0711; found m/z (ESI)=254.0701. Melting Point: 138-140° C.

### Synthesis of 5-(4-methoxypiperidin-1-yl)-2-(trifluoromethyl)pyrimidine (38)

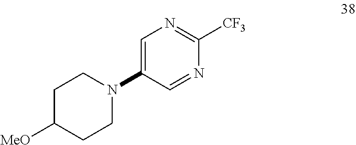

Product 38 was prepared in toluene according to the General Procedure described above at 60° C. using 5-bromo-2-(trifluoromethyl)pyrimidine (56.74 mg, 0.25 mmol), 4-methoxypiperidine (38 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as an off-white solid, yield 88% (58.2 mg). ¹H NMR (600 MHz, CDCl₃): δ (in ppm) 8.39 (s, 2H), 3.63-3.59 (m, 2H), 3.52-3.49 (m, 1H), 3.38 (s, 3H), 3.28-3.24 (m, 2H), 2.02-1.98 (m, 2H), 1.82-1.76 (m, 2H). ¹³C{¹H}NMR (151 MHz, CDCl₃): δ (in ppm) 145.8 (q, J=36.5 Hz), 144.7, 142.9, 120.3 (q, J=273.7 Hz), 74.4, 55.9, 44.1, 29.7. HRMS: Calculated [C₁₁H₁₄F₃N₃O+H]⁺=262.1161; found m/z (ESI)=262.1144. Melting Point: 107-109° C.

### Synthesis of 5-(4-methoxypiperidin-1-yl)-1-methyl-1H-pyrrolo[2,3-b]pyridine (39)

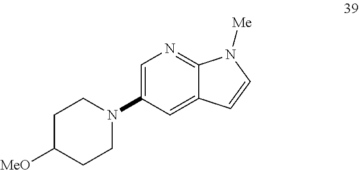

Product 39 was prepared in THF according to the General Procedure described above at 90° C. using 1-methyl-1H-pyrrolo[2,3-b]pyridine (53 mg, 0.25 mmol), 4-methoxypiperidine (38 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (60:40) to obtain a pure product as a yellow viscous liquid, yield 90% (55.7 mg). 1H NMR (600 MHz, CDCl₃): δ (in ppm) 8.17 (d, J=2.6 Hz, 1H), 7.48 (d, J=2.6 Hz, 1H), 7.09 (d, J=3.4 Hz, 1H), 6.31 (d, J=3.4 Hz, 1H), 3.82 (s, 3H), 3.37 (s, 5H), 2.89-2.84 (m, 2H), 2.01-2.06 (m, 2H), 1.82-1.75 (m, 2H). ¹³C{¹H}NMR (151 MHz, CDCl₃): δ (in ppm) 168.8, 143.9, 142.9, 137.6, 129.3, 120.3, 117.3, 98.6, 75.8, 55.6, 50.1, 43.5, 38.6, 31.3, 30.1, 21.4. HRMS: Calculated [C₁₄H₁₉N₃O+H]⁺=246.1600; found m/z (ESI)=246.1582.

### Synthesis of 5-(3,3-difluoropyrrolidin-1-yl)-1-methyl-1H-pyrrolo[2,3-b]pyridine (40)

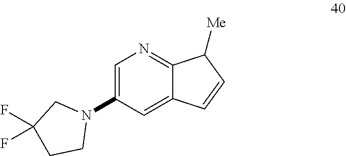

Product 40 was prepared in THF according to the General Procedure described above at 90° C. using 1-methyl-1H-pyrrolo[2,3-b]pyridine (52.8 mg, 0.25 mmol), 3,3-difluoropyrrolidine (43.2 mg, 0.3 mmol), 4.0 mol % [Pd(crotyl)Cl]₂ and 8.0 mol % AshPhos as catalyst. The crude reaction mixture was purified by column chromatography over silica gel using MeOH/DCM as eluent (5:95) to obtain a pure product as a yellow solid, yield 88% (52.7 mg). [Note: Using 1.0 mol % [Pd(crotyl)Cl]₂ and 2.0 mol % AshPhos as catalyst gave 60% yield]¹H NMR (600 MHz, CDCl₃): δ (in ppm) 7.86 (s, 1H), 7.11-7.09 (m, 2H), 6.31 (dd, J=3.3, 1.3 Hz, 1H), 3.81 (s, 3H), 3.70-3.66 (m, 2H), 3.52-3.50 (m, 2H), 2.53-2.46 (m, 2H). ¹³C{¹H}NMR (151 MHz, CDCl₃): δ (in ppm) 142.6, 138.3, 130.2, 129.4, 128.3, 120.3, 110.8, 97.6, 56.5 (t, J=31.2 Hz), 46.5 (t, J=3.5 Hz), 34.3 (t, J=24.3 Hz), 30.9. HRMS: Calculated [C₁₂H₁₃F₂N₃+H]⁺=238.1150; found m/z (ESI)=238.1128. Melting Point: 107-109° C.

### Synthesis of 1-methyl-5-(4-methylpiperazin-1-yl)-1H-pyrrolo[2,3-b]pyridine (41)

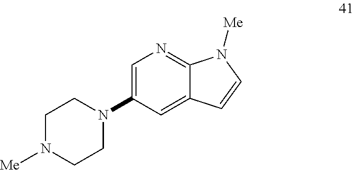

Product 41 was prepared in THF according to the General Procedure described above at 90° C. using 1-methyl-1H-pyrrolo[2,3-b]pyridine (53 mg, 0.25 mmol), 1-methylpiperazine (34 μL, 0.3 mmol), 2.0 mol % [Pd(crotyl)Cl]₂ and 4.0 mol % AshPhos as catalyst. The crude reaction mixture was purified by column chromatography over silica gel using MeOH/DCM as eluent (5:95) to obtain a pure product as a light brown solid, yield 96% (56 mg). [Note: Using 1.0 mol % [Pd(crotyl)Cl]₂ and 2.0 mol % AshPhos as catalyst gave 93% yield]¹H NMR (600 MHz, CDCl₃): δ (in ppm) 8.16 (d, J=2.6 Hz, 1H), 7.46 (d, J=2.6 Hz, 1H), 7.09 (d, J=3.4 Hz, 1H), 6.32 (d, J=3.4 Hz, 1H), 3.82 (s, 3H), 3.14-3.13 (m, 4H), 2.61-2.59 (m, 4H), 2.34 (s, 3H). ¹³C{¹H}NMR (151 MHz, CDCl₃): δ (in ppm) 144.3, 142.9, 137.4, 129.7, 120.6, 117.0, 98.9, 55.6, 52.1, 46.4, 31.6. HRMS: Calculated [C₁₃H₁₈N₄+H]⁺=231.1604; found m/z (ESI)=231.1580. Melting Point: 86-88° C.

### Synthesis of 5-(3,3-difluoroazetidin-1-yl)-1-methyl-1H-pyrrolo[2,3-b]pyridine (42)

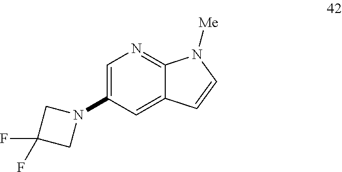

Product 42 was prepared in THF according to the General Procedure described above at 90° C. using 1-methyl-1H-pyrrolo[2,3-b]pyridine (53 mg, 0.25 mmol), 3,3-difluoroazetidine (39 mg, 0.3 mmol), 4.5 mol % [Pd(crotyl)Cl]₂ and 9.0 mol % AshPhos as catalyst. The crude reaction mixture was purified by column chromatography over silica gel using MeOH/DCM as eluent (5:95) to obtain a pure product as a pale-yellow solid, yield 88% (49 mg). [Note: Using 1.0 mol % [Pd(crotyl)Cl]₂ and 2.0 mol % AshPhos as catalyst gave 87% yield]¹H NMR (600 MHz, CDCl₃): δ (in ppm) 7.74 (d, J=2.6 Hz, 1H), 7.14 (d, J=3.4 Hz, 1H), 7.04 (d, J=2.6 Hz, 1H), 6.31 (d, J=3.3 Hz, 1H), 4.24 (t, J=11.7 Hz, 4H), 3.84 (s, 3H). ¹³C{¹H}NMR (151 MHz, CDCl₃): δ (in ppm) 143.6, 141.1, 130.6, 130.1, 120.5, 116.2 (t, J=274.7 Hz), 111.6, 98.2, 64.3 (t, J=25.0 Hz), 31.4. ¹⁹F{¹H}NMR (564 MHz, CDCl₃): δ (in ppm) −98.98. HRMS: Calculated [C₁₁H₁₁F₂N₃+H]⁺=224.0993; found m/z (ESI)=224.0976. Melting Point: 127-129° C.

### Synthesis of 1-(benzo[b]thiophen-5-yl)-4-methylpiperazine (43) (CAS #2097827-53-5)

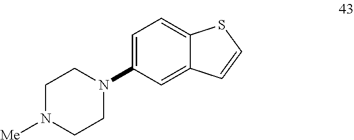

Product 43 was prepared in toluene according to the General Procedure described above at 60° C. using 5-bromobenzo[b]thiophene (53.3 mg, 0.25 mmol), 1-methylpiperazine (34 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (10:90) to obtain a pure product as a pale-yellow solid, yield 94% (55.5 mg). 1H NMR (600 MHz, CDCl₃): δ (in ppm) 7.73 (dd, J=8.8, 0.7 Hz, 1H), 7.39 (d, J=5.4 Hz, 1H), 7.30 (d, J=2.4 Hz, 1H), 7.23 (dd, J=5.4, 0.8 Hz, 1H), 7.08 (dd, J=8.8, 2.4 Hz, 1H), 3.25-3.23 (m, 4H), 2.63-2.61 (m, 4H), 2.37 (s, 3H). ¹³C{¹H}NMR (151 MHz, CDCl₃): δ (in ppm) 149.4, 141.0, 132.1, 127.3, 124.0, 122.9, 116.9, 110.0, 55.5, 50.5, 46.4.

### Synthesis of 2-(4-(benzo[b]thiophen-5-yl)piperazin-1-yl)pyrimidine (44)

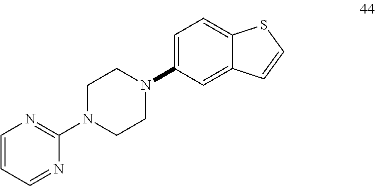

Product 44 was prepared in toluene according to the General Procedure described above at 60° C. using 5-bromobenzo[b]thiophene (53.3 mg, 0.25 mmol), 2-(piperazin-1-yl)pyrimidine (49.3 mg, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (10:90) to obtain a pure product as a white solid, yield 97% (72.1 mg). ¹H NMR (600 MHz, CDCl₃): δ (in ppm) 8.35 (d, J=4.8 Hz, 2H), 7.76 (d, J=8.8 Hz, 1H), 7.41 (d, J=5.4 Hz, 1H), 7.34 (d, J=2.4 Hz, 1H), 7.24 (d, J=5.4 Hz, 1H), 7.13 (dd, J=8.8, 2.4 Hz, 1H), 6.51 (t, J=4.7 Hz, 1H), 4.04-4.02 (m, 4H), 3.27-3.26 (m, 4H). ¹³C{¹H}NMR (151 MHz, CDCl₃): δ (in ppm) 161.6, 157.6, 149.1, 140.6, 132.1, 126.9, 123.6, 122.7, 116.9, 119.9, 50.4, 43.7. HRMS: Calculated [C₁₆H₁₆N₄S+H]⁺=297.1168; found m/z (ESI)=297.1144. Melting Point: 116-119° C.

### Synthesis of 4-(benzo[b]thiophen-5-yl)morpholine (45) (CAS #96803-51-9)

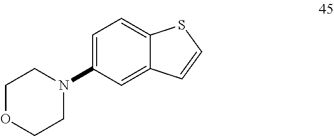

Product 45 was prepared in toluene according to the General Procedure described above at 60° C. using 5-bromobenzo[b]thiophene (53.3 mg, 0.25 mmol), morpholine (25 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (10:90) to obtain a pure product as a white solid, yield 55% (31 mg). ¹H NMR (600 MHz, CDCl₃): δ (in ppm) 7.76 (d, J=8.8 Hz, 1H), 7.42 (d, J=5.4 Hz, 1H), 7.30 (d, J=2.4 Hz, 1H), 7.25 (d, J=5.4 Hz, 1H), 7.07 (dd, J=8.8, 2.4 Hz, 1H), 3.92-3.90 (m, 4H), 3.18-3.20 (m, 4H). ¹³C{¹H}NMR (151 MHz, CDCl₃): δ (in ppm) 149.0, 140.6, 132.0, 127.0, 123.6, 122.7, 116.1, 109.4, 66.9, 50.5. Melting Point: 136-138° C.

### Synthesis of 1-(benzo[b]thiophen-5-yl)-4-methoxypiperidine (46)

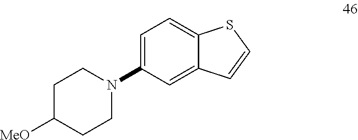

Product 46 was prepared in toluene according to the General Procedure described above at 60° C. using 5-bromobenzo[b]thiophene (53.3 mg, 0.25 mmol), 4-methoxypiperidine (38 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (10:90) to obtain a pure product as a white solid, yield 95% (59.1 mg). ¹H NMR (600 MHz, CDCl₃): δ (in ppm) 7.73 (d, J=8.8 Hz, 1H), 7.39 (d, J=5.4 Hz, 1H), 7.32 (d, J=2.5 Hz, 1H), 7.23 (d, J=5.4 Hz, 1H), 7.11 (dd, J=8.9, 2.4 Hz, 1H), 3.55-3.51 (m, 2H), 3.4 (s, 3H), 2.97-2.93 (m, 2H), 2.07-2.05 (m, 2H), 1.80-1.75 (m, 2H). ¹³C{¹H}NMR (151 MHz, CDCl₃): δ (in ppm) 149.4, 140.8, 131.7, 126.9, 123.8, 122.7, 117.3, 110.3, 76.2, 55.7, 48.6, 30.9. HRMS: Calculated [C₁₄H₁₇NOS+H]⁺=248.1103; found m/z (ESI)=248.1084. Melting Point: 63-65° C.

### Synthesis of 5-(3,3-difluoropyrrolidin-1-yl)-1-methyl-1H-indazole (47)

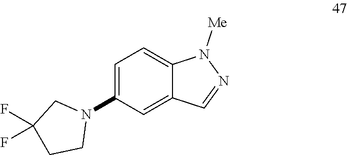

Product 47 was prepared in THF according to the General Procedure described above at 90° C. using 5-bromo-1-methyl-1H-indazole (52.8 mg, 0.25 mmol), 3,3-difluoropyrrolidine (43.2 mg, 0.3 mmol), 3.0 mol % [Pd(crotyl)Cl]₂ and 6.0 mol % AshPhos as catalyst. The crude reaction mixture was purified by column chromatography over silica gel using MeOH/DCM as eluent (5:95) to obtain a pure product as a yellow solid, yield 93% (55.7 mg). [Note: Using 1.0 mol % [Pd(crotyl)Cl]₂ and 2.0 mol % AshPhos as catalyst gave 63% yield] ¹H NMR (500 MHz, CDCl₃): δ (in ppm) 7.84 (d, J=1.0 Hz, 1H), 7.30 (d, J=9.0 Hz, 1H), 6.86 (dd, J=9.1, 2.3 Hz, 1H), 6.73 (d, J=2.2 Hz, 1H), 4.02 (s, 3H), 3.69 (t, J=13.4 Hz, 2H), 3.52 (t, J=7.1 Hz, 2H), 2.54-2.46 (m, 2H). ¹³C{¹H}NMR (126 MHz, CDCl₃): δ (in ppm) 142.0, 134.8, 131.2, 128.4, 124.8, 115.3, 109.6, 100.4, 56.9 (t, J=31.1 Hz), 46.8 (t, J=3.3 Hz), 35.7, 34.8 (t, J=24.1 Hz). HRMS: Calculated [C₁₂H₁₃F₂N₃+H]⁺=238.1150; found m/z (ESI)=238.1127. Melting Point: 118-120° C.

### Synthesis of 4-methoxy-1-(I-methyl-1H-pyrazol-3-yl)piperidine (48)

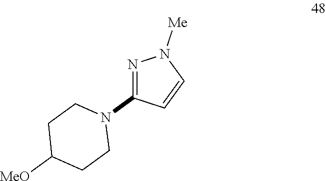

Product 48 was prepared in THF according to the General Procedure described above at 70° C. using 3-bromo-1-methyl-1H-pyrazole (40.25 mg, 25.8 μL, 0.25 mmol), 4-methoxypiperidine (38 μL, 0.3 mmol), 5.0 mol % [Pd(crotyl)Cl]₂ and 10.0 mol % AshPhos as catalyst. The crude reaction mixture was purified by column chromatography over silica gel using EtOAc/Hexane as eluent (80:20) to obtain a pure product as a yellow viscous liquid, yield 80% (32 mg). ¹H NMR (500 MHz, CDCl₃): δ (in ppm) 7.12 (d, J=2.3 Hz, 1H), 5.61 (d, J=2.3 Hz, 1H), 3.72 (s, 3H), 3.56-3.52 (m, 2H), 3.36 (s, 3H), 3.33-3.28 (m, 1H), 2.88-2.83 (m, 2H), 1.99-1.95 (m, 2H), 1.68-1.61 (m, 2H). ¹³C{¹H}NMR (126 MHz, CDCl₃): δ (in ppm) 159.9, 131.1, 91.6, 55.6, 46.5, 38.8, 30.4. HRMS: Calculated [C₁₀H₁₇N₃O+H]⁺=196.1444; found m/z (ESI)=196.1422.

### Synthesis of 3-(3,3-difluoropyrrolidin-1-yl)-1-methyl-1H-pyrazole (49)

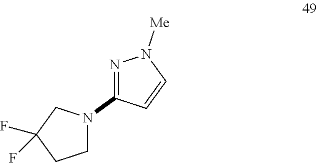

Product 49 was prepared in THF according to the General Procedure described above at 70° C. using 3-bromo-1-methyl-1H-pyrazole (40.25 mg, 25.8 μL, 0.25 mmol), 3,3-difluoropyrrolidine (43 mg, 0.3 mmol), 5.0 mol % [Pd(crotyl)Cl]₂ and 10.0 mol % AshPhos as catalyst. The crude reaction mixture was purified by column chromatography over silica gel using MeOH/DCM as eluent (5:95) to obtain a pure product as brown semisolid/waxy, yield 74% (34 mg). ¹H NMR (600 MHz, CDCl₃): δ (in ppm) 7.15 (t, J=2.1 Hz, 1H), 5.50 (t, J=2.1 Hz, 1H), 3.75 (d, J=1.7 Hz, 3H), 3.6 (t, 2H), 3.4 (t, 2H), 2.45-2.39 (m, 2H). ¹³C{¹H}NMR (151 MHz, CDCl₃): δ (in ppm) 157.0, 131.3, 90.4, 56.6 (t, J=31.1 Hz), 47 (t, J=3.5 Hz), 34.9 (t, J=24.3 Hz), 29.7. HRMS: Calculated [C₈H₁₁F₂N₃+H]⁺=188.0993; found m/z (ESI)=188.0972.

### Synthesis of 4-(4-(trifluoromethyl)thiazol-2-yl)morpholine (50) (CAS #265107-02-6)

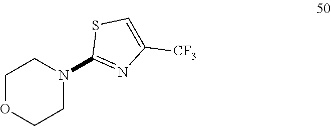

Product 50 was prepared in toluene according to the General Procedure described above at 60° C. using 2-bromo-4-(trifluoromethyl)thiazole (58.00 mg, 30.46 μL, 0.25 mmol), morpholine (26 μL, 0.3 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as a yellow viscous liquid, yield 72% (45.1 mg). ¹H NMR (600 MHz, CDCl₃): δ (in ppm) 7.0 (s, 1H), 3.81-3.79 (m, 4H), 3.5-3.48 (m, 4H). ¹³C{¹H}NMR (151 MHz, CDCl₃): δ (in ppm) 172.3, 141.2, 120.2, 108.9, 65.9, 48.3. ¹⁹F{¹H}NMR (564 MHz, CDCl₃): δ (in ppm) −65.35.

### Synthesis of 4-(4-(pyrimidin-2-yl)piperazin-1-yl)thiazole (51)

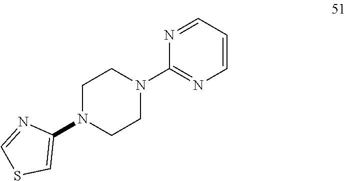

Product 51 was prepared in THF according to the General Procedure described above at 90° C. using 4-bromothiazole (82.01 mg, 45 μL, 0.5 mmol), 2-(piperazin-1-yl)pyrimidine (99 mg, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as yellow solid, yield 84% (104 mg). ¹H NMR (600 MHz, CDCl₃): δ (in ppm) 8.61 (d, J=2.1 Hz, 1H), 8.31 (d, J=4.8 Hz, 2H), 6.50 (t, J=4.7 Hz, 1H), 5.98 (d, J=2.2 Hz, 1H), 3.98 (t, J=5.3 Hz, 4H), 3.42-3.31 (m, 4H). ¹³C{¹H}NMR (151 MHz, CDCl₃): δ (in ppm) 162.87, 161.84, 157.87, 151.38, 110.25, 90.39, 48.81, 43.39. HRMS: Calculated [C₁₁H₁₃N₅S+H]⁺=248.0946; found m/z (ESI)=248.096. Melting Point: 122-126° C.

### Synthesis of 4-(4-((4-chlorophenyl)(phenyl)methyl)piperazin-1-yl)thiazole (52)

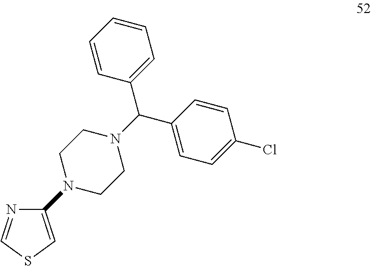

Product 52 was prepared in THF according to the General Procedure described above at 90° C. using 4-bromothiazole (82.01 mg, 45 μL, 0.5 mmol), 1-((4-chlorophenyl)(phenyl)methyl)piperazine (173 mg, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (30:70) to obtain a pure product as pale yellow liquid, yield 79% (148 mg). ¹H NMR (600 MHz, CDCl₃): δ (in ppm) 8.59 (d, J=2.2 Hz, 1H), 7.41 (td, J=7.6, 1.8 Hz, 4H), 7.30 (t, J=7.7 Hz, 2H), 7.28-7.25 (m, 2H), 7.23-7.19 (m, 1H), 5.91 (d, J=2.2 Hz, 1H), 4.27 (s, 1H), 3.33 (t, J=5.1 Hz, 4H), 2.60-2.50 (m, 4H).

### Synthesis of ethyl 4-(8-chloro-3-(4-(pyrimidin-2-yl)piperazin-1-yl)-5,6-dihydro-11H-benzo[5,6]cyclohepta[1,2-b]pyridin-11-ylidene)piperidine-1-carboxylate (53)

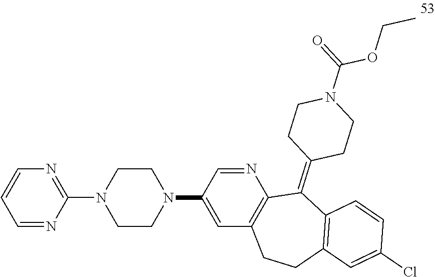

Product 53 was prepared in THF according to the General Procedure described above 2 at 60° C. using ethyl 4-(3-bromo-8-chloro-5,6-dihydro-11H-benzo[5,6]cyclo-hepta[1,2-b]pyridin-11-ylidene)piperidine-1-carboxylate, 2-(piperazin-1-yl)pyrimidine, 5.0 mol % [Pd(crotyl)Cl]₂ and 10.0 mol % AshPhos as catalyst. The crude reaction mixture was purified by column chromatography over silica gel using EtOAc/Hexane as eluent (80:20) to obtain a pure product as a white solid, yield 51% (31 mg). [Note: Product was lost during the process of purification.]¹H NMR (600 MHz, Acetone): δ (in ppm) 8.36-8.32 (m, 2H), 8.19-8.15 (m, 1H), 7.21-7.08 (m, 4H), 6.61-6.55 (m, 1H), 4.05 (d, J=7.1 Hz, 2H), 3.96-3.91 (m, 4H), 3.70-3.61 (m, 2H), 3.35-3.48 (m, 1H), 3.29-3.21 (m, 4H), 2.81 (s, 4H), 2.50-2.43 (m, 1H), 2.35-2.28 (m, 2H), 2.25-2.19 (m, 1H), 2.05-2.02 (m, 1H), 1.17 (t, J=7.1 Hz, 3H). ¹³C NMR (151 MHz, Acetone): δ (in ppm) 162.8, 158.8, 155.9, 149.2, 147.1, 146.9, 141.8, 139.4, 136.4, 136.2, 136.1, 134.3, 134.1, 132.9, 131.3, 129.6, 129.6, 129.5, 128.0, 126.7, 124.9, 124.8, 111.2, 61.6, 61.6, 49.3, 49.2, 49.2, 45.9, 44.3, 44.3, 34.9, 33.2, 32.8, 32.4, 32.2, 30.7, 30.5, 23.1, 15.2, 15.1, 14.4. HRMS: Calculated [C₃₀H₃₅ClN₆O₃—C₃H₅O₂]⁺=491.2248; found m/z (ESI)=491.1361.

### Synthesis of 3,3-difluoro-1-(thiophen-2-yl)azetidine (54)

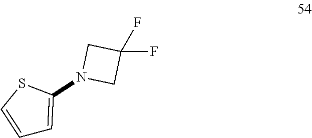

Product 54 was prepared in THF according to the General Procedure described above at 70° C. using 2-chlorothiophene (59 mg, 46.3 μL, 0.5 mmol), 3,3-difluoroazetidine (78 mg, 0.6 mmol), 1.0 mol % [Pd(crotyl)Cl]₂ and 2.0 mol % AshPhos as catalyst. The crude reaction mixture was analyzed using GC-MS wrt 2-chlorothiophene, yield 72%.

### Synthesis of 3-(3,3-difluoropyrrolidin-1-yl)pyridine (55)

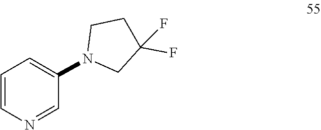

Product 55 was prepared in THF according to the General Procedure described above at 70° C. using 3-chloropyridine (56.77 mg, 48 μL, 0.5 mmol), 3,3-difluoropyrrolidine (86.4 mg, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (25:75) to obtain a pure product as pale yellow liquid, yield 88% (83 mg). ¹H NMR (600 MHz, CDCl₃): δ (in ppm) 8.00 (dd, J=4.7, 1.4 Hz, 1H), 7.93 (d, J=3.1 Hz, 1H), 7.18-7.06 (m, 1H), 6.77 (dd, J=8.4, 3.1 Hz, 1H), 3.62 (t, J=13.1 Hz, 2H), 3.48 (t, J=7.2 Hz, 2H), 2.45 (m, 2H).

### Synthesis of 6-(4-methoxypiperidin-1-yl)nicotinonitrile (56) (CAS #1096303-36-4)

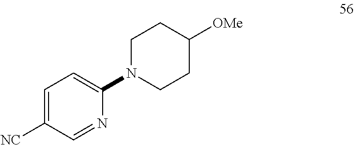

Product 56 was prepared in THF according to the General Procedure described above at 70° C. using 6-chloronicotinonitrile (69.5 mg, 0.5 mmol), 4-methoxypiperidine (76 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as colorless oil, yield 86.4% (95 mg). ¹H NMR (600 MHz, CDCl₃): δ (in ppm) 8.33 (d, J=2.6 Hz, 1H), 7.52 (dd, J=9.1, 2.4 Hz, 1H), 6.60-6.53 (m, 1H), 3.92 (ddd, J=13.6, 7.2, 3.8 Hz, 2H), 3.45 (dt, J=7.6, 3.9 Hz, 1H), 3.43-3.36 (m, 2H), 3.33 (s, 3H), 1.92-1.84 (m, 2H), 1.59 (dt, J=13.1, 4.3 Hz, 2H).

### Synthesis of 6-(4-(pyrimidin-2-yl)piperazin-1-yl)nicotinonitrile (57) (CAS #941384-06-1)

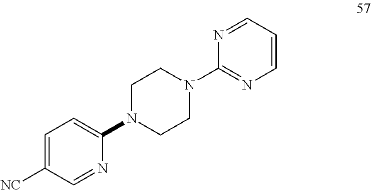

Product 57 was prepared in THF according to the General Procedure described above at 70° C. using 6-chloronicotinonitrile (69.5 mg, 0.5 mmol), 2-(piperazin-1-yl)pyrimidine (99 mg, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (30:70) to obtain a pure product as white solid, yield 78% (105 mg). ¹H NMR (600 MHz, CDCl₃): δ (in ppm) 8.47-8.40 (m, 1H), 8.35 (dd, J=4.7, 1.0 Hz, 2H), 7.68-7.59 (m, 1H), 6.64 (d, J=9.1 Hz, 1H), 6.55 (dd, J=5.2, 4.3 Hz, 1H), 4.00-3.92 (m, 4H), 3.79 (dd, J=6.6, 4.2 Hz, 4H).

### Synthesis of 4-(pyrazin-2-yl)morpholine (58) (CAS #5625-94-5)

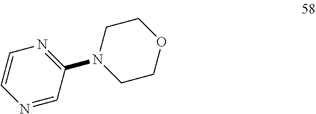

Product 58 was prepared in THF according to the General Procedure described above at 90° C. using 2-chloropyrazine (48 μL, 0.5 mmol), morpholine (52 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (25:75) to obtain a pure product as pale yellow liquid, yield 93% (71 mg). ¹H NMR (600 MHz, CDCl₃): δ (in ppm) 7.51 (d, J=1.7 Hz, 1H), 7.45 (d, J=1.1 Hz, 1H), 7.26 (d, J=2.7 Hz, 1H), 3.27-3.14 (m, 4H), 2.97-2.90 (m, 4H).

### Synthesis of 2-(3,3-difluoropyrrolidin-1-yl)pyrazine (59) (CAS #1863348-16-6)

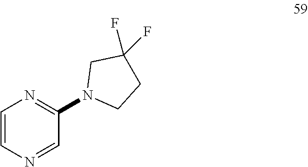

Product 59 was prepared in THF according to the General Procedure described above at 90° C. using 2-chloropyrazine (48 μL, 0.5 mmol), 3,3-difluoropyrrolidine (86.1 mg, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (30:70) to obtain a pure product as orange solid, yield 86% (80 mg). ¹H NMR (600 MHz, CDCl₃): δ (in ppm) 8.02 (s, 1H), 7.85 (s, 2H), 3.82 (t, J=13.0 Hz, 2H), 3.69 (t, J=7.3 Hz, 2H), 2.48 (tt, J=13.8, 7.3 Hz, 2H).

### Synthesis of N-(tert-butyl)pyrazin-2-amine (60) (CAS #282102-88-9)

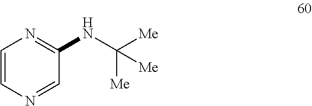

Product 60 was prepared in THF according to the General Procedure described above at 90° C. using 2-chloropyrazine (48 μL, 0.5 mmol), 2-methylpropan-2-amine (64 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (20:80) to obtain a pure product as pale yellow liquid, yield 91% (69 mg). ¹H NMR (600 MHz, CDCl₃): δ (in ppm) 7.92 (dd, J=2.9, 1.6 Hz, 1H), 7.81 (d, J=1.6 Hz, 1H), 7.70 (d, J=2.8 Hz, 1H), 4.58 (s, 1H), 1.42 (s, 10H).

### Synthesis of ethyl 4-(8-(tert-butylamino)-5,6-dihydro-11H-benzo[5,6]-cyclohepta[1,2-b]pyridin-11-ylidene)piperidine-1-carboxylate (61)

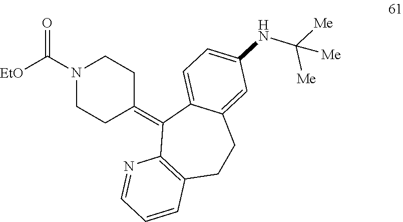

Product 61 was prepared in THF according to the General Procedure described above at 90° C. using Loratadine (Ambeed, A188364-008) (96 mg, 0.5 mmol), 2-methylpropan-2-amine (64 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (80:20) to obtain a pure product as bright pink solid, yield 77% (81 mg). ¹H NMR (600 MHz, CDCl₃): δ (in ppm) 8.35 (dd, J=4.9, 1.7 Hz, 1H), 7.40 (dd, J=7.7, 1.7 Hz, 1H), 7.03 (dd, J=7.6, 4.8 Hz, 1H), 6.94 (d, J=8.2 Hz, 1H), 6.53 (dd, J=8.3, 2.5 Hz, 1H), 6.48 (d, J=2.5 Hz, 1H), 4.11 (q, J=7.3 Hz, 2H), 3.80 (d, J=15.9 Hz, 2H), 3.35-3.27 (m, 2H), 3.15-3.03 (m, 2H), 2.75 (m, 2H), 2.49-2.20 (m, 4H), 1.30 (s, 9H), 1.22 (t, J=7.0 Hz, 3H). ¹³C{¹H}NMR (151 MHz, CDCl₃): δ (in ppm) 159.09, 155.81, 146.64, 146.37, 138.26, 137.16, 135.81, 135.53, 134.13, 130.50, 122.09, 117.54, 114.60, 61.48, 51.54, 45.26, 45.15, 32.70, 31.86, 30.95, 30.83, 30.36, 30.31, 14.97, 14.47. HRMS: Calculated [C₂₆H₃₃N₃O₂+H]⁺=420.2573; found m/z (ESI)=420.2638. Melting Point: 169-173° C.

### Synthesis of ethyl 4-(8-(4-methoxypiperidin-1-yl)-5,6-dihydro-11H-benzo[5,6]cyclohepta[1,2-b]pyridin-11-ylidene)piperidine-1-carboxylate (62)

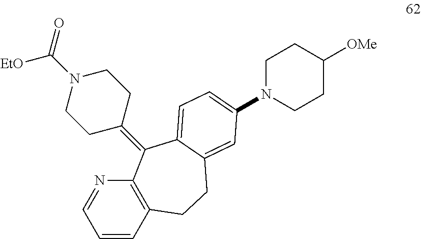

Product 62 was prepared in THF according to the General Procedure described above at 90° C. using Loratadine (Ambeed, A188364-008) (96 mg, 0.5 mmol), 4-methoxypiperidine (76 μL, 0.6 mmol), 1.0 mol % [Pd(crotyl)Cl]₂ and 2.0 mol % AshPhos as catalyst. The crude reaction mixture was purified by column chromatography over silica gel using EtOAc/Hexane as eluent (80:20) to obtain a pure product as pale yellow liquid, yield 84% (97 mg). ¹H NMR (600 MHz, CDCl₃): δ (in ppm) 8.34 (d, J=4.8 Hz, 1H), 7.40 (d, J=7.8 Hz, 1H), 7.06-6.98 (m, 2H), 6.75-6.65 (m, 2H), 4.13-4.08 (m, 2H), 3.78 (s, 2H), 3.46 (m, 2H), 3.35-3.28 (m, 6H), 3.08 (m, 2H), 2.86 (m, 2H), 2.77 (m, 2H), 2.39 (m, 3H), 2.30-2.21 (m, 1H), 2.00-1.92 (m, 2H), 1.65 (m, 2H), 1.22 (t, J=7.0 Hz, 3H). ¹³C{¹H}NMR (151 MHz, CDCl₃): δ (in ppm) 158.34, 155.34, 150.34, 146.23, 137.94, 136.82, 135.72, 134.93, 133.58, 130.12, 129.66, 121.71, 116.57, 113.74, 61.04, 60.18, 55.37, 46.95, 46.87, 46.81, 44.78, 44.69, 32.37, 31.44, 30.48, 20.86, 14.52, 14.02. HRMS: Calculated [C₂₈H₃₅N₃O₃+H]⁺=462.275; found m/z (ESI)=462.2744.

### Gram-Scale Synthesis of Product 62

Product 62 was also prepared via a gram scale synthesis based on the General Procedure described above at 90° C. using Loratadine (Ambeed, A188364-008, 1.914 g, 5 mmol), 4-methoxy piperidine (0.75 mL, 6.0 mmol), 0.1 mol % [Pd(crotyl)Cl]₂, and 0.2 mol % AshPhos as a catalyst. After 6 hours, TLC indicated complete consumption of starting material and the reaction mixture was quenched with 5-10 mL EtOAc and passed through a plug of celite. Volatiles were removed under reduced pressure. The resulting reaction mixture was directly loaded on a flash silica column (40 g Silica gel Flash Column CV 30-40 mL/min) using the minimum amount of dichloromethane (5 mL). The crude reaction mixture was purified by using EtOAc/Hexane as eluent (80:20) to obtain a pure product as pale yellow liquid, yield 81% (1.63 g).

### Discussion

In the optimization of reaction conditions for catalytic amination, thiophenyl bromide 4 and tert-butylamine 5 were used as coupling partners. Table 2, below, summarizes findings from the optimization studies. In reactions run on a 0.5 mmol scale, one reaction parameter (i.e., Pd source identity, base identity, solvent identity, Pd loading amount, reaction temperature and reaction time) at a time was varied. [Pd(crotyl)Cl]2 proved to be the optimal palladium source, while sodium tert-butoxide served as the preferred base, and THF (tetrahydrofuran) was the optimal solvent. Under these optimized conditions, the coupling product 6 was obtained with a 90% yield (Table 2, entry 1). Substituting [Pd(crotyl)Cl]2 with Pd(OAc)₂, for example, resulted in a lower yield of 6 (38%, Table 2, entry 2). Similarly, Pd₂dba₃ provided only 70% yield (Table 2, entry 3), likely due to competition between dba (dibenzylideneacetone) and ligand. Other palladium sources, such as [Pd(allyl)Cl]₂ and Pd(cod)Cl₂, yielded inferior results for this transformation. The choice of cation in the base significantly impacted catalytic efficiency. Using potassium tert-butoxide as the base led to a yield of only 35% for 6 (Table 2, entry 4), likely due to its lower solubility than sodium tert-butoxide (25 g/100 g THF vs. 32 g/100 g THF; Beletskaya et al, 1999; Park et al., 2015) or the counterion effect. Comparatively weak bases like cesium carbonate, potassium hydroxide, triethylamine, and diisopropylethylamine were ineffective (Table 2, entry 5). Maintaining a 1:1 ratio of palladium to ligand was optimal; reducing the palladium loading to 1 mol % resulted in only a 25% yield of 6 (Table 2, entry 6). The catalytic reaction also demonstrated effectiveness in toluene, yielding 81% product, though it was less effective than in THF (Table 2, entry 7). Tert-butanol and ethanol proved to be ineffective solvents, with no product formation detected in these cases (Table 2, entry 8). Only 56% of the product was obtained in methyl-tert-butyl ether (MTBE) (Table 2, entry 9). A reaction temperature of 70° C. was optimal; at room temperature (rt), only an 8% yield of 6 was obtained (Table 2, entry 10). Interestingly, the reactions were almost completed within 2 hours, yielding 770 of 6 (Table 2, entry 11), while extending the reaction time to 16 hours resulted in 87% yield (Table 2, entry 12). Without being bound to any one theory, this suggests either catalyst decomposition during the reaction or the formation of less active ligated palladium aggregates. The addition of sodium bromide as an additive decreased the yield due to interference with the base's optimal solubility (Table 2, entry 13).

TABLE 2
Summary of Optimization Studies.

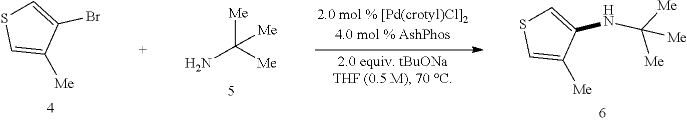

| Entry | Conditions | Conv^{b} |
|---|---|---|
| 1 | No deviation | 90^{c} |
| 2 | 2 mol % Pd(OAc)₂ instead of [Pd(crotyl)Cl]₂ | 38 |
| 3 | 2 mol % Pd₂dba₃ instead of [Pd(crotyl)Cl]₂ | 70 |
| 4 | t-BuOK instead of t-BuONa | 35 |
| 5 | KOH or Cs₂CO₃ or Et₃N or i-PrNET₂ instead of t-BuONa | 0 |
| 6 | 1 mol % [Pd(crotyl)Cl]₂ instead of 2 mol % | 25 |
| 7 | Toluene instead of THE | 81 |
| 8 | t-BuOH or EtOH instead of THF | 0 |
| 9 | MTBE instead of THF | 56 |
| 10 | Reaction temperature rt instead of 70 °C. | 8 |
| 11 | Reaction time 2 h instead of 26 h | 77 |
| 12 | Reaction time 16 h instead of 26 h | 87^{c} |
| 13 | 1.0 equiv. NaBr as an additive | 50 |

Conditions: 4 (0.5 mmol), 5 (0.6 mmol), Pd(crotyl)Cl]₂, tBuONa (2.0 equiv.), 1 mL THF, 70 °C, 26 h.
^{b}Conversion to 6 based on GC-MS using mesitylene (0.5 mmol) as an internal standard.
^{c}Isolated yield.

Following the optimized conditions, the substrate scope was expanded to include the coupling of heteroaryl bromides with α-branched secondary amines, such as indoline and 2-methylpiperidine. See FIG. 4, products 7-18. Notably, only 1 mol % [Pd(crotyl)Cl]₂ and 2 mol % AshPhos were needed for preparing most of these compounds. Bromobenzothiophene was effectively coupled with both indoline and 2-methylpiperidine, affording excellent yields (7, 8). Interestingly, despite the strong binding affinity of 2-methylpiperidine to palladium, it did not adversely affect catalytic activity. In all cases where 2-methylpiperidine was used as a nucleophile, the desired coupling products were obtained in good-to-excellent yields (8, 9, 11, 13, 15, 18). Electrophiles containing pyrimidine (9, 10) and benzopyrazole (15, 16) were also successfully coupled with both indoline and 2-methylpiperidine. Notably, the more challenging thiazole and pyrazole bromides reacted favorably with the amines, resulting in product yields of 93% and 84%, respectively (17, 18).

Various heteroaryl bromides were also coupled with tert-butylamine. See FIG. 4, products 19-24. In these examples, depending upon the choice of electrophile, 1-3 mol % of [Pd(crotyl)Cl]₂ and 2-6 mol % of AshPhos loading was used, as lower loadings resulted in low conversions in some cases. Nitrogen-containing heterocycles demonstrated good-to-excellent yields. See FIG. 4, products 19-21, 23, and 24. Pyridines with electron-donating or -releasing substituents at the 2- or 4-position effectively coupled with tert-butylamine, providing good yields (19, 20). Electrophiles containing pyrimidine (21), benzothiophene (22), and quinoline (23) provided excellent yields. Similarly, electrophiles featuring benzopyrazole rings also coupled well with tert-butylamine (24).

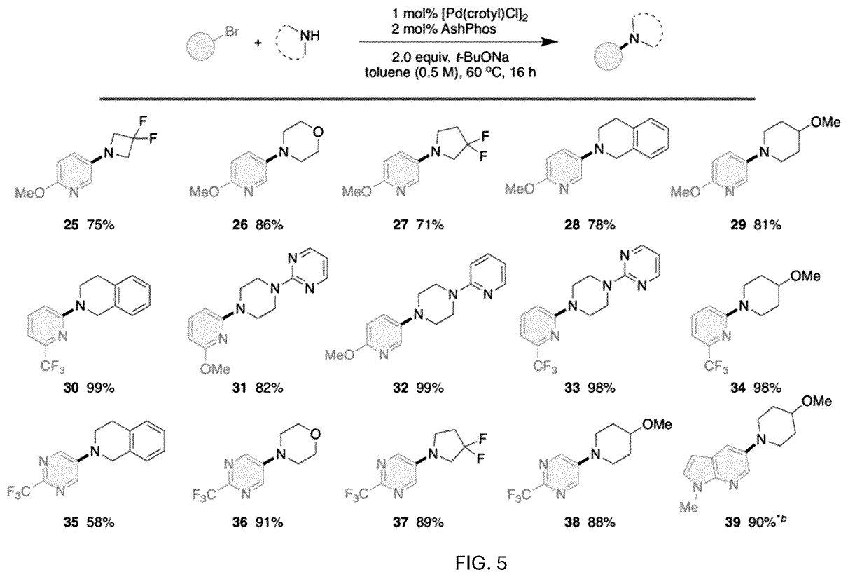

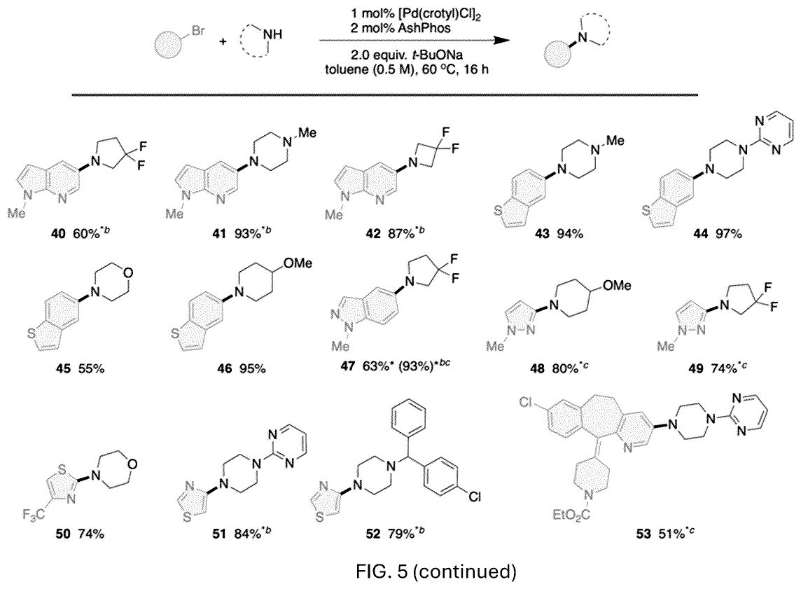

After confirming the generality observed in the reactions in FIG. 4, it became evident that the newly designed ligand is highly effective for coupling challenging heteroaryl bromides with amines. The substrate scope was further expanded to include more functionally diverse coupling partners, with a focus on chelating secondary cycloalkyl amines containing multiple heteroatoms. See FIG. 5, products 25-53. Substituted pyridines successfully coupled with various amines, such as difluorinated azetidine (25), morpholine (26), difluorinated pyrrolidine (27), tetrahydroisoquinoline (28, 30), and 4-methoxypiperidine (29, 34), achieving good-to-excellent yields. Notably, secondary amines with multiple nitrogen atoms, such as 1-(pyridine-2-yl)piperazine (31, 32) and 2-(piperazine-1-yl)pyrimidine (33, 44), participated effectively in the catalytic reactions, highlighting the strong binding of AshPhos with palladium. Without this robust interaction, these highly chelating amines could have adversely affected catalytic activity. The reactivity trend for coupling pyrimidine bromides was excellent, as demonstrated by products 35-38. Additionally, more chelating heterocycles, such as pyrrolopyridine, were well-tolerated as electrophiles, resulting in excellent yields (39-42). Remarkably, even for product 41, where both coupling partners exhibited high binding affinity with palladium, excellent reactivity was observed. Benzothiophene heterocycles, serving as electrophiles, were also effectively coupled with various nitrogen-enriched secondary cycloalkylamines (43-46). Notably, excellent yields were achieved even when the nucleophile contained four nitrogen atoms, as seen in example 44. However, the reaction yield was moderate when bromobenzothiophene was coupled with morpholine (45). Electrophiles containing benzopyrazole (47), pyrazole (48, 49), and thiazole (50) were also well-tolerated across a variety of amines, yielding good-to-excellent products. The thiazole electrophile, where the more acidic proton (located on the carbon between the sulfur and nitrogen atoms) is available for side reactions, reacted exclusively in the desired cross-coupling reaction for products 51 and 52. Notably, the most acidic methynic proton in product 52 remained intact and did not interfere with the desired reactivity. Interestingly, an electrophile from Merck's Informer Library successfully coupled with amines possessing four nitrogen atoms (53). The moderate yield in this case was attributed to product loss during purification. Finally, examples involving strained cyclic amines (25, 42), such as azetidine, coupled smoothly without decomposition of the strained ring. For all products except 48, 49, and 53, 1 mol % [Pd] and 2 mol % AshPhos were required, which may be considered reasonable given the complexity of the substrates.

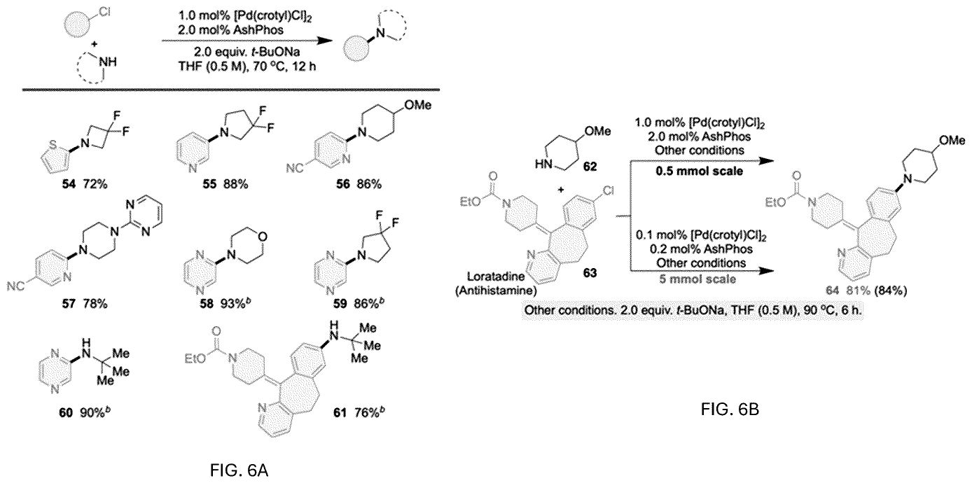

The efficiency of this catalytic approach was further tested using heteroaryl chlorides, as the oxidative addition of these substrates is more challenging than that of the corresponding heteroaryl bromides. As demonstrated in FIG. 6A, heteroaryl chlorides of thiophene, pyridine, and pyrazine (54-61) participated well in the desired reaction pathway, yielding good-to-excellent products. In all these cases, 1 mol % [Pd(crotyl)Cl]₂ and 2 mol % AshPhos were required. The pyridyl-containing nitrile functional group demonstrated favorable reactivity, yielding 86% of 56 and 78% of 57, the latter of which contains six nitrogen atoms. Both secondary alkyl amines (for products 54-59) and hindered tert-butyl amines (for products 60, 61) proved effective in the catalytic process. In the preparation of product 61, transesterification was not observed when the reactions were performed using t-BuONa. It is noteworthy that this example involved an electrophile sourced from Merck's Informer Library.

Furthermore, the scalability of the present catalytic approach was tested using an electrophile from the Merck Informer Library. See FIG. 6B. Initially, the reaction was tested on a 0.5 mmol scale under standard conditions, where heteroaryl chloride 63 and amine 62 were subjected to the reaction conditions, yielding 84% of product 64. Interestingly, when the reaction was scaled up to 5 mmol using the same coupling partners but with lower catalyst loading (0.1 mol % [Pd(crotyl)Cl]2 and 0.2 mol % AshPhos), 81% of product 64 was obtained. This yield was comparable to that of the small-scale reaction, despite the catalyst loading being ten times lower.

### Example 3

### Mechanistic Studies and Ligand Comparison

### Investigation of Off Cycle at Variable Temperature

A model substrate 3-bromo-1-methyl-1H-pyrazole 66 was selected for use in studies to explore the mechanism behind catalyst activation and deactivation. These reactions were performed according to the General Procedure described in Example 2.

In an oven-dried 8 mL reaction vial containing a Teflon-coated magnetic stir bar, 1.0 equiv. NaOt-Bu base was added under an nitrogen atmosphere. The reaction vial was closed with a rubber septum. The reaction mixture was evacuated and backfilled with nitrogen three times. 3-Bromo-1-methyl-1H-pyrazole (66) and 2-methylpiperidine (67) were added to the reaction vial. 0.3 mL anhydrous THF was added to the reaction mixture. A stock solution of [Pd(crotyl)Cl]₂ and AshPhos 0.2 mL was added to the reaction mixture. This way, a set of three different reactions, labeled as reaction 1, 2, and 3, was set up at the same time. The reaction was stirred at 70° C. for 16 h, while reaction 2 was stirred at rt for 16 h. The reaction 3 was stirred at rt for 1 h.

After 1 h, reaction 3 was quenched with 0.5 mL EtOAc, and the vial was opened and solvents were evaporated. The crude mixture was analyzed by ³¹P NMR spectroscopy. In the ³¹P NMR observation, maximum catalyst deactivation was observed as the free phosphine ligand, AshPhos, was detected. Likewise, reaction 2 was quenched, processed, and analyzed after 16, which also showed maximum catalyst deactivation. Reaction 1 was quenched, processed, and analyzed after 16 h. Compared to the catalyst deactivation at rt, very less free ligand was observed that indicated insignificant catalyst deactivation at 90° C.

### Ligand Comparison

To compare the performance of different phosphine Pd ligands, amination reactions were performed with 4-bromothiazole 65 or 3-bromo-N-methylpyrazole 66 as the heteroaryl halide substrate and 2-methylpiperidine 67 as the amine in the presence of 5.0 mol % [Pd(crotyl)Cl]₂, 10.0 mol % phosphine ligand (AshPhos or EPhos) and sodium tert-butoxide (2.0 equiv.) in THF at 50 or 90° C. for 12 hours.

### Discussion

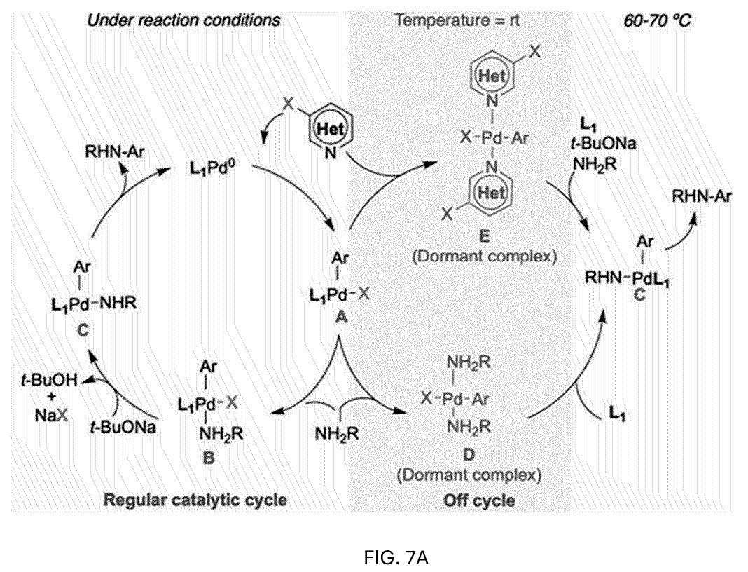

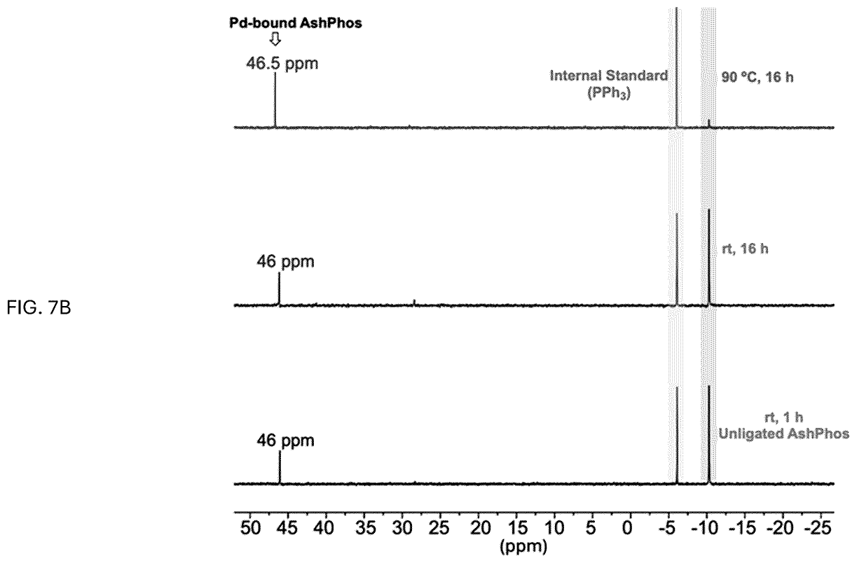

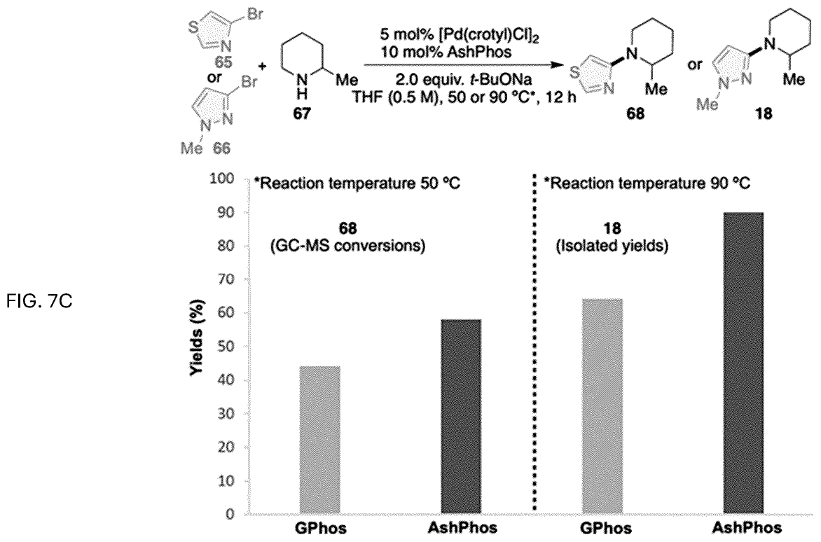

The use of elevated reaction temperatures was further explored by studying the formation of off-cycle palladium species that release the AshPhos ligand, rendering the palladium species catalytically dormant. As shown in FIG. 7A, after the oxidative addition of heteroaryl bromide, an intermediate A can proceed to the desired catalytic cycle through amine binding, deprotonation, and reductive elimination, forming intermediates B and C, respectively. Simultaneously, it is proposed that an excess of heteroaryl bromide and nucleophilic amine compared to the catalytic palladium species can lead to the binding of amine nucleophile and heteroaryl bromide via nitrogen atoms, resulting in the catalytically dormant species D and E. However, this binding is less favorable at elevated temperatures that facilitate a normal catalytic cycle. At room temperature, the formation of D and E is anticipated.

To verify this hypothesis, a control study was conducted using ³¹P NMR. See FIG. 7B. Initially, when the reaction between heteroaryl bromide 66 and amine 67 was performed at rt under the conditions described in FIG. 7C, slight formation of the oxidative addition complex was observed at 46 ppm, while the majority of free AshPhos ligand was detected as indicated by the ³¹P signal at −10.2 ppm. After running the same reaction at rt for 16 hours, no significant changes in the ³¹P NMR were observed, supporting the idea that off-cycle species readily form at rt, even though oxidative addition is also possible, no transmetallation was observed in the analysis. The formation of catalytically dormant species hinders productive transmetallation and reductive elimination. However, when the reaction mixture was heated to 90° C. for 16 hours, predominantly the oxidative addition-transmetallated complex was observed, as revealed by the appearance of ³¹P signal at 46.5 ppm. Ca. 90% product formation was also observed in the same reaction mixture. Notably, when the reaction mixture was initially stirred at rt for 1 hour and then stirred at 90° C. for the next 15 hours, the dormant species were converted to catalytically active species, as evidenced by a significant ³¹P signal at 46.5 ppm. These control experiments indicate that use of an elevated reaction temperature can prevent the formation of catalytically dormant palladium species.

Next, the activity of AshPhos and the state-of-the-art GPhos in two different reactions was compared. See FIG. 7C. AshPhos outperformed in these examples using only inexpensive sodium tert-butoxide base and THF solvent. For instance, in a reaction between heteroaryl bromide 65 and amine 67, GPhos yielded 45% of product 68, while AshPhos achieved a 60% yield of the same product. Similarly, coupling between 66 and 67 resulted in a 65% yield of product 18 with GPhos, whereas AshPhos provided an impressive 90% isolated yield of product 18.

According, based on the results of Examples 1-3, the development of the AshPhos ligand represents a significant advancement in the field of Buchwald-Hartwig amination. Derived from cost-effective and readily available starting materials, AshPhos addresses the limitations of existing ligands by offering enhanced catalytic performance, particularly for challenging substrates. Its design emphasizes chelation and cooperativity, leading to improved turnover rates and selectivity. The successful synthesis and characterization of AshPhos, along with its demonstrated efficacy in catalytic amination reactions, highlight its potential for scalable and sustainable applications in synthetic chemistry. AshPhos has proven highly effective for coupling challenging heteroaryl bromides and chlorides with various amines, including those containing multiple heteroatoms. The ligand's strong binding with palladium facilitates excellent yields across a diverse range of substrates. Slightly elevated reaction temperatures can prevent the formation of catalytically dormant species, ensuring efficient catalytic cycles. Overall, AshPhos represents a valuable advancement in the field of catalytic amination, promoting more efficient and sustainable chemical processes.

### Example 4

### General Information and Methods for Examples 5-9

### General Information:

Most of the reactions were carried out under a nitrogen atmosphere. Reagents were purchased at the highest commercial quality and used without further purification, unless otherwise stated. Ethyl acetate (EtOAc), hexane, dichloromethane (CH₂Cl₂), and acetone ((CH₃)₂CO)) were purchased from Fisher Scientific. Sigma-Aldrich supplied methanol and pentane. Analytical thin-layer chromatography (TLC) was performed on precoated silica gel (UV 254 indicator, TLC Silica gel 60 F₂₅₄) purchased from Supelco (lot no. HX91185454), and silica gel (standard grade, 230-400 mesh) was purchased from Silicycle (lot #A-000983). Visualization on TLC was achieved using UV light (254 nm), iodine on silica gel, or basic KMnO₄ indicator. Aryl halides, P(Cy)₂Cl, CuCl, [Pd(crotyl)Cl]₂ (lot no: A293592-QJ40, 98% purity), and K₄[Fe(CN)₆]·3H₂O (lot no. A235710-AA4) were directly purchased from Ambeed. Anhydrous K₂CO₃ was purchased from Acros (lot no. B0121238). Potassium hydroxide pellets were purchased from Fisher Chemicals (lot no. 193564A). NMR solvents were obtained from Sigma-Aldrich. Deuterium oxide was obtained from Aldrich Chemistry (lot no. MKCB2218V). Tert-BuLi (1.7 M in pentane) was purchased from Sigma-Aldrich. Potassium cyanide was purchased from Sigma-Aldrich (lot #BCBV1748). For a 0.5 mmol scale reaction (8 mL crimp-top vial), a stir bar (6 (L)×2 (D) mm, PTFE-coated, cylindrical) was used.

### Test for the Detection of Free Cyanide Ion

Cyanide reagent test strips designed for semi-quantitative monitoring of water for free cyanide were purchased from Industrial Test Systems or Amazon. The test kit utilizes a free cyanide detection method developed by Nagashima, which uses isonicotinic acid and barbituric acid. The testing kit uses two dip strips. Strip #1 has different front and end pads. The end pad is impregnated with Chloramine T hydrate, which converts cyanide to cyanogen chloride. The pad near the handle is impregnated with monobasic and dibasic phosphates to buffer to the proper pH for the formation of cyanogen chloride. In strip #2, both front and back pads are impregnated with a solution of isonicotinic acid and 1,3-dimethylbarbituric acid. The two acids react with the cyanogen chloride to form a blue color.

For testing, water samples with a pH above 5.0 and below 11.5 were used directly, with sample measurements being performed at 23° C. (room temperature).

Testing protocol was as follows. Solutions of varying concentrations of potassium cyanide (KCN; purchased from Sigma-Aldrich) were prepared in water. The concentrations used were 1000 ppm, 100 ppm, 10 ppm, 1.0 ppm, and 0.1 ppm. To begin, 2.0 mL of each sample was added to a microcuvette. Next, strip #1 was dipped into water for 1 minute, using a gentle up-and-down motion. Afterward, strip #1 was discarded into a cyanide waste container. Then, strip #2 was dipped into the water sample for approximately 1 minute, again using a gentle up-and-down motion. Strip #2 was shaken to remove any excess water. For better accuracy in detecting low cyanide levels, the water samples were retained for 10-15 minutes to allow the color to develop. Finally, the developed color was matched with microcuvette colors from controls.

### Transmission Electron Microscopy (TEM), Scanning Transmission Electron Microscopy (STEM), High-Angle Annular Dark-Field (HAADF) Imaging

To investigate the composition, energy-dispersive X-ray spectroscopy (EDS) and EDS mapping were employed. These analyses were carried out using a 200 kV FEI Tecnai F20 field-emission gun microscope equipped with a spectrometer sold under the tradename EDAX® TEAM EDS. TEM samples were prepared by drop-casting dispersions of the catalyst onto commercial copper grids supported by amorphous holey carbon films.

### X-Ray Photoelectron Spectroscopy (XPS)

The analysis was conducted using a spectroscopy system sold under the tradename NEXSA® (Thermo Scientific) equipped with an Al Monochromatic X-ray source. Measurements were performed under ultra-high vacuum, with a base pressure ranging from 2.0×10⁻⁹ to 2.0×10⁻⁸ mBar. XPS spectra were collected at a take-off angle of 0 degrees, and the X-ray Source was at 30 degrees. Binding energy (BE) calibration was achieved by collecting and deconvoluting the high-resolution C1s spectrum, where the C—C peak from adventitious carbon was referenced to 284.5 eV. High-resolution XPS spectra were analyzed using XPSPEAK. For each spectrum, a Shirley-type background was fitted and subtracted, and the resulting background-subtracted spectrum was deconvoluted into Gaussian-type peaks.

### HPMC Solution

Preparation of 0.1 wt. % aq. HPMC solution: To a 250 mL round-bottom flask, 0.1 g of solid HPMC powder (provided by AbbVie, lot: 2452765-0) was added, followed by 100 mL of deionized water, and the flask was fitted with a rubber septum. This solution was degassed with positive nitrogen pressure for approximately 30 minutes with continuous stirring. The degassed 0.1 wt. % aq. An HPMC solution was used to perform cross-coupling reactions.

### Example 5

### Synthesis and Characterization of Palladium-Ashphos Nanoparticles

### General Synthesis of Pd-AshPhos Nanoparticles Derived from [Pd(crotyl)Cl]₂ and AshPhos (NP 1)

In an 8 mL reaction vial containing a PTFE-coated stir bar, [Pd(crotyl)Cl]₂ (10.0 mg, 0.025 mmol) and AshPhos (23.9 mg, 0.050 mmol) were added. The reaction vial was closed with a rubber septum, evacuated, and backfilled with nitrogen. This cycle was repeated two additional times. dry THF (0.2 mL) was added, and the mixture was stirred at 60° C. for 2-3 minutes. Then, the reaction mixture was cooled down to room temperature, and the solvent volatiles were evaporated to obtain a bright yellow solid. Subsequently, the rubber septum was opened, and 0.5 mL 0.1 wt. % aq. HPMC was added to this mixture, followed by the addition of 2.0 equiv. K₂CO₃, and the mixture was stirred for the next 30 minutes. The color of the reaction mixture turns from bright yellow to dark yellow. The resulting solid nanoparticles encapsulated in the hydrophobic pockets of HPMC were used as such for characterization.

### Sample Preparation for NMR Study of Catalyst

In an 8 mL reaction vial containing a PTFE-coated stir bar, [Pd(crotyl)(AshPhos)Cl](34.6 mg, 0.0511 mmol) and K₂CO₃ (0.0511 mmol) were added. The reaction vial was closed with a rubber septum, evacuated, and backfilled with nitrogen. This cycle was repeated twice more. Dry THF (0.2 mL) was added, and 0.5 mL of 0.1 wt. % HPMC (in D₂O) was added to this mixture, and the reaction mixture was stirred for the next 30 minutes. The solution turns from bright yellow to dark yellow. The resulting solid nanoparticles, encapsulated in the hydrophobic pockets of HPMC, were used as-is for characterization.

The ³¹P NMR studies reveal that the [Pd(crotyl)(AshPhos)Cl] in 0.1 wt. % HPMC/D₂O spontaneously forms a stable catalytic species in this aqueous medium after possible reductive elimination of crotyl chloride, and then nucleation of a Pd (0) atom appeared at 28.3 ppm.

### Catalytic Performance of Fresh and Aged NPs

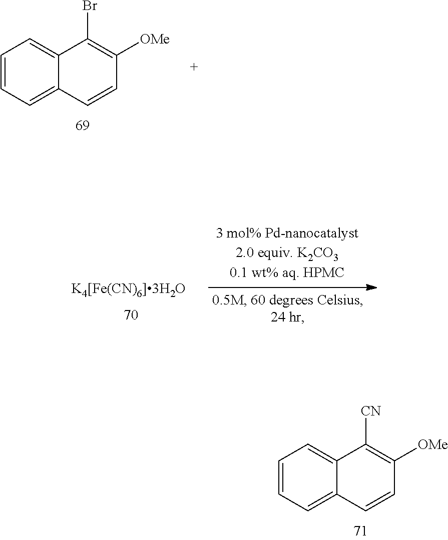 [SMILES: COc1ccc2ccccc2c1Br ; COc1ccc2ccccc2c1C#N]

### Scheme 8. Exemplary Reaction for Study of Fresh and Aged NPs.

Pd-AshPhos NPs derived from [Pd(crotyl)Cl]2 (3.0 mol %) and AshPhos (6.0 mol %) were prepared in 0.1 wt. % aq. HPMC (0.5 mL) according to the General Procedure for Catalytic Reactions described in Example 7, below. To identify the catalytic activity of the aged nanoparticles in 0.1 wt. % aq. HPMC solutions, reactions were performed using fresh and aged NPs (8 h, 24 h, and 1 week) to catalyze the transformation of 1-bromo-2-methoxynapthalene (69) to 2-methoxynaphthonitrile (71) as shown in Scheme 8, above. 1-Bromo-2-methoxynapthalene (69, 0.5 mmol) was contacted with K₄[(Fe(CN)₆]·3H₂O (70, 0.25 equiv.) in the presence of the NPs at 60° C. for 24 hours. Results are provided in Table 3, below. Conversions (% yield of 2-methoxynaphthonitrile (71)) reported in Table 3 are based on GC-MS using mesitylene (0.5 mmol) as an internal standard.

TABLE 3
Activity of Aged-NPs

| | | |
|---|---|---|
| Entry | NP Age | % yield |

| 1 | fresh | | 78 |
|---|---|---|---|
| 2 | 8 | hours | 70 |
| 3 | 24 | h | 70 |
| 4 | 1 | week | 65 |

### Tests for Free Cyanide Release

Using the same exemplary catalytic reaction shown in Scheme 8, above, 0.1 mL test samples were removed from the crude reaction mixture before and after the reaction. The test samples were diluted with an additional 20 mL of water and tested according to the cyanide testing protocol described in Example 4. For comparison, a sample of a solution of K₄[(Fe(CN)₆]·3H₂O (70, 100 ppm, 10 mg/100 mL) was used as a control. No color developed in the test samples, confirming the absence of free cyanide ions during the transformation. Additional test samples were taken from a reaction mixture of the same reaction at different time intervals, i.e., 4 hours, 12 hours, and 24 hours). Again, no color development was observed after testing for free cyanide ion.

For comparison, the same test was performed on crude reaction samples from a catalytic reaction performed using the protocol described by Lipshutz et al. (Thakore et al., 2021) (see Scheme 9A, below) and a catalytic reaction performed using a protocol described by Buchwald et al. (Senecal et al., 2013; Cohen and Buchwald, 2015) (see Scheme 9B, below).

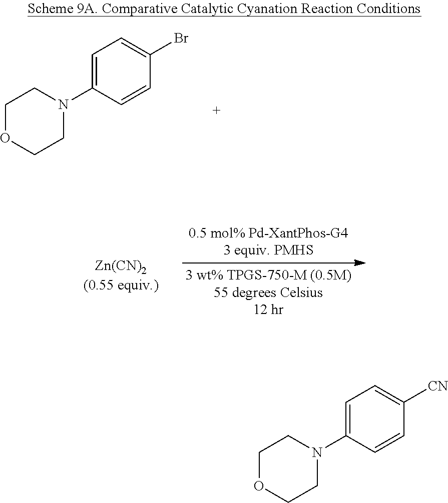 [SMILES: Brc1ccc(N2CCOCC2)cc1 ; N#Cc1ccc(N2CCOCC2)cc1]

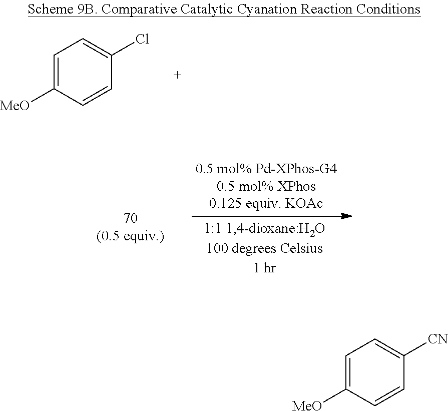 [SMILES: COc1ccc(Cl)cc1 ; COc1ccc(C#N)cc1]

### Discussion

A method of transforming aryl halides to aryl nitriles was developed based on the hypothesis that, under the reaction conditions described herein, in situ-generated mixed-metal Pd—Fe NPs formed from HPMC can provide a cooperative catalytic environment in which Pd is selectively coordinated by the strongly chelating AshPhos ligand while remaining in close spatial proximity to Fe. In this configuration, AshPhos is expected to bind preferentially to Pd, thereby enhancing oxidative addition and halogen-nitrile cross-metathesis, providing cyanide-ion-free transmetallation. The Fe-bound nitrile, positioned near the Pd center within the NP architecture, can facilitate cross-halogen-nitrile metathesis. This sequence should ultimately promote rapid reductive elimination to afford the desired product. See FIG. 8A. The method is also based on the hypothesis that the strong σ-donor properties of AshPhos suppress de-ligation and Pd dimerization via nitrile bridging after cross-metathesis, helping maintain the active monomeric Pd species required for turnover.

To investigate the binding affinity of the AshPhos ligand with Pd and the stability of the resulting AshPhos-Pd NPs within the hydrophobic core of HPMC, ³¹P NMR studies were conducted of the NPs at various time intervals. See FIG. 8B. The NPs formed spontaneously when AshPhos(crotyl)PdCl and K₂CO₃ were suspended in a 1:1 ratio as a 0.05 M solution in 0.1 wt. % HPMC in D₂O. The fresh solution exhibited ³¹P signals at 31.8 and 28.3 ppm, while the free ligand appeared at −10.3 ppm. The signal at 31.8 ppm corresponds to AshPhos(crotyl)PdCl, whereas the signal at 28.3 ppm likely corresponds to the AshPhos Pd(0) nucleus. After 30 minutes of stirring at 60° C., both signals disappeared, and a new signal emerged at 26.2 ppm, which corresponds to AshPhos-Pd NPs within the hydrophobic pockets of HPMC. This signal remained consistent at 26.2 ppm even after one week in an aqueous solution, indicating the stability of the NPs, possibly imparted by HPMC. No free or oxidized ligand was detected in ³¹P NMR spectroscopy. See FIG. 8B. A control NMR study of mixed metal NPs containing Fe was not possible due to the paramagnetic nature of the catalytic material that contains some level of Fe(III).

The catalytic activity of both fresh and aged NPs was evaluated using a model reaction, i.e., the cyanation of 1-bromo-2-methoxynaphthalene (69). The reaction involved the coupling of 1-bromo-2-methoxynaphthalene (as an exemplary aryl halide) with a cyanide source (i.e., K4[(Fe(CN)₆]3H₂O) (70) in a 0.1 wt. % HPMC solution, employing 3 mol % NPs and 2.0 equivalents of K₂CO₃ as the base. The reaction was less effective without a base, as it enhanced NP dispersion but did not participate in the catalytic cycle. When a fresh NP catalyst was used, the cyano-containing product was isolated in 78% yield. However, a slight reduction in the isolated yield of product was observed when aged NPs were used. Without being bound to any one theory, this reduction is likely attributable to the growth in NP size and the reduction in the surface-to-volume ratio over time. Specifically, NPs aged for 8 and 24 hours gave 70% of product, whereas NPs aged for one week resulted in a 65% yield.

Next, cyanide reagent strip tests were performed at the start of the reaction, during its progress, and upon completion to detect any free cyanide ions. No free cyanide ions were detected down to concentrations as low as 0.1 ppm. In contrast, the state-of-the-art micellar catalysis reported by the Lipshutz group (see Scheme 9A above) required polymethylhydrosiloxane (PMHS) to enable cyanation (Thakore et al., 2021), which also generated HCN in water, resulting in detectable free CN⁻ ions in our tests. Similarly, reactions conducted under Buchwald's conditions (Senecal et al., 2013; Cohen and Buchwald, 2015) (see Scheme 9B, above) produced free CN⁻ ions, even while employing the same potassium ferrocyanide reagent, indicating a difference in transmetallation mechanism between the presently disclosed NP system and traditional homogeneous catalysis systems.

### Example 6

### Mechanistic Studies of Catalytic Cyanation

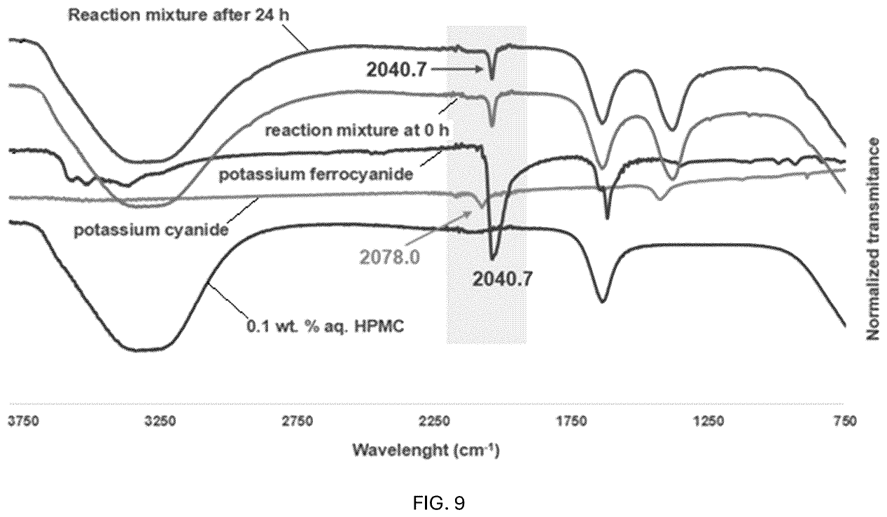

To determine whether the free nitrile group from potassium ferrocyanide serves as the nitrile source for the cyanation of 1-bromo-2-methoxynaphthalene or whether the reaction occurs in a concerted manner via in situ generated ligated Fe/Pd NPs, a control infrared (IR) spectroscopy study was performed. Because the basic conditions provided by K₂CO₃ can potentially result in release of KCN in situ, the IR analysis aimed to probe this possibility. IR spectra were recorded for neat aqueous HPMC, KCN in aqueous HPMC, potassium ferrocyanide in aqueous HPMC, a standard reaction mixture at time zero, and after 24 hours. See FIG. 9. The nitrile stretch of KCN appears at 2078 cm⁻¹, while potassium ferrocyanide shows a stretch at 2040 cm⁻¹; notably, the standard reaction mixture exhibits a nitrile stretch at 2040 cm⁻¹, indicating no free nitrile species are present. These findings strongly support that transmetallation proceeds in a concerted manner rather than via cyanide ion liberation, underscoring the safety of this protocol.

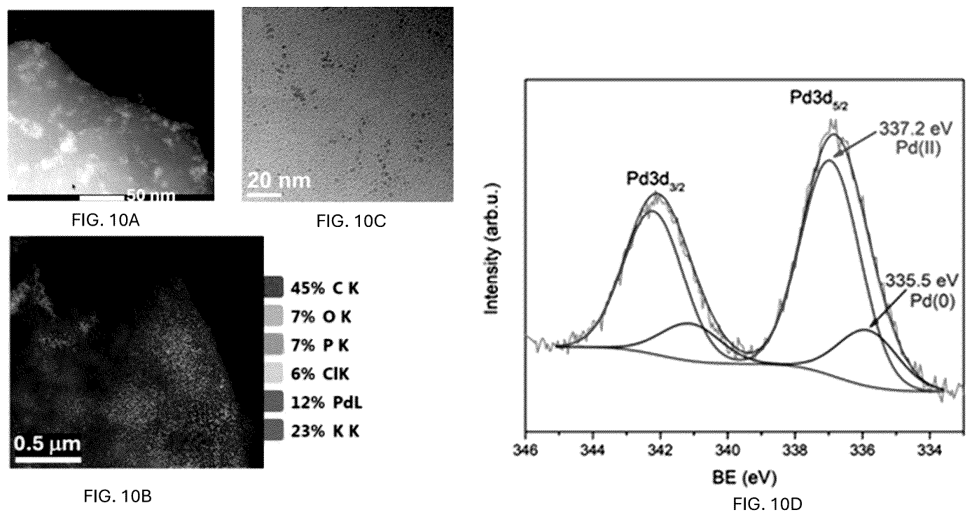

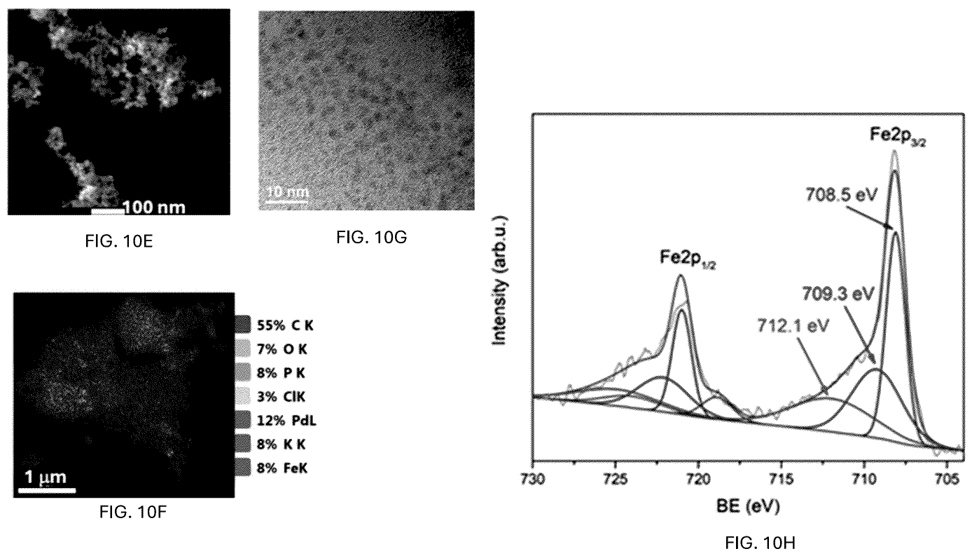

The influence of potassium ferrocyanide on forming active nanocatalytic species for cyanide-free catalysis was probed by comparing Pd NPs generated with and without potassium ferrocyanide (70). High-angle annular dark field scanning transmission electron microscopy (HAADF-STEM) and energy-dispersive X-ray spectroscopy (EDS) confirmed Pd and ligand-derived phosphorus in both samples (see FIGS. 10A, 10B, 10E, and 10F), while high-resolution transmission electron microscopy (HRTEM) revealed smaller NPs (<2 nm) without 70 and larger (~3 nm) with 70 (see FIGS. 10C and 10G), indicative of mixed metal NPs causing particle size enlargement. X-ray photoelectron spectroscopy (XPS) analysis established Pd(0) as the catalytically active state (335.5 eV) (Brun et al., 1999 and indicated Pd(II) at 337.2 eV (Ansari et al, 2024), likely from aerobic oxidation or Pd—P interactions within HPMC. See FIG. 10D. Fe exhibited +2 and +3 states (708.5, 712.1 eV), consistent with redox interplay between Pd(II) and K4[Fe(CN)₆]·3H₂O, which drives efficient Pd(0) generation. See FIG. 10H. These findings support a bimetallic mechanism wherein Pd(0) mediates cross-coupling while Fe(II) facilitates concerted transmetallation, ensuring robust cyanide-free catalysis.

### Example 7

### Palladium-Catalyzed Cyanation Reactions

### General Procedure for Palladium-Catalyzed Cyanation Reactions

In an 8.0 mL reaction vial containing a PTFE-coated magnetic stir bar, [Pd(crotyl)Cl]₂ (5.9 mg, 0.015 mmol, 3.0 mol %) and AshPhos (14.0 mg, 0.030 mmol, 6.0 mol %) were added [Note: the amount of catalyst used depend on the substrate, as described for individual exemplary products below.] The reaction vial was sealed with a rubber septum, and the contents were evacuated and backfilled with nitrogen. The evacuation and backfilling cycles were repeated 3-4 times. Subsequently, 0.2 mL dry THF was added to the reaction vial, and the septum was covered with black electric tape. The reaction mixture was stirred at 60° C. under a nitrogen atmosphere for approximately 2-3 minutes to obtain a bright yellow precomplex. After precomplexation, THF was removed under reduced pressure (e.g., as the use of a co-solvent can lead to less efficient cross-coupling), and 0.1 wt. % degassed aq. HPMC (1 mL) was added to the reaction vial to maintain the global concentration of 0.5 M. The mixture was stirred at 60° C. for the next 5 minutes. Subsequently, the septum was opened, and aryl halide (0.5 mmol), K₄[Fe(CN)₆]·3H₂O (0.125 mmol, 0.25 equiv.) and K₂CO₃ (1.0 mmol, 2.0 equiv.) were added to the reaction mixture. The reaction vial was resealed with a rubber septum, which was then covered with black tape. The reaction mixture was stirred at 60° C. in a preheated oil bath. After complete consumption of the starting material, as monitored by TLC or GC-MS, the reaction mixture was cooled to rt, and 2.0 mL ethyl acetate was added. The mixture was then gently stirred for 2 minutes at room temperature. Later, the organic layer was separated using a pipette. This extraction was repeated an additional 2-3 times. The combined organic layers were dried over anhydrous Na₂SO₄, and volatiles were removed under reduced pressure to obtain the crude product, which was further purified by silica gel column chromatography, using ethyl acetate and hexane as eluents.

Note: All 0.5 mmol-scale reactions were performed in an oil bath or completed on a stir plate set to 1000-1100 rpm; efficient stirring is essential for the reaction. Additionally, the reaction's internal temperature was maintained at 60° C., using the same amount of solvent and a reaction vessel equipped with a temperature sensor.

### Reaction Optimizations Studies:

Using the reaction of 1-bromo-2-methoxynapthalene (69) and K₄[(Fe(CN)₆]·3H₂O (70) (with 0.5 mmol 69 and 0.25 equiv. 70), shown in Scheme 8, above, optimal palladium-catalyzed cyanation reaction conditions were determined by running several series of reactions, varying one reaction parameter at a time. For example, other palladium sources were used in place of the [Pd(crotyl)Cl]₂, other bases were used in place of potassium carbonate (K₂CO₃), the amount of base was varied, and other solvents were used in place of 0.1 wt % aq. HPMC. Results of these studies are described in Tables 4A-4E, below. Percent yields described in Tables 4A-4E were determined by GC-MS using mesitylene (0.5 mmol) as an internal standard or, when indicated with an asterisk, based on isolated yield. N.d. stands for not determined.

TABLE 4A
Effect of Solvent

| | | Yield |
|---|---|---|
| Entry | Solvent | (%) |
| 1 | 0.1 wt % aq. HPMC | 78 (76)* |
| 2 | 3.0 wt % aq. PS-750-M | 73 |
| 3 | 3.0 wt % aq. TWEEN-20 | 68 |
| 4 | 3.0 wt % aq. SDS | 58 |
| 5 | DMF | 11 |
| 6 | NMP | 8 |
| 7 | H₂O | 17 |

TABLE 4B
Effect of Pd Source

| | | Yield |
|---|---|---|
| Entry | Pd Source | (%) |
| 1 | [Pd(crotyl)Cl]₂ | 78 (76)* |
| 2 | [Pd(allyl)Cl]₂ | 63 |
| 3 | Pd₂dba₃ | traces |
| 4 | Pd(OAc)₂ | traces |
| 5 | PdCl₂ | traces |

TABLE 4C
Effect of Base Source

| | | Yield |
|---|---|---|
| Entry | Base | (%) |
| 1 | KOH | 70 |
| 2 | K₂CO₃ | 78 |
| 3 | KOTMS | 17 |
| 4 | KOₜ-Bu | 35 |
| 5 | NaOₜ-Bu | 31 |
| 6 | Li₂CO₃ | 75 |
| 7 | Cs₂CO₃ | 71 |
| 8 | NEt₃ | 70 |
| 9 | DIPEA | 75 |

TABLE 4D
Effect of Base Equivalents

| | Base | Yield |
|---|---|---|
| Entry | Equivalents | (%) |
| 1 | No base | 34 |
| 2 | 0.5 | 40 |
| 3 | 1.0 | 51 |
| 4 | 2.0 | 78(76)* |

TABLE 4E
Additional Control Studies

| | | Yield |
|---|---|---|
| Entry | Conditions | (%) |
| 1 | without Pd/Ligand | n.d. |
| 2 | without base | 34 |
| 3 | 1.0 equiv. 70 instead of 0.25 equiv. | 44 |
| 4 | H₂O instead of HPMC | 17 |
| 5 | CuBr₂ as an additive | 18 |
| 6 | H₂ gas as an additive | 46 |
| 7 | ZnCl₂ as an additive | 64 |
| 8 | 0.2 mL co-solvent THF | 67 |
| 9 | Cu(CH₃CN)₄PF₆ as an additive | 31 |
| 10 | Catalyst: 3 mol % Pd(CN)₂ (absence of ligand) | n.d. |
| 11 | Catalyst: 3 mol % PD(CN)₂ and 3.0 mol % | n.d. |
| | AshPhos | |
| 12 | Room temperature instead of 60° C. | 11 |
| 13 | 0.1 mol % [Pd(crotyl)Cl]₂ instead of 3.0 mol % | 8 |
| 14 | 1.0 mol % [Pd(crotyl)Cl]₂ instead of 3.0 mol % | 33 |
| 15 | 2.0 mol % [Pd(crotyl)Cl]₂ instead of 3.0 mol % | 60 |

### Exemplary Cyanation Reactions and Products:

### 2-Methoxy-1-naphthonitrile (71) (CAS #16000-39-8)

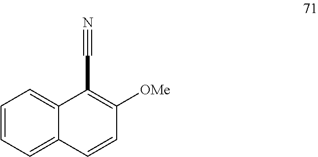

Product 71 was prepared according to the general reaction procedure using 3.0 mol % [Pd(crotyl)Cl]₂ and 6.0 mol % AshPhos as the catalyst to afford a white solid (70 mg, 76% yield), R_{f}=0.4, eluent EtOAc/hexanes (1:9). ¹H NMR (600 MHz, CDCl₃): δ (ppm) 8.07 (d, J=8.6 Hz, 1H), 7.99 (d, J=9.1 Hz, 1H), 7.79 (d, J=8.4 Hz, 1H), 7.66-7.56 (m, 1H), 7.47-7.37 (m, 1H), 7.24 (d, J=9.4 Hz, 1H), 4.05 (s, 3H).

### 4-Morpholinobenzonitrile (73) (CAS #10282-31-2)

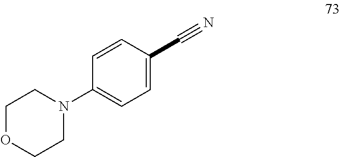

Product 73 was prepared according to the general reaction procedure using 2.0 mol % [Pd(crotyl)Cl]₂ and 4.0 mol % AshPhos as the catalyst to afford a white semisolid (79 mg, 83% yield), R_{f}=0.4, eluent EtOAc/hexanes (3/7). ¹H NMR (600 MHz, CDCl₃): δ (ppm) 7.47 (d, J=9.0 Hz, 2H), 6.83 (d, J=9.1 Hz, 2H), 3.84-3.72 (m, 4H), 3.33-3.14 (m, 4H).

### 4-(Tert-butyl)benzonitrile (76) (CAS #4210-32-6)

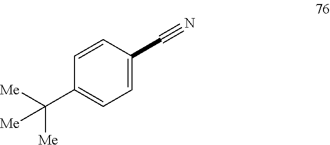

Product 76 was prepared according to the general reaction procedure using 3.0 mol % [Pd(crotyl)Cl]₂ and 6.0 mol % AshPhos as the catalyst to afford a white solid (65 mg, 82% yield), R_{f}=0.6, eluent EtOAc/hexanes (5/95). ¹H NMR (600 MHz, CDCl₃): δ (ppm) 7.37 (d, J=8.5 Hz, 2H), 7.27 (d, J=8.5 Hz, 2H), 1.11 (s, 9H).

### 4-Methoxybenzonitrile (77) (CAS #874-90-8)

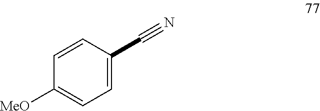

Product 77 was prepared at 0.25 mmol scale according to the general reaction procedure using 3.0 mol % [Pd(crotyl)Cl]₂ and 6.0 mol % AshPhos as the catalyst to afford a white solid (33 mg, 96% yield), R_{f}=0.5, eluent EtOAc/hexanes (1/9). ¹H NMR (600 MHz, CDCl₃): δ (ppm) 7.57 (d, J=7.9 Hz, 2H), 6.94 (d, J=8.9 Hz, 2H), 3.85 (s, 3H). Note: Using 2 mol % [Pd(crotyl)Cl]₂ and 4.0 mol % AshPhos gave 87% product.

### [1,1′-Biphenyl]-4-carbonitrile (78) (CAS #2920-38-9)

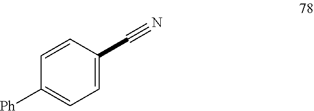

Product 78 was prepared according to the general reaction procedure using 2.0 mol % [Pd(crotyl)Cl]₂ and 4.0 mol % AshPhos as the catalyst to afford a white solid (70 mg, 77% yield), R_{f}=0.5, eluent EtOAc/hexanes (2/8). ¹H NMR (600 MHz, CDCl₃): δ (ppm) 7.77 (dd, J=7.8, 1.5 Hz, 1H), 7.65 (m, 1H), 7.58 (m, 2H), 7.55-7.48 (m, 3H), 7.48-7.42 (m, 2H).

### 3-Methoxybenzonitrile (79) (CAS #1527-89-5)

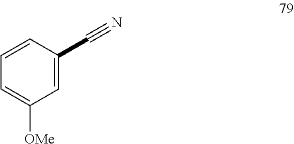

Product 79 was prepared according to the general reaction procedure using 3.0 mol % [Pd(crotyl)Cl]₂ and 6.0 mol % AshPhos as the catalyst to afford a pale yellow liquid (60 mg, 90% yield), R_{f}=0.7, eluent EtOAc/hexanes (1/9), ¹H NMR (600 MHz, CDCl₃): δ (ppm) 7.36 (dd, J=9.3, 7.5 Hz, 1H), 7.25-7.18 (m, 1H), 7.15-7.10 (m, 2H), 3.82 (s, 3H).

### 3,5-dimethoxybenzonitrile (80) (CAS #19179-31-8)

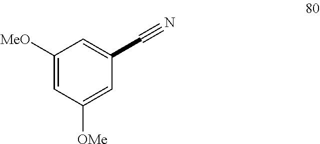

Product 80 was prepared according to the general reaction procedure using 2.0 mol % [Pd(crotyl)Cl]₂ and 4.0 mol % AshPhos as the catalyst to afford a colorless liquid (75 mg, 91% yield), R_{f}=0.4, eluent EtOAc/hexanes (1/9). ¹H NMR (600 MHz, CDCl₃): δ (ppm) 6.72 (d, J=2.6 Hz, 2H), 6.62 (t, J=2.4 Hz, 1H), 3.78 (s, 6H).

### 1-Naphthonitrile (81) (CAS #86-53-3)

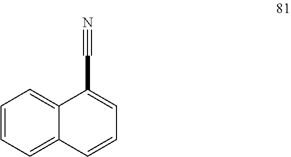

Product 81 was prepared according to the general reaction procedure using 3.0 mol % [Pd(crotyl)Cl]₂ and 6.0 mol % AshPhos as the catalyst to afford a white solid (38.5 mg, 95% yield), R_{f}=0.5, eluent EtOAc/hexanes (1/9). ¹H NMR (600 MHz, CDCl₃): δ (ppm) 7.99 (dd, J=8.3, 1.4 Hz, 1H), 7.83 (d, J=8.4 Hz, 1H), 7.71-7.62 (m, 2H), 7.45 (m, 1H), 7.37 (m, 1H), 7.27 (dd, J=8.4, 7.1 Hz, 1H). Note: Using 2 mol % [Pd(crotyl)Cl]₂ and 4.0 mol % AshPhos gave 65% product.

### 2-Methyl-1-naphthonitrile (82) (CAS #20944-85-8)

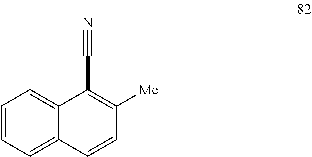

Product 82 was prepared according to the general reaction procedure using 3.0 mol % [Pd(crotyl)Cl]₂ and 6.0 mol % AshPhos as the catalyst to afford a white solid (65.2 mg, 78% yield), R_{f}=0.5, eluent EtOAc/hexanes (1/9). ¹H NMR (600 MHz, CDCl₃): δ (ppm) 8.16 (dd, J=8.4, 1.1 Hz, 1H), 7.90 (d, J=8.4 Hz, 1H), 7.83 (d, J=8.2 Hz, 1H), 7.62 (m, 1H), 7.52 (m, 1H), 7.35 (d, J=8.5 Hz, 1H), 2.72 (s, 3H).

### 6-methoxy-2-naphthonitrile (83) (CAS #67886-70-8)

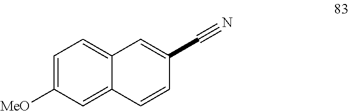

Product 83 was prepared according to the general reaction procedure using 2.0 mol % [Pd(crotyl)Cl]₂ and 4.0 mol % AshPhos as the catalyst to afford a white solid (68 mg, 73% yield), R_{f}=0.4, eluent EtOAc/hexanes (1:9). ¹H NMR (600 MHz, CDCl₃): δ (ppm) 8.09 (s, 1H), 7.73-7.77 (m, 2H), 7.53 (d, J=8.6 Hz, 1H), 7.25-7.20 (m, 1H), 7.13 (s, 1H), 3.93 (s, 3H).

### 4-Methyl-1-naphthonitrile (84) (CAS #36062-93-8)

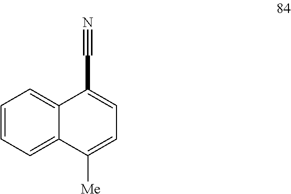

Product 84 was prepared according to the general reaction procedure using 3.0 mol % [Pd(crotyl)Cl]₂ and 6.0 mol % AshPhos as the catalyst to afford a pale-yellow solid (74 mg, 88% yield), R_{f}=0.5, eluent EtOAc/hexanes (1/9). ¹H NMR (600 MHz, CDCl₃): δ (ppm) 8.20 (dd, J=8.1, 1.5 Hz, 1H), 8.08-7.96 (m, 1H), 7.74 (d, J=7.3 Hz, 1H), 7.63 (m, 2H), 7.30 (dd, J=7.1, 1.2 Hz, 1H), 2.71 (d, J=1.1 Hz, 3H). Note: Using 2.0 mol % [Pd(crotyl)Cl]₂ and 4.0 mol % AshPhos yielded 60% product formation.

### 2,3-Dihydrobenzo[b][1,4]dioxine-6-carbonitrile (85) (CAS #19102-07-9)

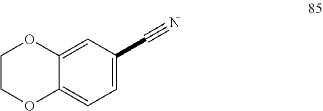

Product 85 was prepared according to the general reaction procedure using 2.0 mol % [Pd(crotyl)Cl]₂ and 4.0 mol % AshPhos as the catalyst to afford a white solid (76 mg, 90% yield), R_{f}=0.5, eluent EtOAc/hexanes (1/9). ¹H NMR (600 MHz, CDCl₃): δ (ppm) 7.11 (d, J=8.1 Hz, 2H), 6.89 (d, J=8.2 Hz, 1H), 4.96-3.15 (m, 4H).

### 2,2-Difluorobenzo[d][1,3]dioxole-5-carbonitrile (86) (CAS #135132-34-2)

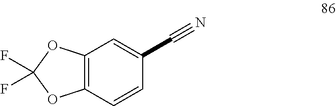

Product 86 was prepared according to the general reaction procedure using 3.0 mol % [Pd(crotyl)Cl]₂ and 6.0 mol % AshPhos as the catalyst to afford a white solid (82 mg, 89% yield), R_{f}=0.5, eluent EtOAc/hexanes (1/9). ¹H NMR (600 MHz, CDCl₃): δ (ppm) 7.46 (s, 1H), 7.35 (s, 1H), 7.17 (s, 1H).

### 4-(methylsulfinyl)benzonitrile (87) (CAS #. 97474-48-1)

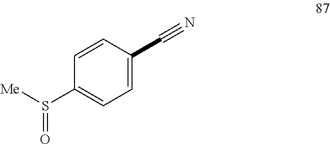

Product 87 was prepared according to the general reaction procedure using 3.0 mol % [Pd(crotyl)Cl]₂ and 6.0 mol % AshPhos as the catalyst to afford a white solid (70 mg, 83% yield), R_{f}=0.6, eluent EtOAc/hexanes (8/2), ¹H NMR (600 MHz, CDCl₃): δ (ppm) 7.84-7.81 (m, 2H), 7.78-7.74 (m, 2H), 2.75 (s, 3H).

### 2,6-Dimethylbenzonitrile (88) (CAS #6575-13-9)

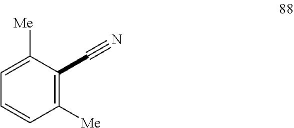

Product 88 was prepared according to the general reaction procedure using 3.0 mol % [Pd(crotyl)Cl]₂ and 6.0 mol % AshPhos as the catalyst to afford a colorless liquid (40 mg, 60% yield), R_{f}=0.6, eluent EtOAc/hexanes (1/9), ¹H NMR (600 MHz, CDCl₃): δ (ppm) 7.34 (t, J=7.7 Hz, 1H), 7.12 (d, J=7.7 Hz, 2H), 2.53 (s, 6H).

### 2,5-dimethylbenzonitrile (89) (CAS #13730-09-1)

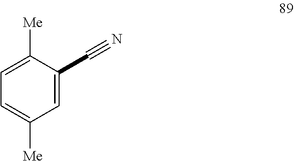

Product 89 was prepared according to the general reaction procedure using 2.0 mol % [Pd(crotyl)Cl]₂ and 4.0 mol % AshPhos as the catalyst to afford a transparent viscous oil (56 mg, 85% yield), R_{f}=0.4, eluent EtOAc/hexanes (95/5), ¹H NMR (600 MHz, CDCl₃): δ (ppm) 7.44 (d, J=2.0 Hz, 1H), 7.34 (dd, J=8.0, 1.9 Hz, 1H), 7.25 (d, J=7.9 Hz, 1H), 2.56 (s, 3H), 2.40 (s, 3H).

### 2,6-Dimethoxybenzonitrile (90) (CAS #16932-49-3)

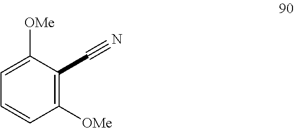

Product 90 was prepared according to the general reaction procedure using 3.0 mol % [Pd(crotyl)Cl]₂ and 6.0 mol % AshPhos as the catalyst to afford a white solid (47 mg, 56% yield), R_{f}=0.4, eluent EtOAc/hexanes (2/8), ¹H NMR (600 MHz, CDCl₃): δ (ppm) 7.41 (t, J=8.5 Hz, 1H), 6.53 (d, J=8.5 Hz, 2H), 3.87 (s, 6H).

### 6-Methoxynicotinonitrile (91) (CAS #15871-85-9)

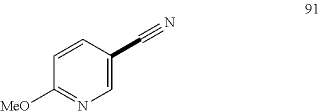

Product 91 was prepared according to the general reaction procedure using 3.0 mol % [Pd(crotyl)Cl]₂ and 6.0 mol % AshPhos as the catalyst to afford a white solid (47 mg, 68% yield), R_{f}=0.5, eluent EtOAc/hexanes (1/9), ¹H NMR (600 MHz, CDCl₃): δ (ppm) 8.49 (s, 1H), 7.77 (d, J=9.0 Hz, 1H), 6.82 (d, J=8.9 Hz, 1H), 4.00 (s, 3H).

### Benzo[b]thiophene-5-carbonitrile (92) (CAS #2060-63-1)

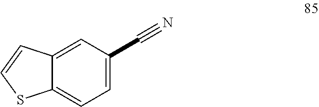

Product 92 was prepared according to the general reaction procedure using 3.0 mol % [Pd(crotyl)Cl]₂ and 6.0 mol % AshPhos as the catalyst to afford a white solid (49 mg, 81% yield), R_{f}=0.5, eluent EtOAc/hexanes (1/9). ¹H NMR (600 MHz, CDCl₃): δ (ppm) 8.10 (s, 1H), 7.93 (d, J=8.3 Hz, 1H), 7.59 (d, J=5.5 Hz, 1H), 7.51 (d, J=8.4 Hz, 1H), 7.41-7.32 (m, 1H).

### 1H-indole-5-carbonitrile (93) (CAS #15861-24-2)

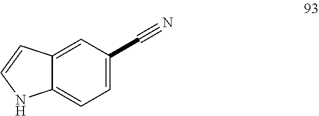

Product 93 was prepared according to the general reaction procedure using 2.0 mol % [Pd(crotyl)Cl]₂ and 4.0 mol % AshPhos as the catalyst to afford a white solid (43 mg, 61% yield), R_{f}=0.4, eluent EtOAc/hexanes (3/7). ¹H NMR (600 MHz, CDCl₃): δ (ppm) 8.58 (s, 1H), 7.99 (d, J=3.5 Hz, 1H), 7.51-7.39 (m, 2H), 7.33 (q, J=3.1 Hz, 1H), 6.63 (d, J=3.2 Hz, 1H).

### Benzo[d][1,3]dioxole-5-carbonitrile (94) (CAS #4421-09-4)

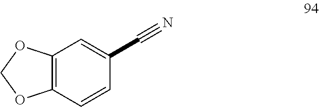

Product 94 was prepared according to the general reaction procedure using 3.0 mol % [Pd(crotyl)Cl]₂ and 6.0 mol % AshPhos as the catalyst to afford a white solid (71 mg, 92% yield), R_{f}=0.5, eluent EtOAc/hexanes (1/9), ¹H NMR (600 MHz, CDCl₃): δ (ppm) 7.19 (dd, J=8.1, 1.7 Hz, 1H), 7.01 (s, 1H), 6.85 (d, J=8.1 Hz, 1H), 6.06 (s, 2H).

### 3,5-Dimethylbenzonitrile (95) (CAS #22445-42-7)

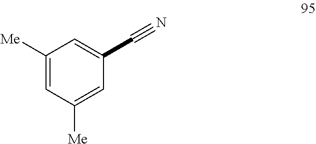

Product 95 was prepared according to the general reaction procedure using 3.0 mol % [Pd(crotyl)Cl]₂ and 6.0 mol % AshPhos as the catalyst to afford a white solid (48 mg, 73% yield), R_{f}=0.5, eluent EtOAc/hexanes (1/9). ¹H NMR (600 MHz, CDCl₃): δ (ppm) 7.23 (d, J=2.0 Hz, 2H), 7.22-7.17 (m, 1H), 2.33 (s, 6H).

### [1,1′-Biphenyl]-2-carbonitrile (96) (CAS #24973-49-7)

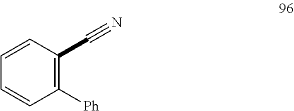

Product 96 was prepared according to the general reaction procedure using 3.0 mol % [Pd(crotyl)Cl]₂ and 6.0 mol % AshPhos as the catalyst to afford a colorless liquid (73 mg, 80% yield), R_{f}=0.4, eluent EtOAc/hexanes (1/9). ¹H NMR (600 MHz, CDCl₃): δ (ppm) 7.77 (dd, J=7.8, 1.5 Hz, 1H), 7.65 (m, 1H), 7.58 (dt, J=6.3, 1.4 Hz, 2H), 7.55-7.48 (m, 3H), 7.48-7.42 (m, 2H).

### Benzo[b]thiophene-5-carbonitrile (97) (CAS #744213-22-7)

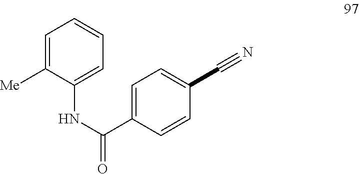

Product 97 was prepared according to the general reaction procedure using 3.0 mol % [Pd(crotyl)Cl]₂ and 6.0 mol % AshPhos as the catalyst to afford a white solid (53% yield), R_{f}=0.6, eluent EtOAc/hexanes (2/8). ¹H NMR (600 MHz, CDCl₃): δ (ppm) 7.98 (d, J=8.0 Hz, 2H), 7.88 (d, J=7.6 Hz, 1H), 7.80 (d, J=8.0 Hz, 2H), 7.65 (s, 1H), 7.31-7.23 (m, 2H), 7.17 (td, J=7.5, 1.3 Hz, 1H), 2.34 (s, 3H).

### (R)-4-(5-((1H-1,2,3-triazol-1-yl)methyl)-2-oxooxazolidin-3-yl)-2-fluorobenzonitrile (98)

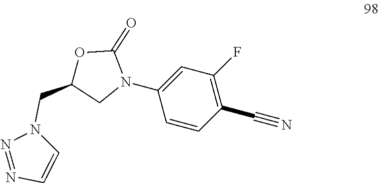

Product 98 was prepared according to the general reaction procedure using 5.0 mol % [Pd(crotyl)Cl]₂ and 10.0 mol % AshPhos as the catalyst to afford a white solid (31 mg, 41% yield), R_{f}=0.4, eluent MeOH/CH₂Cl₂ (5/95). ¹H NMR (600 MHz, CDCl₃): δ (ppm) 7.67 (d, J=14.0 Hz, 2H), 7.35-7.28 (m, 1H), 6.41 (dd, J=8.7, 2.2 Hz, 1H), 6.35 (dd, J=11.8, 2.2 Hz, 1H), 4.55 (dd, J=13.9, 3.3 Hz, 1H), 4.47 (dd, J=13.9, 7.2 Hz, 1H), 4.40 (dt, J=7.6, 3.5 Hz, 1H), 3.35-3.26 (m, 1H), 3.21 (dt, J=13.0, 6.1 Hz, 1H).

### N-(tert-butyl)-4′-((6-cyano-4-oxo-2-propylquinazolin-3(4H)-yl)methyl)-[1,1′-biphenyl]-2-sulfonamide (99)

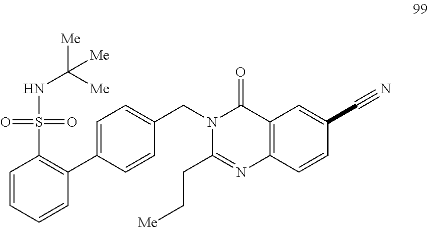

Product 99 was prepare according to the genera reaction procedure and DIPEA as a base 2.0 equiv., instead of K₂CO₃, using 5 mol % [Pd(crotyl)Cl]₂ and 10 mol % AshPhos as a catalyst to obtain a white solid (32 mg, 49% yield), R_{f}=0.3, eluent EtOAc/hexanes (6/4). ¹H NMR (600 MHz, CDCl₃): δ (ppm) 8.64 (d, J=2.1 Hz, 1H), 8.16 (dd, J=8.0, 1.4 Hz, 1H), 8.01 (dd, J=8.6, 2.1 Hz, 1H), 7.54 (dt, J=7.6, 3.8 Hz, 1H), 7.48 (m, 2H), 7.42 (d, J=8.6 Hz, 1H), 7.26 (d, J=2.3 Hz, 4H), 5.44 (s, 2H), 3.49 (s, 1H), 2.73 (t, J=7.7 Hz, 2H), 1.85 (q, J=7.5 Hz, 2H), 1.02 (t, J=7.4 Hz, 3H), 0.98 (s, 9H); ¹³C NMR (600 MHz, CDCl₃): δ (ppm) 61.3, 157.6, 146.8, 143.3, 142.2, 139.3, 139.2, 136.3, 136.0, 132.4, 132.1, 130.6, 129.2, 128.5, 128.1, 126.3, 122.2, 90.9, 54.6, 46.5, 37.3, 34.3, 29.9, 20.6, 14.0; HRMS (ESI) Calcd [M+H]⁺=515.2111; Found=515.2153.

### (1R,2S,5R)-2-isopropyl-5-methylcyclohexyl 3-cyanobenzoate (100) (CAS #2271180-33-5)

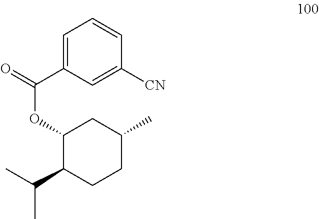 [SMILES: CC(C)[C@@H]1CC[C@@H](C)C[C@H]1OC(=O)c1cccc(C#N)c1]

Product 100 was prepared according to the general reaction procedure using 3.0 mol % [Pd(crotyl)Cl]₂ and 6.0 mol % AshPhos as the catalyst to afford a white solid (78 mg, 54% yield), R_{f}=0.6, eluent EtOAc/hexanes (1/9). ¹H NMR (300 MHz, CDCl₃): δ 8.32 (t, J=1.7 Hz, 1H), 8.27 (dt, J=7.9, 1.5 Hz, 1H), 7.83 (dt, J=7.7, 1.5 Hz, 1H), 7.58 (t, J=7.8 Hz, 1H), 4.96 (td, J=10.9, 4.4 Hz, 1H), 2.14-2.07 (m, 1H), 1.95-1.86 (m, 1H), 1.79-1.70 (m, 2H), 1.64-1.46 (m, 3H), 1.20-1.06 (m, 2H), 0.93 (dd, J=6.8, 2.6 Hz, 6H), 0.79 (d, J=6.9 Hz, 3H).

### Gram-Scale Synthesis of 2,3-Dihydrobenzo[b][1,4]dioxine-6-carbonitrile (85)

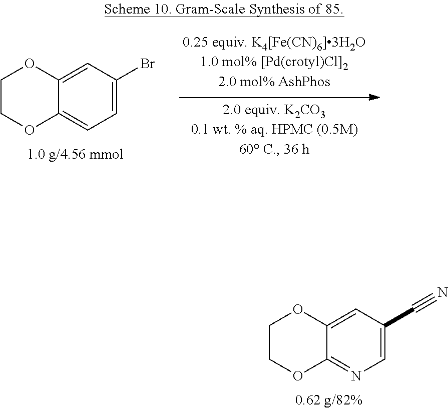

Product 85 was prepared according to the general procedure at 60° C. using 1.0 mol % [Pd(crotyl)Cl]₂ (18 mg), and 2.0 mol % AshPhos (43 mg) as a catalyst. The precatalyst was prepared by mixing the ligand and Pd source in 2.0 mL THF for 5 minutes at 60° C. After pre-complexation, the THF was evaporated completely, followed by the addition of 18 mL of 0.1 wt. % aq. HPMC. Later, 6-bromo-2,3-dihydrobenzo[b][1,4]dioxine (1.0 g, 4.56 mmol), K₄[Fe(CN)₆]·3H₂O (0.49 mg, 6.0 mmol), and K₂CO₃ (1.28 g) were added to the reaction flask, and the resulting mixture was stirred for next 36 h at 60° C. until the starting material was consumed entirely monitored by TLC and GC-MS. The reaction mixture was quenched with 10 mL EtOAc and 5 mL H₂O. Organic layer was separated from the aqueous layer. The aqueous layer was further extracted with an additional 20 mL of EtOAc. The combined organic layers were washed with brine and water, and dried over Na₂SO₄. Volatiles were removed under reduced pressure. The resulting reaction mixture was directly loaded onto a CombiFlash silica column (20 g silica gel) and the crude reaction mixture was purified using EtOAc/hexane (95:5) to obtain a white solid as the pure product, with a yield of 82% (621 mg). No free cyanide was detected before or after the reaction.

### Gram-Scale Synthesis of 6-methoxynicotinonitrile (91)

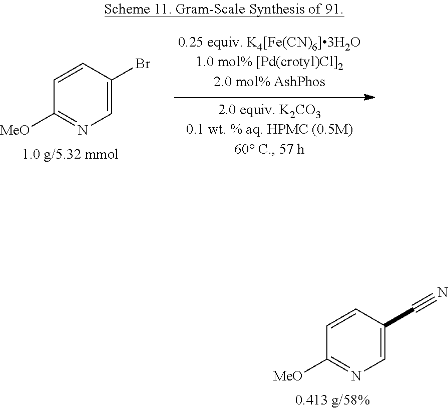

Product 91 was prepared according to the general procedure at 60° C. using 1.0 mol % [Pd(crotyl)Cl]₂ (22 mg), and 2.0 mol % AshPhos (49 mg) as a catalyst. The precatalyst was prepared by mixing the ligand and Pd source in 2.0 mL THF for 5 minutes at 60° C. After pre-complexation, the THF was evaporated completely, followed by the addition of 10.5 mL of 0.1 wt. % aq. HPMC. Later, 5-bromo-2-methoxypyridine (1.0 g, 5.32 mmol), K₄[Fe(CN)₆]·3H₂O (0.56 mg, 1.33 mmol), and K₂CO₃ (1.47 g) were added to the reaction flask, and the resulting mixture was stirred at 60° C. for next 57 h. The progress of the reaction was monitored by TLC (silica gel) and GC-MS. After completion of the reaction, the reaction mixture was quenched with 15 mL EtOAc and 5 mL H₂O. The organic layer was separated from the aqueous layer, and the aqueous layer was further extracted with an additional 30 mL of EtOAc. The combined organic layers were washed with brine and water and dried over Na₂SO₄. Volatiles were removed under reduced pressure to obtain the crude product. The resulting crude product was directly loaded onto a flash silica column (20 g silica), and the crude reaction mixture was purified with EtOAc/hexane (3:7) to obtain white solid as the pure product, with a yield of 58% (413 mg). No free cyanide was detected before or after the reaction.

### Gram-Scale Synthesis of (1R,2S,5R)-2-isopropyl-5-methylcyclohexyl 3-cyanobenzoate (100)

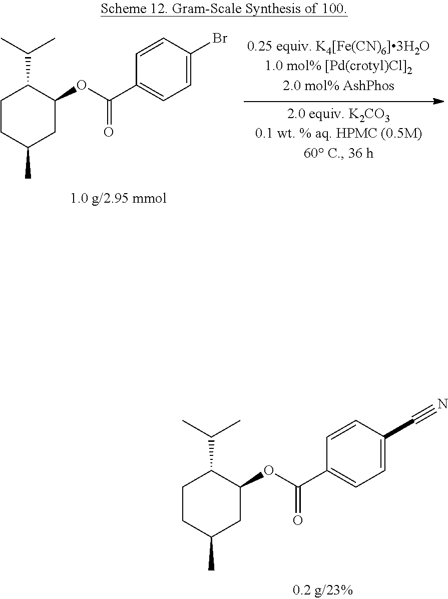

Product 100 was prepared according to general procedure at 60° C., using a 1.0 mol % [Pd(crotyl)Cl]₂ (11.6 mg) and 2.0 mol % AshPhos (26.9 mg) as the catalyst. The precatalyst was prepared by mixing the ligand and Pd source in 2.0 mL THF for 5 minutes at 60° C. After pre-complexation, the THF was evaporated completely, followed by the addition of 6 mL of 0.1 wt. % aq. HPMC into it. Later, (1S,2R,5S)-2-isopropyl-5-methylcyclohexyl-3-bromobenzoate (1.0 g, 2.95 mmol), K₄[Fe(CN)₆]·3H₂O (0.31 mg, 0.74 mmol), and K₂CO₃(0.82 g) were added to the reaction flask, and the resulting mixture was stirred at 60° C. for next 48 h. the progress of the reaction was monitored by TLC (silica gel). After the completion of the reaction, the reaction mixture was quenched with 15 mL EtOAc and 5 mL H₂O. The organic layer was separated from the aqueous layer. The aqueous layer was further extracted with an additional 30 mL of EtOAc. The combined organic layers were washed with brine and water, and dried over Na₂SO₄. Volatiles were removed under reduced pressure. The resulting crude product was directly loaded on a flash silica column (20 g silica) using the minimum amount of dichloromethane (2 mL). The crude reaction mixture was purified using EtOAc/hexane (5:95) to obtain a white solid as the pure product, with a yield of 23% (192 mg). 62% of the unreacted starting material was recovered due to poor solubility. No free cyanide was detected before or after the reaction.

### Discussion

To determine optimal conditions for the reaction of 1-bromo-2-methoxynaphthalene and potassium ferrocyanide, reaction parameters were varied one at a time. A summary of the results are shown in Table 5, below. Reaction conditions that deviated from the standard reaction conditions (0.5 mmol 1-bromo-2-methoxynaphthalene, 0.25 equiv. potassium ferrocyanide, 3 mol % [Pd(crotyl)Cl]₂, 6 mol % AshPhos, 2.0 equiv. K₂CO₃, 1.0 mL 0.1 wt % aq. HPMC, 60° C.) are noted. Yield of 2-methoxynaphthonitrile was determined by GC-MS calculated with respect to an internal standard (mesitylene, 0.5 mmol).

TABLE 5
Reaction Optimization for Reaction of 1-Bromo-2-methoxynaphthalene
and Potassium Ferrocyanide to Form 2-methoxynaphthonitrile.

| Entry | Conditions | Conversion (%) |
|---|---|---|
| 1 | No deviation | 78 |
| 2 | No catalyst | n.d. |
| 3 | H₂O instead of HPMC | 17 |
| 4 | NMP as a solvent instead of aq. HPMC | traces |
| 5 | DMF as a solvent instead of aq. HPMC | 11 |
| 6 | 3 wt % SDS instead of aq. HPMC | 58 |
| 7 | No base | 34 |
| 8 | Room temperature instead of 60° C. | 11 |
| 9 | 1 mol % CuBr₂ as a co-catalyst | 18 |

To broaden substrate scope, NPs were optimized using in-situ generation. [Pd(crotyl)Cl]₂, K₂CO₃, and 0.1 wt. % HPMC provided the best conditions (Table 5, entry 1), affording product 71 in 78% yield. Control experiments confirmed NP and HPMC roles: omitting NPs gave no product, and replacing HPMC with water, organic solvents, or micelles (SDS, Tween 20) sharply reduced yields (Table 5, entries 2-6). HPMC uniquely stabilizes NPs and serves as a catalytic scaffold. Alternative Pd sources ([Pd(allyl)Cl]2, Pd₂dba₃, PdCl₂) were less effective, likely due to slower Pd(0) formation. Cyanide source and base identity (Table 5, entry 7) were important: K₄[Ru(CN)₆] failed, and bases other than K₂CO₃ underperformed. Mild heating was helpful (see Table 5, entry 8), whereas THF and transmetallation additives (ZnCl₂, CuBr₂ (Table 5, entry 9)) were less useful. Using Pd(CN)₂ as a Pd source gave no reaction, supporting the cyanide-free protocol. Collectively, HPMC enables NP formation and sustained catalysis under aqueous, cyanide-free conditions.

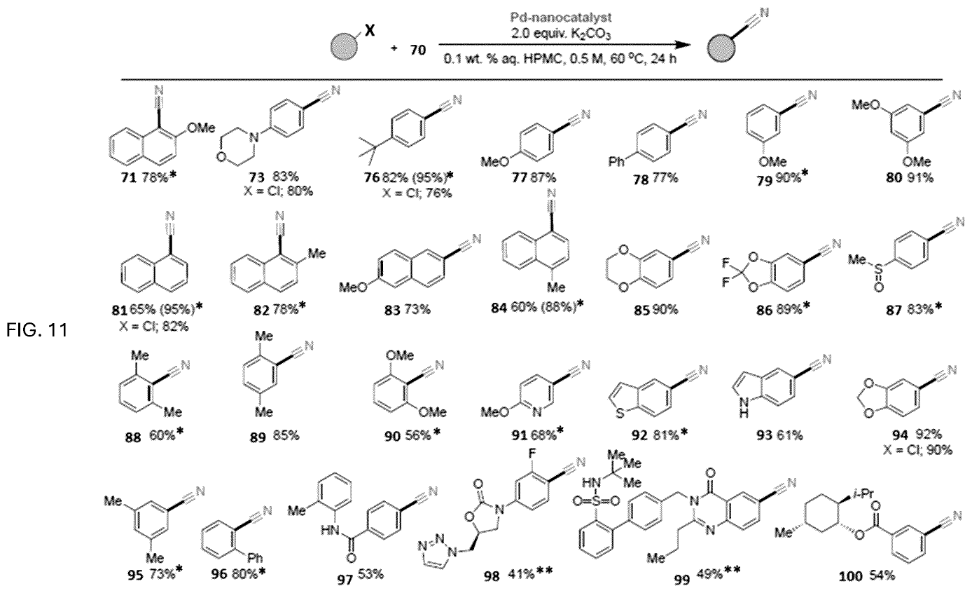

Under optimized conditions, the substrate scope was explored. See FIG. 11, products 71, 73, 76-100. Cyanation proceeded efficiently on naphthyl rings bearing diverse substituents (71, 81-84). Methoxy groups were well tolerated at multiple positions, including C-2 and C-7 (71, 83), and methyl substituents at ortho and para positions did not undergo undesired C—H arylation (82, 84). Electron-deficient electrophiles were also well tolerated under reaction conditions, leading to the corresponding nitriles (87, 97, 100). Comparable reactivity was observed for phenyl rings bearing methoxy or alkyl groups at ortho (88, 89), meta (79, 80, 95), and para (76, 77) positions. Biphenyl bromides also afforded good yields, particularly in ortho- (96) and para-phenyl (78) configurations. Morpholine substitution was compatible (73), and heteroaryl bromide, including pyridyl (91), benzothiophene (92), and indole (93), underwent cyanation in good to excellent yields. Bromides of dibenzodioxins, 2,2-difluorobenzodioxole, and benzodioxole delivered excellent outcomes (85, 86, 94). Notably, the hetero(aryl) substrate for preparing product 87 showed no C—H arylation despite an activated methyl group in the sulfoxide moiety. The NH groups of amide (97) and sulfonamide (99) did not interfere, and triazole and dioxazolidinone rings were tolerated, affording cyanation product 98, albeit in modest yield with 50% recovery of starting material. Similarly, an aryl iodide bearing a quinazoline ring and sulfonamide group furnished the desired product (99) in 49% yield, with 48% of unreacted material recovered. The reduced catalytic activity in these cases likely reflects poor solubility in the aqueous HPMC medium. Both compounds originated from Merck's Informer library. The protocol's generality was also assessed by applying it to aryl chlorides. Selected examples demonstrated that cyanation of aryl chlorides under optimized conditions delivered yields comparable to those for aryl bromides (corresponding to products 73, 76, 81, 94), underscoring the method's versatility across halogenated substrates. The practicality of the catalytic system was confirmed on a gram scale. The same cyanation protocol afforded 85 in 82% yield with reduced catalyst loading (1 mol % catalyst loading, instead of 3 mol %), highlighting the protocol's efficiency and reproducibility for larger-scale applications. The ester group was well tolerated under aqueous basic conditions, and no byproducts from ester hydrolysis were observed in product 100.

### Example 8

### Ligand Comparison Study

Reactions were performed according to the General Procedure described in Example 7, except in some cases substituting the AshPhos ligand for another phosphine ligand, i.e., tBuXPhos or GPhos. General reaction conditions were as follows: Aryl halide (0.5 mmol), K₄[Fe(CN)₆·3H2O (0.25 equiv.) [Pd(crotyl)Cl]₂ (3.0 mol %), ligand (6.0 mol %), K₂CO₃ (2.0 equiv.), 1.0 mL 0.1 wt. % HPMC, 60° C., 24 hours. The catalytic performance of palladium complexes with the different ligands is summarized in Table 6, below.

TABLE 6
Ligand Comparison

| Aryl halide | AshPhos | t-BuXPhos | GPhos |
|---|---|---|---|
| % product when the | 96 | 64 | 42 |
| aryl halide is 4- | | | |
| bromoanisole | | | |
| % product when the | <10% | 58 | 77 |
| aryl halide is 4- | | | |
| chloroanisole | | | |
| % product when the | 82 | 88 | 90 |
| aryl halide is bromo- | | | |
| p-tert-butylbenzene | | | |
| % product when the | 76 | 40 | 68 |
| aryl halide is chloro- | | | |
| p-tert-butylbenzene | | | |

### Example 9

### Kinetic Studies

A detailed kinetic study probed the influence of coupling partners and base on the reaction rate of the reaction shown in Scheme 7, above. Four runs of the reaction were performed as described in Table 7, below. Yield of aryl nitrile (71) from each reaction run was measured by GC-MS on the crude reaction mixture from aliquots removed at time 0 and at 30, 45, 60, 90, 120, 180, 240, and 300 minutes. Reaction yields were calculated using mesitylene (0.5 mmol) as an internal standard. The product concentration was plotted against time.

TABLE 7
Kinetics Study Reaction Conditions

| | 69 | 70 | K₂CO₃ | [Pd(crotyl)Cl]₂ | AshPhos |
|---|---|---|---|---|---|
| Run | (mmol) | (mmol) | (mmol) | (mmol) | (mmol) |
| 1 | 0.5 | 0.125 | 1.0 | 0.015 | 0.03 |
| 2 | 0.25 | 0.125 | 1.0 | 0.015 | 0.03 |
| 3 | 0.5 | 0.0625 | 1.0 | 0.015 | 0.03 |
| 4 | 0.5 | 0.125 | 0.5 | 0.015 | 0.03 |

Halving the concentration of nitrile source (potassium ferrocyanide, 70) or base had negligible effect on the rate of product formation. However, the reaction displayed an approximate first-order dependence on concentration of aryl bromide 69. This finding suggests that the rate-determining step involves oxidative addition or reductive elimination.

In summary, a safe Pd-catalyzed cyanide ion-free cyanation of aryl halides was developed featuring a transmetallation via halogen-nitrile metathesis using potassium ferrocyanide as a bound cyanide reservoir. A novel mixed-metal nanoparticle system comprised of Pd, Fe and the phosphine ligand AshPhos supported in an aqueous HPMC microenvironment provides efficient cyanation of aryl bromides and chlorides without the intermediacy of cyanide ion in stark contrast to traditional homogenous catalysis systems. The robust iron-cyanide bonding restricts cyanide speciation mobilization but still allows for a concerted transmetallation to enable catalysis. Support for this concerted mechanism comes from both IR studies and cyanide test strips, clearly showing the absence of any cyanide ion formation, universally present in traditional cyanation methods. This advance represents both a novel transmetallation paradigm for Pd catalysis, as well as a significant reduction in risk to worker safety and environmental impacts. Use of this methodology can greatly simplify engineering and administrative controls, as well as waste treatment requirements, in performing industrial scale cyanation reactions. Likewise, greatly reduced acute toxicity risks can benefit scientists working at laboratory scales across academia and industry.

### REFERENCES

All references listed herein including but not limited to all patents, patent applications and publications thereof, scientific journal articles, and database entries are incorporated herein by reference in their entireties to the extent that they supplement, explain, provide a background for, or teach methodology, techniques, and/or compositions employed herein.
Anbarasan, P.; Schareina, T.; Beller, M. Recent developments and perspectives in palladium-catalyzed cyanation of aryl halides: synthesis of benzonitriles. Chem. Soc. Rev. 2011, 40, 5049-5067. doi: 10.1039/C1CS15004A.
Ansari, T. N.; Choudhary, R. H.; Nachtegaal, M.; Clark, A. H.; Plummer, S. V.; Jasinski, J. B.; Gallou, F.; Handa, S. Aminations of Aryl Halides Using Nitroaromatics as Coupling Partners: Overcoming the Hydrodehalogenation Pathway under a Hydrogen Atmosphere in Water. ACS Catal. 2024, 14, 4099-4107. doi: 10.1021/acscatal.3c06351,
Beletskaya, I. P.; Bessmertnykh, A. G.; and Guilard, R. Palladium-catalyzed amination of aryl dibromides with secondary amines: synthetic and mechanistic aspects. Tetrahedron Lett. 1999, 40, 6393-6397. doi: 10.1016/50040-4039(99)01246-0.
Borlinghaus, N.; Ansari, T. N.; von Garrel, L. H.; Ogulu, D.; Handa, S.; Wittmann, V.; and Braje, W. M. Nucleophilic aromatic substitution reactions under aqueous, mild conditions using polymeric additive HPMC. Green Chem. 2021, 23, 3955-3962. doi: 10.1039/D1GC00128K.
Brun, M.; Berthet, A.; Bertolini, J. C. XPS, AES and Auger parameter of Pd and PdO. J. Electron Spectrosc. Relat. Phenom. 1999, 104, 55-60. doi: 10.1016/50368-2048(98)00312-0.
Campeau, L. C.; and Hazari, N. Cross-coupling and related reactions: connecting past success to the development of new reactions for the future. Organometallics. 2018, 38, 3-35. doi: 10.1021/acs.organomet.8b00720.
Cohen, D. T.; Buchwald, S. L. Mild Palladium-Catalyzed Cyanation of (Hetero)aryl Halides and Triflates in Aqueous Media. Org. Lett. 2015, 17, 202-205. doi: 10.1021/015032359.
Cooper, T. W.; Campbell, I. B.; and Macdonald, S. J. Factors determining the selection of organic reactions by medicinal chemists and the use of these reactions in arrays (small focused libraries). Angew. Chem. Int. Ed. 2010, 49, 8082-8091. doi: 10.1002/anie.201002238.
DeAngelis, A. J.; Gildner, P. G.; Chow, R.; and Colacot, T. J. Generating active “L-Pd (0)” via neutral or cationic π-allylpalladium complexes featuring biaryl/bipyrazolylphosphines: synthetic, mechanistic, and structure-activity studies in challenging cross-coupling reactions. J Org. Chem. 2015, 80, 6794-6813. doi: 10.1021/acs.joc.5b01005.
Dorel, R.; Grugel, C. P.; and Haydl, A. M. The Buchwald-Hartwig amination after 25 years. Angew. Chem. Int. Ed. 2019, 58, 17118-17129. doi: 10.1002/anie.201904795.
Erhardt, S.; Grushin, V. V.; Kilpatrick, A. H.; Macgregor, S. A.; Marshall, W. J.; Roe, D. C. Mechanisms of Catalyst Poisoning in Palladium-Catalyzed Cyanation of Haloarenes. Remarkably Facile C—N Bond Activation in the [(Ph3P)4Pd]/[Bu4N]+ CN— System. J Am. Chem. Soc. 2008, 130, 4828-4845. doi: 10.1021/ja078298h.
Fleming, F. F.; Yao, L.; Ravikumar, P. C.; Funk, L.; Shook, B. C. Nitrile-Containing Pharmaceuticals: Efficacious Roles of the Nitrile Pharmacophore. J. Med. Chem. 2010, 53, 7902-7919. doi: 10.1021/jm100762r.
Ganesan, M.; Nagaraaj, P. Recent developments in dehydration of primary amides to nitriles. Org. Chem. Front. 2020, 7, 3792-3814. doi: 10.1039/D0Q000843E.
Hamann, B. C; and Hartwig, J. F. Sterically hindered chelating alkyl phosphines provide large rate accelerations in palladium-catalyzed amination of aryl iodides, bromides, and chlorides, and the first amination of aryl tosylates. J. Am. Chem. Soc. 1998, 120, 7369-7370. doi: 10.1021/ja985527e.
Handa, S.; Andersson, M. P.; Gallou, F.; Reilly, J.; and Lipshutz, B. H. HandaPhos: a general ligand enabling sustainable ppm levels of palladium-catalyzed cross-couplings in water at room temperature. Angew. Chem. Int. Ed. 2016, 55, 4914-4918. doi: 10.1002/anie.201510570.
Hellberg, J.; Dahlstedt, E. and Pelcman, M. E. Synthesis of annulated dioxins as electron-rich donors for cation radical salts. Tetrahedron, 2004, 60, 8899-8912. doi: 10.1016/j.tet.2004.07.017.
Hodgson, H. H. The Sandmeyer reaction. Chem. Rev. 1947, 40, 251-277. doi: 10.1021/cr60126a003.
Hooper, M. W.; Utsunomiya, M.; and Hartwig, J. F. Scope and mechanism of palladium-catalyzed amination of five-membered heterocyclic halides. J. Org. Chem. 2003, 68, 2861-2873. doi: 10.1021/jo0266339.
Imamoto, T. Searching for Practically Useful P-Chirogenic Phosphine Ligands. Chem. Rec. 2016, 16, 2659-2673. doi: 10.1002/tcr.20160098.
Iyer, K. S.; Kavthe, R. D.; Lammert, R. M.; Yirak, J. R.; and Lipshutz, B. H. Ligated Pd-Catalyzed Aminations of Aryl/Heteroaryl Halides with Aliphatic Amines under Sustainable Aqueous Micellar Conditions. JACS Au, 2024, 4, 680-689. doi: 10.1021/jacsau.3c00742.
Jaszczak, E.; Polkowska, Z.; Narkowicz, S.; Namieśnik, J. Cyanides in the environment—analysis—problems and challenges. Environ. Sci. Pollut. Res. 2017, 24, 15929-15948. doi: 10.1007/s11356-017-9081-7.
Jinho, K.; Hyun, J. K.; Sukbok, C. Synthesis of Aromatic Nitriles Using Nonmetallic Cyano-Group Sources. Angew. Chem. Int. Ed. 2012, 51, 11948-11959. doi: 10.1002/anie.201206168.
Johansson Seechurn, C. C.; Parisel, S. L.; and Colacot, T. J. Air-stable Pd (R-allyl) LCl (L=Q-Phos, P (t-Bu) 3, etc.) systems for C—C/N couplings: insight into the structure-activity relationship and catalyst activation pathway. J. Org. Chem. 2011, 76, 7918-7932. doi: 10.1021/jo2013324.
Jones, L. H.; Summerhill, N. W.; Swain, N. A.; Mills, J. E. Aromatic chloride to nitrile transformation: medicinal and synthetic chemistry. Med. Chem. Commun. 2010, 1, 309-318. doi: 10.1039/COMD00135J.
Khadra, A.; Mayer, S.; Mitchell, D.; Rodriguez, M. J.; and Organ, M. G. A general protocol for the broad-spectrum cross-coupling of nonactivated sterically hindered 1° and 2° amines. Organometallics. 2017, 36, 3573-3577. doi: 10.1021/acs.organomet.7b00490.
Kumar, R. U.; Reddy, K. H. V.; Kumar, B. A.; Satish, G.; Reddy, V. P.; and Nageswar, Y. V. D. Metal free amination of 2-chloroazoles in aqueous medium. Tetrahedron Lett. 2016, 57, 637-640. doi: 10.1016/j.tetlet.2015.12.084.
Matthews, A. D.; Peters, E.; Debenham, J. S.; Gao, Q.; Nyamiaka, M. D.; Pan, J.; and Uehling, M. R. Cu Oxamate-Promoted Cross-Coupling of α-Branched Amines and Complex Aryl Halides: Investigating Ligand Function through Data Science. ACS Catal. 2023, 13, 16195-16206. doi: 10.1021/acscatal.3c04566.
McCann, S. D.; Reichert, E. C.; Arrechea, P. L.; and Buchwald, S. L. Development of an aryl amination catalyst with broad scope guided by consideration of catalyst stability. J. Am. Chem. Soc. 2020, 142, 15027-15037. doi: 10.1021/jacs.0c06139.
Miller, J. S.; Manson, J. L. Designer Magnets Containing Cyanides and Nitriles. Acc. Chem. Res. 2001, 34, 563-570. doi: 10.1021/ar0000354.
Old, D. W.; Wolfe, J. P.; and Buchwald, S. L. A highly active catalyst for palladium-catalyzed cross-coupling reactions: room-temperature Suzuki couplings and amination of unactivated aryl chlorides. J. Am. Chem. Soc. 1998, 120, 9722-9723. doi: 10.1021/ja982250.
Park, N. H.; Vinogradova, E. V.; Surry, D. S.; and Buchwald, S. L. Design of New Ligands for the Palladium-Catalyzed Arylation of α-Branched Secondary Amines. Angew. Chem. Int. Ed. 2015, 127, 8377-8380. doi: 10.1002/ange.201502626.
Reichert, E. C.; Feng, K.; Sather, A. C.; and Buchwald, S. L. Pd-catalyzed amination of base-sensitive five-membered heteroaryl halides with aliphatic amines. J. Am. Chem. Soc. 2023, 145, 3323-3329. doi: 10.1021/jacs.2c13520.
Rosenmund, K. W.; Struck, E. Das am Ringkohlenstoff gebundene Halogen und sein Ersatz durch andere Substituenten. I. Mitteilung: Ersatz des Halogens durch die Carboxylgruppe. Ber. Dtsch. Chem. Ges. 1919, 2, 1749-1756 doi: 10.1002/cber. 19190520840.
Roughley, S. D.; and Jordan, A. M. The medicinal chemist's toolbox: an analysis of reactions used in the pursuit of drug candidates. J. Med. Chem. 2011, 54, 3451-3479. doi: 10.1021/jm200187y.
Ruiz-Castillo, P.; and Buchwald, S. L. Applications of palladium-catalyzed C—N cross-coupling reactions. Chem. Rev. 2016, 116, 12564-12649. doi: 10.1021/acs.chemrey.6b00512.
Sandmeyer, T. Ueber die Ersetzung der Amid-gruppe durch Chlor, Brom und Cyan in den aromatischen Substanzen. Ber. Dtsch. Chem. Ges. 1884, 17, 2650-2653. doi: 10.1002/cber. 18840170219.
Sather, A. C.; and Martinot, T. A. Data-rich experimentation enables palladium-catalyzed couplings of piperidines and five-membered (hetero) aromatic electrophiles. Org. Process Res. Dev. 2019, 23, 1725-1739. doi: 10.1021/acs.oprd.9b00233.
Schuppe, A. W.; Borrajo-Calleja, G. M.; Buchwald, S. L. Enantioselective olefin hydrocyanation without cyanide. J Am. Chem. Soc. 2019, 141, 18668-18672. doi: 10.1021/jacs.9b10875.
Senecal, T. D.; Shu, W.; Buchwald, S. L. A General, Practical Palladium-Catalyzed Cyanation of (Hetero) Aryl Chlorides and Bromides. Angew. Chem. Int. Ed. 2013, 125, 10219-10223. doi: 10.1002/ange.201304188.
Sharma, B. M.; Nikam, A. V.; Lahore, S.; Ahn, G. N.; Kim, D. P. Cyanide-free cyanation of sp2 and sp-carbon atoms by an oxazole-based masked CN source using flow microreactors. Chem. Eur. J. 2022, 28, e202103777. doi: dol0.1002/chem/202103777.
Sharma, S.; Ansari, T. N.; Handa, S. HPMC: A Biomass-Based Semisynthetic Sustainable Additive Enabling Clean and Fast Chemistry in Water. ACS Sustain. Chem. Eng. 2021, 9, 12719-12728. doi: 10.1021/acssuschemeng.1c04607.
Sousa, S.; Maria, M. L.; Correira-Sá, L.; Fernandes, V. C.; Delerue-Matos, C.; Calhau, C.; Domingues, V. F. Chemistry and Toxicology Behind Insecticides and Herbicides. In: K. R., R., Thomas, S., Volova, T., K., J. (eds) Controlled Release of Pesticides for Sustainable Agriculture. Springer, 2020, pp 59-109. doi: 10.1007/978-3-030-23396-9_3.
Sruthi, P. R.; Anas, S. An overview of synthetic modification of nitrile group in polymers and applications. J. Polym. Sci. 2020, 58, 1039-1061. doi: 10.1002/pol.20190190
Sundermeier, M.; Zapf, A.; Beller, M. Palladium-catalyzed cyanation of aryl halides: Recent developments and perspectives. Eur. J. Inorg. Chem. 2003, 19, 3513-3526. doi: 10.1002/ejic.200300162.
Thakore, R. R.; Takale, B. S.; Singhania, V.; Gallou, F.; Lipshutz, B. H. Late-stage Pd-catalyzed Cyanations of Aryl/Heteroaryl Halides in Aqueous Micellar Media. ChemCatChem, 2021, 13, 212-216. doi: 10.1002/cctc.202001742.
U.S. Environmental Protection Agency (EPA). Method 335.4: Determination of Total Cyanide by Semi-Automated Colorimetry. (EPA, Washington, DC, 1993).
U.S. Environmental Protection Agency (EPA). Aquatic Life Ambient Water Quality Criteria for Cyanide (EPA 440/5-84-028, EPA, Washington, DC, 1985).
Vitaku, E.; Smith, D. T.; and Njardarson, J. T. Analysis of the structural diversity, substitution patterns, and frequency of nitrogen heterocycles among US FDA approved pharmaceuticals: miniperspective. J. Med. Chem. 2014, 57, 10257-10274. doi: 10.1021/jm501100b.
Wang, X.; Wang, Y.; Li, X., Yu, Z.; Song, C.; Du, Y. Nitrile-containing pharmaceuticals: target, mechanism of action, and their SAR studies. RSC Med. Chem. 2021, 12, 1650-1671. doi: 10.1039/D1MD00131K.
Wang, Y.; Du, Y.; Huang, N. A survey of the role of nitrile groups in protein-ligand interactions. Future Med. Chem. 2018, 10, 2713-2728. doi: 10.4155/fmc-2018-0252.
Wen, Q.; Jin, J.; Zhang, L.; Luo, Y.; Lu, P.; Wang, Y. Copper-mediated cyanation reactions. Tetrahedron Lett. 2014, 55, 1271-1280. doi:10.1016/j.tetlet.2014.01.032.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A compound having a structure of Formula (I): 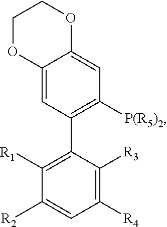
wherein:
R₁ and R₃ are independently selected from C₁-C₆ alkyl, C₁-C₆ alkoxy, and N(R₆)₂;
R₂ and R₄ are independently selected from H, C₁-C₆ alkyl, C₁-C₆ alkoxy, benzyl, substituted benzyl, and N(R₆)₂; or wherein R₁ and R₂ together and/or R₃ and R₄ together are —CH═CH—CH═CH— or —O—(C(R₇)₂)ₙ—O—, wherein n is 1 or 2 and each R₇ is H or halo, optionally H or F;
R₅ is selected from the group consisting of alkyl, cycloalkyl, aryl, 2-pyridyl, and N(R₆)₂; and
each R₆ is independently C₁-C₆ alkyl.

2. The compound of claim 1, wherein R₁ and/or R₃ is C₁-C₆ alkoxy, optionally methoxy.

3. The compound of claim 1, wherein R₂ and/or R₄ is H, optionally wherein R₂ and R₄ are each H.

4. The compound of claim 1, wherein R₁ and R₂ together are —O—(C(R₇)₂)ₙ—O—, optionally wherein each R₇ is H and n is 1; and/or wherein R₃ and R₄ together are —O—(C(R₇)₂)ₙ—O—, optionally wherein each R₇ is H and n is 1.

5. The compound of claim 1, wherein each R₅ is C₁-C₆ alkyl, optionally tert-butyl (t-Bu).

6. The compound of claim 1, wherein each R₅ is cycloalkyl, optionally cyclohexyl (Cy).

7. The compound of claim 1, wherein the compound is selected from the group consisting of:

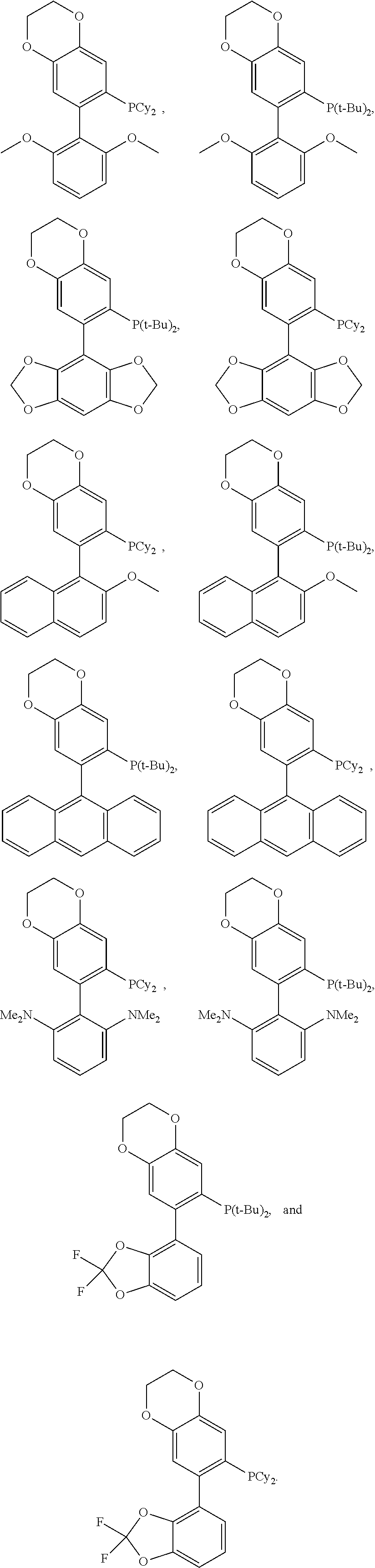

8. A pre-catalyst palladium complex, wherein the pre-catalyst palladium complex comprises a palladium (Pd) ion and a monophosphine ligand, wherein the monophosphine ligand is a compound of claim 1.

9. The pre-catalyst palladium complex of claim 8, wherein the pre-catalyst palladium complex has a formula [Pd(L)(MP)X′], wherein L is an olefin, MP is the monophosphine ligand, and X′ is a halide, optionally wherein L is selected from the group consisting of crotyl alcohol (crotyl), 1-propene (allyl), cinnamyl alcohol (cinnamyl), cyclooctadiene (cod), and dibenzylideneacetone (dba).

10. A method of performing a palladium (Pd)-catalyzed cross-coupling reaction between a first substrate and a second substrate, wherein the method comprises contacting the first substrate and the second substrate in the presence of a pre-catalyst palladium complex comprising a Pd ion and a monophosphine ligand, wherein the monophosphine ligand is a compound of claim 1; wherein the first substrate and the second substrate undergo a Pd-catalyzed cross-coupling reaction to form a product comprising a carbon-carbon, carbon-nitrogen, carbon-oxygen, or carbon-sulfur bond that was not present in the first or second substrate.

11. The method of claim 10, wherein the first substrate is a compound having a structure of the formula Ar₁—X, wherein Ar₁ is aryl, substituted aryl, heteroaryl, or substituted heteroaryl, and X is halo, alkyl sulfonate, substituted alkyl sulfonate, aryl sulfonate, or substituted aryl sulfonate; optionally wherein X is Br, Cl, I, methanesulfonate (OMs), or trifluorosulfonate (OTf).

12. The method of claim 10, wherein the second substrate is selected from the group consisting of an alcohol, a phenol, a thiol, a primary amine, a secondary amine, and an α,β-unsaturated carbonyl compound.

13. The method of claim 10, wherein the Pd-catalyzed cross-coupling reaction is a Buchwald-Hartwig amination reaction, wherein the first substrate is a compound having a structure of the formula Ar₁—X, wherein Ar₁ is aryl, substituted aryl, heteroaryl, or substituted heteroaryl, and X is halo, alkyl sulfonate, substituted alkyl sulfonate, aryl sulfonate, or substituted aryl sulfonate; wherein the second substrate is a primary or secondary amine having the structure HN(R′)₂, wherein each R′ group is selected from H, alkyl, substituted alkyl, aralkyl, substituted aralkyl, aryl, and substituted aryl, subject to the proviso that at least one R′ group is alkyl, substituted alkyl, aralkyl, substituted aralkyl, aryl, and substituted aryl, or wherein two R′ groups together with the nitrogen atom to which they are attached form a cyclic amino group; and wherein the product is a compound of the formula Ar₁—N(R′)₂.

14. The method of claim 13, wherein the second substrate is a primary or secondary amine having a structure of the formula HN(R′)₂, wherein each R′ group is H, alkyl or substituted alkyl, subject to the proviso that at least one R′ group is alkyl or substituted alkyl; or wherein the two R′ groups together with the nitrogen atom to which they are attached form a cyclic amino group, optionally wherein the cyclic amino group comprises a substituted and/or fused nitrogen-containing ring structure; and wherein the product is a compound of the formula Ar₁—N—(R′)₂.

15. The method of claim 13, wherein the second substrate is a primary amine having a structure of the formula H₂NR′, wherein R′ is alkyl having the structure —C(R″)₃, wherein each R″ is H, alkyl, or substituted alkyl, and wherein at least two R″ groups are alkyl or substituted alkyl; optionally wherein each R″ is methyl and the second substrate is t-butylamine.

16. The method of claim 13, wherein the second substrate is an α-branched secondary amine, optionally wherein the α-branched secondary amine comprises a substituted or fused nitrogen-containing ring structure.

17. The method of claim 13, wherein the second substrate is a non-α-branched secondary amine, optionally wherein the non-α-branched secondary amine comprises a substituted or unsubstituted nitrogen-containing ring structure.

18. The method of claim 10, wherein the method comprises:
(a) contacting the monophosphine ligand with about 0.5 molar equivalents of a palladium compound or salt in a first aprotic solvent, wherein the palladium compound or salt is selected from the group consisting of [Pd(crotyl)Cl]₂, [Pd(allyl)Cl]₂, Pd₂dba₃, Pd(OAc)₂, PdBr₂, [Pd(cinnamyl)Cl]₂, (COD)PdCH₂C(Me)₂Ph, and Pd(cod)Cl₂; thereby preparing a solution comprising the pre-catalyst palladium complex;
(b) preparing a mixture comprising the first substrate and the second substrate in a second aprotic solvent, wherein the second aprotic solvent is the same or different than the first aprotic solvent; and
(c) contacting the mixture from step (b) with the solution comprising the pre-catalyst palladium complex and stirring the resulting mixture for a period of time at a temperature of about 20° C. to about 90° C.

19. The method of claim 18, wherein the contacting of step (c) is performed in the presence of a non-nucleophilic base, optionally an alkali metal alkoxide, further optionally wherein the non-nucleophilic base is sodium tert-butoxide.

20. The method of claim 18, wherein the first and/or second aprotic solvent is tetrahydrofuran or toluene.

21. The method of claim 18, wherein the contacting of step (c) is performed for a period of time of about 3 hours to about 16 hours and/or at a temperature of about 50° C. to about 90° C.

22. A nanoparticle comprising a pre-catalyst palladium complex, wherein the pre-catalyst palladium complex comprises a monophosphine ligand, wherein the monophosphine ligand is a compound of claim 1.

23. The nanoparticle of claim 22, wherein the monophosphine ligand is

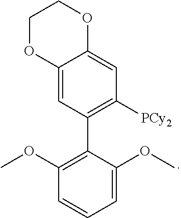

24. The nanoparticle of claim 22, wherein the nanoparticle further comprises ferrocyanide.

25. A method of preparing a nitrile, wherein the method comprises contacting a substrate, wherein the substrate comprises a (hetero)aryl halide or (hetero)aryl sulfonate ester, with (i) potassium ferrocyanide or a hydrate thereof and a nanoparticle comprising a pre-catalyst palladium complex comprising a monophosphine ligand, wherein the monophosphine ligand is a compound of claim 1; or (ii) a nanoparticle comprising the pre-catalyst palladium complex and ferrocyanide, wherein the contacting is performed in an aqueous solution comprising hydroxypropyl methylcellulose (HPMC), thereby converting the substrate into a (hetero)aryl nitrile.

26. The method of claim 25, wherein the method comprises: (a) contacting the pre-catalyst palladium complex with an aqueous solution comprising HPMC and stirring the resulting mixture for a first period of time at a first temperature to provide an aqueous solution comprising HPMC and a nanoparticle comprising the pre-catalyst palladium complex; (b) adding the substrate and potassium ferrocyanide or a hydrate thereof to the aqueous solution comprising the HPMC and the nanoparticle to provide a reaction mixture; and (c) stirring the reaction mixture at a second temperature for a second period of time.

27. The method of claim 26, wherein step (b) further comprises adding a base to the reaction mixture, wherein the base is selected from an alkali metal hydroxide, an alkali metal carbonate, an alkali metal alkoxide, and a trialkylamine, optionally wherein the base is potassium carbonate.

28. The method of claim 25, wherein the method is performed without the generation of free cyanide ions.
